SEQUENCE LISTING (44 sequences)

SEQ ID NO: 1 - DNA, 885 bp, Delftia acidovorans
  source 1..885: mol_type = other DNA
atggactttccaggattcaagaacagcaccgttaccgtggatggtgtggacatcgcctacaccgtaagcggcgaaggccctccggtgctgatgctgcatgggttcccgcagaaccgggccatgtgggcgcgcgtggctccccaactcgccgagcaccataccgtggtgtgtgccgacctgcgaggctatggcgattcggacaagcccaagtgcctgccggaccggtcaaactactcattccgcacgtttgcccatgaccaactctgtgtgatgcgccacctggggttcgagcgcttccacctcgtcggacatgatcgcggcgggcgtaccggtcaccgcatggcgctggatcatcccgaagcggtgctgtcgctgaccgtcatggacatcgtgccgacgtatgcgatgttcatgaacaccaaccgtctggttgccgcttcctactggcattggtatttcctgcagcagcctgagccgttccccgagcacatgatcggtcaggacccggacttcttctatgagacctgtttgttcgggtggggggcaaccaaggtgtcggactttgaccaacaaatgctgaacgcatatcgggagtcttggcgcaacccagccatgattcacggctcatgctcggactaccgcgccgccgcaacaattgaccttgaacacgatagcgcggacatccaacggaaggtggaatgccccaccttggttttctacggctcaaaggggcagatggggcagctattcgacataccagccgagtgggcaaagcgctgcaacaacactacaaacgcatctctgccaggaggccatttcttcgtggatcagttccccgcggaaacatcagagattcttttgaagtttcttgctcgaaacggctga

SEQ ID NO: 2 - protein, 294 aa, Delftia acidovorans
MDFPGFKNSTVTVDGVDIAYTVSGEGPPVLMLHGFPQNRAMWARVAPQLAEHHTVVCADLRGYGDSDKPKCLPDRSNYSFRTFAHDQLCVMRHLGFERFHLVGHDRGGRTGHRMALDHPEAVLSLTVMDIVPTYAMFMNTNRLVAASYWHWYFLQQPEPFPEHMIGQDPDFFYETCLFGWGATKVSDFDQQMLNAYRESWRNPAMIHGSCSDYRAAATIDLEHDSADIQRKVECPTLVFYGSKGQMGQLFDIPAEWAKRCNNTTNASLPGGHFFVDQFPAETSEILLKFLARNG

SEQ ID NO: 3 - DNA, 915 bp, Burkholderia sp.
  source 1..915: mol_type = other DNA
atgtttgaaggattcgagcgacgccttgtcgatgtcggtgacgtaacgatcaactgcgtcgtaggcggtagcggtccggcgcttctattgctccacggttttccgcagaaccttcacatgtgggcccgcgtcgcccccttgctcgcaaacgagtacaccgtcgtctgtgcggatctgcggggctacggcggttcgtcgaagccggtgggcgcccccgaccatgccaactactcctttcgtgcaatggcatccgaccagcgtgaattgatgcgaacgctggggttcgagcggtttcacctggtcggacacgatcggggcggaagaacggggcatcgcatggcgctggaccaccccgatagcgtgctctcgctcgccgttctggacatcatcccaacctatgtgatgttcgaagaagtcgaccgtttcgtggcacgggcctactggcattggtattttcttcagcagcctgcgccttatcccgagaaggtcattggcgccgatcccgacaccttttacgaaggctgtctcttcggctggggcgcgacgggtgctgatggcttcgaccccgagcaactggaagagtatcgaaaacaatggcgcgatcccgcagcaattcacggcagttgctgcgactaccgggccggcgggacgatcgacttcgaactcgaccacggggacctgggccggcaggtccagtgccctgccttggtgttttccggttctgccggcctgatgcactctctcttcgagatgcaggtcgtctgggcgccgcgactggcgaacatgcgtttcgcatcgctgccgggtgggcacttcttcgtcgatcggttccccgacgacacggcacgcatccttcgcgagtttctaagtgatgcgcgcagcggtatccaccagaccgagcgaagagaatcatga

SEQ ID NO: 4 - protein, 304 aa, Burkholderia sp.
MFEGFERRLVDVGDVTINCVVGGSGPALLLLHGFPQNLHMWARVAPLLANEYTVVCADLRGYGGSSKPVGAPDHANYSFRAMASDQRELMRTLGFERFHLVGHDRGGRTGHRMALDHPDSVLSLAVLDIIPTYVMFEEVDRFVARAYWHWYFLQQPAPYPEKVIGADPDTFYEGCLFGWGATGADGFDPEQLEEYRKQWRDPAAIHGSCCDYRAGGTIDFELDHGDLGRQVQCPALVFSGSAGLMHSLFEMQVVWAPRLANMRFASLPGGHFFVDRFPDDTARILREFLSDARSGIHQTERRES

SEQ ID NO: 5 - DNA, 909 bp, Rhodopseudomonas palustris
  source 1..909: mol_type = other DNA
atgcccgatctcgccgacttgtttccgggcttcggctcggaatggatcaacacctcttcgggccggatcttcgcgcgcgtcggcggtgacggaccgccgctattgttgctgcacggctttccgcagacccatgtgatgtggcaccgcgttgcgccgaagctggccgagcgcttcaaggtgatcgtcgccgatctgcccggttacggctggtcggatatgccggagagcgacgagcagcacacgccctacaccaagcgggcgatggccaagcaactgatcgaggcgatggagcagctcggccacgtgcactttgcgctcgccggccatgatcgcggtgcgcgcgtcagctatcggctggcactggattcgccgggccggctgtcgaagctcgccgtgctcgatatcctgccgacctacgagtactggcagcggatgaaccgcgcctatgcgctcaagatctatcactggagcttcctggcgcagccggctccgctgccggaaaatctgctcggcggcgatcctgatttctacgtcaaagccaagctggcgagctggacgcgggcaggcgacctgtcggcgttcgatccgcgtgccgtcgagcattatcgtattgcattcgctgacccgatgcgccgccacgtgatgtgcgaggactatcgcgccggcgcctatgcggatttcgagcacgacaagatcgatgtcgaagccggcaacaagattccggtgccgatgctggcgctgtggggcgcttccggcatcgcacagtcggccgcgacgccgctcgatgtctggagaaagtgggcgtccgacgtgcagggcgcgccgatcgagtccgggcattttcttcccgaggaagcgccggatcagaccgccgaggcgctggtaaggttcttcagcgccgcgccttga

SEQ ID NO: 6 - protein, 302 aa, Rhodopseudomonas palustris
MPDLADLFPGFGSEWINTSSGRIFARVGGDGPPLLLLHGFPQTHVMWHRVAPKLAERFKVIVADLPGYGWSDMPESDEQHTPYTKRAMAKQLIEAMEQLGHVHFALAGHDRGARVSYRLALDSPGRLSKLAVLDILPTYEYWQRMNRAYALKIYHWSFLAQPAPLPENLLGGDPDFYVKAKLASWTRAGDLSAFDPRAVEHYRIAFADPMRRHVMCEDYRAGAYADFEHDKIDVEAGNKIPVPMLALWGASGIAQSAATPLDVWRKWASDVQGAPIESGHFLPEEAPDQTAEALVRFFSAAP

SEQ ID NO: 7 - DNA, 1623 bp, Dehalospirillum multivorans
  source 1..1623: mol_type = other DNA
atgatcagcccggccatcttggagatccgttttggccgcaagttagaccgtgaactggtgatatggtatttcaatatcgtcccaacaggtcgttatcgaaaagtgatgaacctgattgacaaacgccaggagattgttgaagcggcggcggcgctgatgcattcgaaagggtacgaaaataccaaattgtccgatatcctgaaagaaggtcagttgatggaaaaagaaaaatgtaacaatgatgaaccggcaaccatggataaggagaaatctaacaacgataaaccggccacgaaaattaatcgccgtcagttcttaaaatttggcgctggcgccagctctggcattgcaattgcgaccgcggctacggctcttggtggcaaatccttaatcgacccgaaacaggtttacgccggcaccgtcaaagaactggatgaactcccgtttaatatccccgcagattataaaccgtttactaatcaacgtaacattttcggtcaagcggtgctgggcgtaccggagcccctcgccctggtggaacgcttcgatgaagtacggtggaacgggtggcagaccgacggttcaccaggcctgaccgtgctggacggtgccgccgcacgcgccagctttgcagtcgactactattttaacggggaaaacagtgcgtgtcgcgcaaataaaggatttttcgaatggcaccctaaagttccggaacttaacttcaaatggggcgacccggaacgcaatattcacagcccgggagtgaagtctgcagaggaagggaccatggcagtaaaacgtatggcgcgctttttcggagcggccaaggccggtattgctcccttcgataaacgatgggtgtttactgagacagcggcattcgtgaaaacgcctgagggtgaagacttgaagttcatcccgccagattttggctttgagcccaaacatgtcatcagtatgattatccctcagagtctagagggtgtaaagtgcgcaccttcgtttttagggtcggccgagtatggtctgagctttgcccagattggttatgccgcgtttggcctgtcaatgttcattaaagatctgggatatcatgctgttccgatagggtccgattcagcgctgagcatccctatagctattcaagctggcctcggtgaatattctcgttcaggccaaatgattactcctgaatttggcccgaatgtccgtctgtgcgaggttttcacggatatgccactgaaccacgataagccgatttccttcggtgtgacagaattttgtaagacctgtaaaaaatgtgcggaagcatgtccacctcaggcaatcagctacgaagatccgactattgacggtccgcggggccagatgcataatagtggcattaaaaggtggtacgtggatccagtcaagtgctttgaattttggagcagagacaatgttcgcaactgctgcggagcctgcatcgcggcgtgcccattcacgaagcccgaggcgtggcatcacacccttattcggtcgcttgttggtgcgccggtaatcacgccgtttatgaaagatatggatgacatttttggctacgggaaaccgaacgaaaaagctaaagcggattggtggaaatag

SEQ ID NO: 8 - protein, 540 aa, Dehalospirillum multivorans
MISPAILEIRFGRKLDRELVIWYFNIVPTGRYRKVMNLIDKRQEIVEAAAALMHSKGYENTKLSDILKEGQLMEKEKCNNDEPATMDKEKSNNDKPATKINRRQFLKFGAGASSGIAIATAATALGGKSLIDPKQVYAGTVKELDELPFNIPADYKPFTNQRNIFGQAVLGVPEPLALVERFDEVRWNGWQTDGSPGLTVLDGAAARASFAVDYYFNGENSACRANKGFFEWHPKVPELNFKWGDPERNIHSPGVKSAEEGTMAVKRMARFFGAAKAGIAPFDKRWVFTETAAFVKTPEGEDLKFIPPDFGFEPKHVISMIIPQSLEGVKCAPSFLGSAEYGLSFAQIGYAAFGLSMFIKDLGYHAVPIGSDSALSIPIAIQAGLGEYSRSGQMITPEFGPNVRLCEVFTDMPLNHDKPISFGVTEFCKTCKKCAEACPPQAISYEDPTIDGPRGQMHNSGIKRWYVDPVKCFEFWSRDNVRNCCGACIAACPFTKPEAWHHTLIRSLVGAPVITPFMKDMDDIFGYGKPNEKAKADWWK

SEQ ID NO: 9 - DNA, 1221 bp, unidentified
  source 1..1221: mol_type = other DNA
atgcatacgggccgtaatgacgataccaaacgtagccgtactaggaatggtatccgcaccctgccggatgcctcggacgggaacattggatttttgattaatgataactttcgtggcttttcgcaggtcgatgatgtgttttgtcgttctcagtacgatccggaaatcaaaaccccgcactcgcaacgtttttatgatatgtaccgtagacctctggcgaactggcgcaattccgaaggctatggtcagcacgactatgccttccgcaatgcaacgtggcatgttgccgatatctttgcggagctccgtgaagtggatgaccgacgggatggcttcctggacccgttatctttcttgaaagacggtcccgaagaaatggttgagtttaatagcctgaccgagtcatctcaagttattaaacaggctggtaagactattggagcagatttgattggtatcaccaaattcgacagtcggtggagttactctgaactttttagcatccagtccctttccccgaagcccaatgaactagatgatgatctcaaaaacgtgatcgtgattggtcaaagcatggacagcgaactgttagaaacggcgccgagcgcattaagtggcgcggccacaggtatgggttactctcaggatgcactggtgctgctgaccttaagtcagtttatacgcaaccttggctatcgggctgtcccaagcatgaacgactcggctctggccatcccgtatgcggtccaggctggtctgggggaatatggtaagcacggactggtaatcacgccagagtttggcagcagcgtgcgctttggcaaaattttcaccgacatgccgctgcttctggataaaccgattcagtttggcgtttcggatatgtgtaatatatgtaacgcgtgcagcaaggcctgcccatcaaaagcgattccggatgggaaaccatcacctgtaacctttaaccgtagtaacattagcggggtcactaagtggaccatcgatggcgaagcgtgtttctcctactggacgaaaattaacacggattgcgcagtatgcattcgcgtttgccctttcacaagagactatactaaattccgccatcgtctctggctgaaattgtcaggctcgcgtttccgcaaaattgccctgcgcatcgaccaaaaatccaaacgagggaaacgcgtgaagagtcgcacatggtggtcctcagagaattag

SEQ ID NO: 10 - protein, 406 aa, unidentified
MHTGRNDDTKRSRTRNGIRTLPDASDGNIGFLINDNFRGFSQVDDVFCRSQYDPEIKTPHSQRFYDMYRRPLANWRNSEGYGQHDYAFRNATWHVADIFAELREVDDRRDGFLDPLSFLKDGPEEMVEFNSLTESSQVIKQAGKTIGADLIGITKFDSRWSYSELFSIQSLSPKPNELDDDLKNVIVIGQSMDSELLETAPSALSGAATGMGYSQDALVLLTLSQFIRNLGYRAVPSMNDSALAIPYAVQAGLGEYGKHGLVITPEFGSSVRFGKIFTDMPLLLDKPIQFGVSDMCNICNACSKACPSKAIPDGKPSPVTFNRSNISGVTKWTIDGEACFSYWTKINTDCAVCIRVCPFTRDYTKFRHRLWLKLSGSRFRKIALRIDQKSKRGKRVKSRTWWSSEN

SEQ ID NO: 11 - DNA, 1287 bp, Desulfoluna sp.
  source 1..1287: mol_type = other DNA
atggattccgagcatcatccagaaaaaaaaattgatctgtcgcgccgcaaatttgttacccttggtgcggcgtcggctgtggcgggtagtacgatgctggccacgcttccgtctcaagtgatggcggaagcctcaaagggtatgactggcaagcagccgaccagtctagcggataatatcgatagcgctgtttaccaacggtttcatcaaaaaaacaccgccttttgtcaggcactctcaggtacgttcccgcagggcggtcaggcactgaagatgttggggaatacatccagcgagctggggcagcggcagctggacaaagcgttgtctgacagtggctggtacatccaccaattaatagcgaacgggacttccctgtcgggcccggaaactgtggcatatgcgcgcgataatgagattgctcgtgaacgttatgaattcacgtctcctgaagaggcctcacattatattaaaaaagcggcaagattcttgggtgcggaccttgtgggtatcacaccatacgacgagcgctggacctatgccagcttctacgatcatctgaaacaacagaacgtccccccaaccttaccttttaccccgaagagtgtgatagtgctgggcttcgagatggattatgaagccatgacaaccgcgccgagcggaatctcgggagccgcggtaggtcaggggtattccgagatggctatcacaggagccagcctgcgtaagttcattacgtcaattgggtataaagtatttgctaccggcaacgatgtcgccttaaacatcccatacggtattgctgcgggcctgggcgaagcaggccgcaatggcatcctcgtgacttacgaatatggcccgcgtgtccgtttgtgcaaagtttttacggaaatggatttagcctgcgaccatcccgtcagctttggcgttcagcacttctgcgaaacgtgtatgctgtgcgccaaagcatgtcccggccacgcgatttcgaaagaaaaagaacctagctttgaaatcaatgatgagtgcaacaatccgggagtagaaaaatgggcaattgatgcaaagaaatgcctgctcgcttggggtaaaaccaaaagcgattgtgcaacctgtattacctcttgcccgtacaacaaaccgaacttttggcaccatcgcctggtcgataaggttaatcacatgatgccggggtctgtgcacagtgtaatgcgagaaatggacaaactgttcggttatggcaattcctttgacaaaaaagcggttgaccatttttggaaaagctag

SEQ ID NO: 12 - protein, 428 aa, Desulfoluna sp.
MDSEHHPEKKIDLSRRKFVTLGAASAVAGSTMLATLPSQVMAEASKGMTGKQPTSLADNIDSAVYQRFHQKNTAFCQALSGTFPQGGQALKMLGNTSSELGQRQLDKALSDSGWYIHQLIANGTSLSGPETVAYARDNEIARERYEFTSPEEASHYIKKAARFLGADLVGITPYDERWTYASFYDHLKQQNVPPTLPFTPKSVIVLGFEMDYEAMTTAPSGISGAAVGQGYSEMAITGASLRKFITSIGYKVFATGNDVALNIPYGIAAGLGEAGRNGILVTYEYGPRVRLCKVFTEMDLACDHPVSFGVQHFCETCMLCAKACPGHAISKEKEPSFEINDECNNPGVEKWAIDAKKCLLAWGKTKSDCATCITSCPYNKPNFWHHRLVDKVNHMMPGSVHSVMREMDKLFGYGNSFDKKAVDHFWKS

SEQ ID NO: 13 - DNA, 1494 bp, unidentified
  source 1..1494: mol_type = other DNA
atgaaaaaaaaagagaagccgaccgcggtcaaccgccgggattttctcaagttcgggtcaattactgccgtggctggggcggcaaccctggcggctatgccgaagaaagcggccgcggataaactggacaaacatttggtggaggaattagtaaccatccatgatgacttccctgcggaggtacgcgatgactatgttccggcgcgcaactgggatcatgtccaggctcgtagcatttttgttgatgcggtgcgtgccatcggcgacgacgttgaagacgatatagtagcggatggtcaagcattcgtccaaaagatgaattttgcatgggataattcgaaagtgggccacactcaagctgataaagcactgctgagcggggcgtgggccatgaacaattttgccgcaggccctagccccgcggcaattccggactatggtgttaacagttgggaacaaaagacgcagaagaatccacacgcactattcgataacgactacgtcgtaaaagataaatggaaatttgaatctaaagaggaagccgcgaatcagattaaacgtgccgcccgcatgtttggcgctgatcttgttgggatcactcggagagataaacgctgggattattcgaagttccttaaccccgtcccgccgttagctcgtcgtgcctttgccggaccgccgacaccggaacagatggaagaaatgcataattggggcccggataaatttgtgaccgattggtccgatttcccttttgaaccaaaaaccgtcatcgtcatggcctttgaaatggactacgaaggcatcagtgcgatgccaagttatgtggggagtgctgcggccggcgctggttactcacgaatggcagagacgccataccagctggcggtgtacctgaaaaatttgggatatcatgcagtttccgcgggtaacgacatgggactgtccgtgccttatgcgatcgcagctggtctgggcgagaattctcgactgggacaggtggttacgtacaaatacggtccgagggttcgcattgcaaaagtatacacggattttgactttgtcgaatacgataaacctaaatcgtttggcgtgatggaattctgcaaaaactgtatgcgctgtgccgatgcctgtccgaccaaagccattagcttcgataaagaaccatcttttgaaccgacccataagaataaagataacgcatggtataacattaaaggtgttaaaaaatatcacgttgatgccaagtcatgtttccagctctggggcgaattgggcgatgactgcggtgtatgcatggcatcctgcccatataataaacccgacttctggcatcatcgtctggtggacagcgcgacagcggcgatgccgggtccggtgcacgattttatgcgtgagatggataaattattcggttatggcaacgtggatgacaaagacgcggtgaaaaagttttatagccccaaaggcaagtcgtatgacggtcactag

SEQ ID NO: 14 - protein, 497 aa, unidentified
MKKKEKPTAVNRRDFLKFGSITAVAGAATLAAMPKKAAADKLDKHLVEELVTIHDDFPAEVRDDYVPARNWDHVQARSIFVDAVRAIGDDVEDDIVADGQAFVQKMNFAWDNSKVGHTQADKALLSGAWAMNNFAAGPSPAAIPDYGVNSWEQKTQKNPHALFDNDYVVKDKWKFESKEEAANQIKRAARMFGADLVGITRRDKRWDYSKFLNPVPPLARRAFAGPPTPEQMEEMHNWGPDKFVTDWSDFPFEPKTVIVMAFEMDYEGISAMPSYVGSAAAGAGYSRMAETPYQLAVYLKNLGYHAVSAGNDMGLSVPYAIAAGLGENSRLGQVVTYKYGPRVRIAKVYTDFDFVEYDKPKSFGVMEFCKNCMRCADACPTKAISFDKEPSFEPTHKNKDNAWYNIKGVKKYHVDAKSCFQLWGELGDDCGVCMASCPYNKPDFWHHRLVDSATAAMPGPVHDFMREMDKLFGYGNVDDKDAVKKFYSPKGKSYDGH

SEQ ID NO: 15 - DNA, 1332 bp, unidentified
  source 1..1332: mol_type = other DNA
atggaagagcaaaacatcgtccaattagatgaaaacaaagatcctgaagtgaaaaaagtgaaaccggcggggtttttccaggatcgtgttagatgggttcgccccttgggtcgctcgcgtctcattgagctgccgggcaaagccgttgcggaaaccgtatcaacgcagctggataaaaagctcgtaaaggaatggccggaaatgccggtgaaaattcgttcggattataaaaggatgccgcaaaagaacaccattttcaatcgtgcctttagcggggacgccccgaaacaccagaagatgatgggcgccttctggcatcctgagccgcgtaaagaaccaggatggacacagctggactatgcacttgaaaaggccgcctggagcgtcaatgacaccatggcaccatttagccaggcgggcattccgaacacgcctgcataccgctgggacatgaaacccgatagtcagacataccgttttaattccacccatgaagcaactaaagcagtcaaacgtgctgctcgcttcctgggcgctgatctggttggtattgcacgttatgatgaacgctgggtgtatagttccttttatgatccactgaaaaaccaggaaatccccgcggatcttccgttcaaacctaaatctgtaatcgtgatggcggtcgagatggattacgcggcatttggcacggcacccacggttttagcatccgccggcgctggtaagggctacagcgaaatggctgtgaccgcgacctcagtggctcatttcatcagcaacctggggtacaaagcgtttggcgccggtaatgatattgccatgtcagtcccgtatgcgatcgcagcgggtctgggtgaggccgctcgcaatgggatggttgtaacttataaatacggcccgcgcgtccggctatgcaaggtgttcacggaaatggagttggagtgggacaaaccggtgacctttggagttcggcatttttgtgaaaattgcatgcgatgcgcggacgcctgcccgtctaaagccataccaaaagacaaaaaaccaagctttaaagtcaataacaaaagtaacaacccgggtgtggaaaaatgggcggttgatgcggaaaaatgttttgagttttggtgcaaaaatggtggcgattgtggcacgtgtatctcgagttgcccgtacaataagccagaattctggcaccataaaatggtagataaattaacagcgctgatgcctggaccggtgcactctttcatgcgcgagatggacattactttcgggtatggtaacacctatgacaagaaggcggtgaaaaaattttggaacgaagaatcctag

SEQ ID NO: 16 - protein, 443 aa, unidentified
MEEQNIVQLDENKDPEVKKVKPAGFFQDRVRWVRPLGRSRLIELPGKAVAETVSTQLDKKLVKEWPEMPVKIRSDYKRMPQKNTIFNRAFSGDAPKHQKMMGAFWHPEPRKEPGWTQLDYALEKAAWSVNDTMAPFSQAGIPNTPAYRWDMKPDSQTYRFNSTHEATKAVKRAARFLGADLVGIARYDERWVYSSFYDPLKNQEIPADLPFKPKSVIVMAVEMDYAAFGTAPTVLASAGAGKGYSEMAVTATSVAHFISNLGYKAFGAGNDIAMSVPYAIAAGLGEAARNGMVVTYKYGPRVRLCKVFTEMELEWDKPVTFGVRHFCENCMRCADACPSKAIPKDKKPSFKVNNKSNNPGVEKWAVDAEKCFEFWCKNGGDCGTCISSCPYNKPEFWHHKMVDKLTALMPGPVHSFMREMDITFGYGNTYDKKAVKKFWNEES

SEQ ID NO: 17 - DNA, 1194 bp, unidentified
  source 1..1194: mol_type = other DNA
atgtggacttccaagaccggcaatcctcgcacatatcgcatcgtcggtagtcaacggcaagtggatgaacgtgaaaccccgcatccgcgcgtcgagcgcggggaactcggcgatcgtctgctgaactggcggaaaactcgcgcggggcaggatccattccggcgcatctttggggtgggcggtggagatccgaaaaattgcttacagtacattatgaaacaagccccggaaggcggcgtcaacccgaacccggttccggtacccgatccggttacgatgacccgcgacatcaaagaggtggcccgtttctttggtgctgacgtcgtgggaattacatatctggaccaggcctacgtctactcgcaccgtgcaagacctaatccggccacgggtgaaaaaccaggtgatcctattaaagttccgcaccgatatgcaatctgcatgggctttgcatcagactacgaaaaatttctcagcaacaattcccgtatttcggatgctgagtatggattaggtaaccagcgtatgattccgaccacctttatgctggcggcatatatccgtgaaatgggctatccggcccgctcgcatgactacgcgcgtggtgaagtaaatcccattcccctagctgtgaatgcgggtttgggcgaactcgggcgtcatggtatgctgatacacgaagattatggcagtcgcatccatctgagtgtggtgacaaccgatttgccactggcggtggaccagcccgtagacattggtgtagaggacgtgtgtaaatattgtatgaaatgcgcgaggacctgtccgtcacacagcatcccattcagcgataaagaagtacacaatggcgtcgagcgttaccgtattaatgttgatagctgctacaagtaccgcttagcgggcaaagataagtggaccaactgtgttatctgcgtttctgcctgctgttataacaagccgaaagcttggtggcatactctggccgtgaaatctattaaatggacgccgatacctcttagagttcttattatcaagccacttctgtggatggatgatctgttttggggcaaacgaccgtggaaacacatgaaatggctgcgctatgacaacgcaccggaacctgcgttctgtaacattccagggtgcagcgtgcagcatacgaacttgcagcataagcctctgcatacggcgtag

SEQ ID NO: 18 - protein, 397 aa, unidentified
MWTSKTGNPRTYRIVGSQRQVDERETPHPRVERGELGDRLLNWRKTRAGQDPFRRIFGVGGGDPKNCLQYIMKQAPEGGVNPNPVPVPDPVTMTRDIKEVARFFGADVVGITYLDQAYVYSHRARPNPATGEKPGDPIKVPHRYAICMGFASDYEKFLSNNSRISDAEYGLGNQRMIPTTFMLAAYIREMGYPARSHDYARGEVNPIPLAVNAGLGELGRHGMLIHEDYGSRIHLSVVTTDLPLAVDQPVDIGVEDVCKYCMKCARTCPSHSIPFSDKEVHNGVERYRINVDSCYKYRLAGKDKWTNCVICVSACCYNKPKAWWHTLAVKSIKWTPIPLRVLIIKPLLWMDDLFWGKRPWKHMKWLRYDNAPEPAFCNIPGCSVQHTNLQHKPLHTA

SEQ ID NO: 19 - DNA, 1197 bp, unidentified
  source 1..1197: mol_type = other DNA
atgctgagctctaaacaaaacacgcctcgtagctaccgtatcgtcggcccacagcgccagctggacgaacgcgaaaccccgcacccgaaagtagatcgcggtgaattcggcgcgcgtctgcgcgattggcggaagaaccgtgcgggctccgatgccttccgtcgtctgttcggtggtgggggcgagggtgatccaaacaatacgctgcaacagattatgaagcaggcaccggaagggaaagttaacccgaatcagctccctattgatgaccccgcagaaatggcgaaacagataaagggcgttgcgcagtacctgggtgccgacgtagcagggatctgtgaattaaatccgctctatgtttattcccatcgcgcccggggtaacgctgcgatgggggaaaagcccggtgatccgattgttatgccgcataggtttgccatctgcctgggatttgcgtcaagttacgaacgctatatgtccaataattctaaaatttcggataccgaatatcaatttggcaataaccacgccatcgtgcctacttttcagttggcaagctatatcagagaaatgggttacccagcgacggcacatcatcacggtcgcagctcggtaaacccaattccgcttgcgattaatgccggactgggcgaactgggccgtcacggcatgttaatccatgaaaaatatggtagtcgactgcacttaaccgtggttacctgtgatctgcctttggcggtggacaaaccggtggacataggcgtggaggaattttgtaaatattgtaaaaagtgcgcgcgtacatgcccgagtcattcaattccgttcggcgataaaactgtcgtcaatggcgttgagaaatacgctatcaacgtcgagagctgttataaatacaaattggctggccgaggagaatggaccaactgcgtggtgtgcgtgtcgtcttgttgctataataaagcggatacgtggtaccatgacttagcaatgtggtcagtaaaagtgacaccgccgaaattgcgggtcctcgtggtcaaaccgctactgtggatcgatgaccttatttggggaaagcgcccctggaagcatatgaaatggcttggttacgataacgccccagagcctgtttattgcaccattgcagggtgcaccgctaaacacgccaaactgcaacataaaaaactgcacactgcttag

SEQ ID NO: 20 - protein, 398 aa, unidentified
MLSSKQNTPRSYRIVGPQRQLDERETPHPKVDRGEFGARLRDWRKNRAGSDAFRRLFGGGGEGDPNNTLQQIMKQAPEGKVNPNQLPIDDPAEMAKQIKGVAQYLGADVAGICELNPLYVYSHRARGNAAMGEKPGDPIVMPHRFAICLGFASSYERYMSNNSKISDTEYQFGNNHAIVPTFQLASYIREMGYPATAHHHGRSSVNPIPLAINAGLGELGRHGMLIHEKYGSRLHLTVVTCDLPLAVDKPVDIGVEEFCKYCKKCARTCPSHSIPFGDKTVVNGVEKYAINVESCYKYKLAGRGEWTNCVVCVSSCCYNKADTWYHDLAMWSVKVTPPKLRVLVVKPLLWIDDLIWGKRPWKHMKWLGYDNAPEPVYCTIAGCTAKHAKLQHKKLHTA

SEQ ID NO: 21 - DNA, 1215 bp, unidentified
  source 1..1215: mol_type = other DNA
atgcataccggccgcaacgacgcagcgctccgtgcacgtactcgggggcgagcccgtgcggcggcgacagcgtccgatacggacgcgggttttaccgtggaagccaactttgaacgttttagccaggccgatgacgtgttttcgcgttcgcgcaccgacagtgagcttcgcgatgaaaaagcagataaattttattcaacttatcggcggcctctggaaaattggcgcaaagcgaaggggttccgccagttagattatgcattccgtaacgcaacctggcatgtagccgacgttttcgccgaaatgtatgaggatgacgatcgccgagatggatttctggacccacttagcatgttgcgcgatggcgctgcggaacaagtcgactgtggctccccgagtgatgcaagcaaactgttgaaacacgctgcgtctaccgcgggcgcggacctggtcggcgttgcggcatatgatgaacgttggacctacacggatcgtttctcacaggccaccggcaccggaaaaccgaacccgttacccgaagaaattaataaagttattgtcattggtcaagccatggatgagagattgattgatactgctcctagcgcactgtctggcgcggccacggggatgggctattcacaggacgcggttgtgctgctgaccgtggctcaattcattcgtaatctcggttacactgccgttgccagcatgaatgataccgctctggcaatcccgtacgctatcaaagcgggcctgggtgaatatggtaagcatggactggtaattacgcccgagttcgggacgtcagtccgcttcggcaagatttttacggacatgccacttcgtgaagataccccgatccgctttggtgtcgaggagatgtgcaatatttgcaacgcatgcagtaaagcttgtccgtcccgtgccatcccggataagaaaccgtctacggaccgccacaacaaatctaatatcgtgggtattcgtaaatggagtatagacggtgaaaagtgctttagctactggagcaaaatcaactcggattgctcggtgtgtgtgcgagtttgtccttacacacgcgattacacacagagacggaatcgcgcctggctgcgcttagccgattccccgctccgtaaactagctctgaggatcgatcgccgtataggtggcgggaaacgcgtgcaggcggaaacatggtggccagtatag

SEQ ID NO: 22 - protein, 404 aa, unidentified
MHTGRNDAALRARTRGRARAAATASDTDAGFTVEANFERFSQADDVFSRSRTDSELRDEKADKFYSTYRRPLENWRKAKGFRQLDYAFRNATWHVADVFAEMYEDDDRRDGFLDPLSMLRDGAAEQVDCGSPSDASKLLKHAASTAGADLVGVAAYDERWTYTDRFSQATGTGKPNPLPEEINKVIVIGQAMDERLIDTAPSALSGAATGMGYSQDAVVLLTVAQFIRNLGYTAVASMNDTALAIPYAIKAGLGEYGKHGLVITPEFGTSVRFGKIFTDMPLREDTPIRFGVEEMCNICNACSKACPSRAIPDKKPSTDRHNKSNIVGIRKWSIDGEKCFSYWSKINSDCSVCVRVCPYTRDYTQRRNRAWLRLADSPLRKLALRIDRRIGGGKRVQAETWWPV

SEQ ID NO: 23 - DNA, 1176 bp, unidentified
  source 1..1176: mol_type = other DNA
atgtctaaacaccagaattatccaattcagcatgaacacgatgcttctgccggcatcgtggtcactgaggactttgaacgctttagccaacgaaatgatattttcacacgcgcattttgggacgattcggtccggactaagcaaaccaaagccttttttgcctcctatcgtatggaggcggcaccgcgccgcgggagcggattctcccagcgcgactttgcactgcgtaacgcgtcgtggctgatcagcgacgtggtgagtaatcgtaacgcggaaaacggaatgcgtgaaggtttccaggcgcccattcaaccggatacgcccgtggcagaagagcgtattgatgtggatgatccaggccgcatgtcagttgaaatcaaacgtattgctggttttttcggagctgacttatgtggcataaccgacatggatgaacgctggatttatgccgcacgtgtggatacgcgtgatatgtcagacgcgccgcacgatctgccggcgggcctgtcatcggtgatcgtcctgggccatgaaatggatcgcgaactcgtggccacgtacccgtccgccctggcgggtgccgccaccggccgtgaatactcgcatgaagcgagcattgttatgcagttagcggcgtatattcgcaatctggggtacgaagcggttccgagtatgaacgatacggcactcgtaataccttatgcagttaaagccggcctgggcgaatacgcccggaaccagctcgtaatcaccccggagttgggtccgcgtcttagatttagcaaaattttcacaaatcttccgctgacgcatgatacaccgaagccgaaaggggtacgcgcattctgtgacatctgcaccaggtgtgcggatgcatgcccagttaaagctcttccctacggtccaccttctaccgataccgctaacattagcgctatcaaaggcgtccggaagtggaccagtgatgcggagaaatgctttagtttttgggccaaactgtccagcgactgcgccatctgcatgagagtttgtcctttcaaccgcgactataaaactgcgggtaatcgcctgtggctgaagttggctctgggtcctttccggcgattggcgttatggctagcacgtaatcatggtccacgtcgcaaaccggatgagtggtggcgtggcattgggtag

SEQ ID NO: 24 - protein, 391 aa, unidentified
MSKHQNYPIQHEHDASAGIVVTEDFERFSQRNDIFTRAFWDDSVRTKQTKAFFASYRMEAAPRRGSGFSQRDFALRNASWLISDVVSNRNAENGMREGFQAPIQPDTPVAEERIDVDDPGRMSVEIKRIAGFFGADLCGITDMDERWIYAARVDTRDMSDAPHDLPAGLSSVIVLGHEMDRELVATYPSALAGAATGREYSHEASIVMQLAAYIRNLGYEAVPSMNDTALVIPYAVKAGLGEYARNQLVITPELGPRLRFSKIFTNLPLTHDTPKPKGVRAFCDICTRCADACPVKALPYGPPSTDTANISAIKGVRKWTSDAEKCFSFWAKLSSDCAICMRVCPFNRDYKTAGNRLWLKLALGPFRRLALWLARNHGPRRKPDEWWRGIG

SEQ ID NO: 25 - DNA, 1020 bp, unidentified
  source 1..1020: mol_type = other DNA
atgactctctcggttcaaaatttgtctggttggaaagagtgttcggtaagtacggtgacgtggccgaaccctccgcggttagatacgcagcgtttttataacgccctcactaactacgataaacggctggcgatgccatttgaagacttcaccccgttccgtgttgctgcaggagatgtcgacatatttggcgtaaaaggcggtgcaggcccgccgttgctgctgctgcacggccacccccagacacatttgatttggcatcggtgtgtggcgcaactggccaaacatttcaccattattgcgacggatctgcgtgggtacggagcctccgcgaaacctgaaagcgacgctacacacgccgcctatagcaagcgtgctatggcagctgatcaggtagctgttatgcgacactttggctacgaaagatttctggtgtgcgcgcatgatcgcggcgcacgagtggcccaccgtatggcccttgaccatcctgatgcggtcgaacgcttaatgctgcttgatatcgccccgaccctcgctatgtacgaagcaactgataggaccttcgcaaccttgtattttcactggttctttctgatccaaccagagccgttacctgaaaccctgattggtgcgaatccagacgtgtatgtcgaccgcgtgatgggtagccgtcatgcgggcttagccccgtttgcgccagaagcacttgatgcgtatcgtagtgctctacgccagcccggcgccgtacatgcgatgtgtgaagactaccgcgcatcagcgacgattgatctggaacacgaccgcgcggatattgagtgcggtcataagatcggttgtccgctgcgcgtgctgtggggtgaagaaggggttatccagaaatgcttcgagccgctggatgaatggcgccgtgttgcgcgcgatgtttccggacgtgccctgccctgcgggcattatatcccggaggaagtcccggaagacctggtgaccgagatgcttgcgttctttgaggcagtcgaacag

SEQ ID NO: 26 - protein, 340 aa, unidentified
MTLSVQNLSGWKECSVSTVTWPNPPRLDTQRFYNALTNYDKRLAMPFEDFTPFRVAAGDVDIFGVKGGAGPPLLLLHGHPQTHLIWHRCVAQLAKHFTIIATDLRGYGASAKPESDATHAAYSKRAMAADQVAVMRHFGYERFLVCAHDRGARVAHRMALDHPDAVERLMLLDIAPTLAMYEATDRTFATLYFHWFFLIQPEPLPETLIGANPDVYVDRVMGSRHAGLAPFAPEALDAYRSALRQPGAVHAMCEDYRASATIDLEHDRADIECGHKIGCPLRVLWGEEGVIQKCFEPLDEWRRVARDVSGRALPCGHYIPEEVPEDLVTEMLAFFEAVEQ

SEQ ID NO: 27 - DNA, 888 bp, unidentified
  source 1..888: mol_type = other DNA
atgttcttcgaagattttaccccgtttcgttttgccgccgacgatgtggacatctatggcgttaaaggcggtgcgggccctccgctgttgcttttacacgggcacccgcagtcccatttgatttggcatagatgcgccgcccgccttgcggaacactttaccgttatcgctaccgacttacgaggctacggcgcctctgctaagcccccgtcggacgcaagccatatgccgtactcaaaacgggctatggcagcagatcaggttgcggtgatgcgccacttcggtttcgaccagtttctggtctgcgcgcatgatcggggagcgcgcgtggcgcaccgcatggctttagaccatcccgccgcagtggagcgtctgatgctgctcgatatagcaccgactctggcgatgtatgaaggaaccgatcgcacgtttgccacgctgtattttcattggttcttcctgattcagccagagccattgccagaaacactaattgaaggcaacccggcggcttacgttgatagggtcatgggtagccgccatgccggcctggccccgtttgcaccacaagcccttgaagcgtatcgtaacgcgttacgccaaccgggcgccgtacacgcaatgtgtgaagactatcgtgcagcggcgactatcgatctggaacatgatcgtgcggatattgagcgtggtaataaaattggttgtcctctccgcgtgctgtggggggtagacggtgtcatcgaaaaatgcttcgaacctctcgtggagtggcgtaaagtcgcgcgagatatcagtggtcgtgctctgccctgtgggcattacattccggaggaggcgccggatgaactggtagcagaaatgctgagtttttttgaagctgttgatctg

SEQ ID NO: 28 - protein, 296 aa, unidentified
MFFEDFTPFRFAADDVDIYGVKGGAGPPLLLLHGHPQSHLIWHRCAARLAEHFTVIATDLRGYGASAKPPSDASHMPYSKRAMAADQVAVMRHFGFDQFLVCAHDRGARVAHRMALDHPAAVERLMLLDIAPTLAMYEGTDRTFATLYFHWFFLIQPEPLPETLIEGNPAAYVDRVMGSRHAGLAPFAPQALEAYRNALRQPGAVHAMCEDYRAAATIDLEHDRADIERGNKIGCPLRVLWGVDGVIEKCFEPLVEWRKVARDISGRALPCGHYIPEEAPDELVAEMLSFFEAVDL

SEQ ID NO: 29 - DNA, 921 bp, unidentified
  source 1..921: mol_type = other DNA
atgctggaacttccgaacgataaacgcgatgcaatggccttcgagaattttacgccatttcgcgttgcggtgggtgatgtggatatctttggggtgaaagggggcgcaggcccgcccttgcttctgcttcacggccatccgcagagccatctgatttggcaacgctgtgcagctcgtttggcggcacacttcacggttatcgcgacggacttacggggctatggtgcttctggtaagccggcgtccgatgccacccatatgccttattcgaaacgcaccatggctgcggatcaggtcgccgtgatgcgccatttcggcttcgataagtttctagtatgcgctcacgatagaggagcgcgtgttgcacaccggatggccctggaccacgcggacgcggtagaacgcctgatgttgctggacattgctccgacactggcaatgtatgaggcgaccgacaggactttcgcgaccttatacttccactggttctttctcatccaaccagagcccctgccggagactctgattggtgcaaacccagccgcatatgttgacgcagtgatgggaggacgtcatgcgggtttagccccgtttgatccggccgcgctcgaagcttatcgcgccgctctcgctcagcctggcgcagtccatgccatgtgcgaggactaccgtgcgagtgcaagcatcgatctggaacatgatcgtgccgatatagaacgcggtcacaaaattggctgcccattgcgagtgctgtggggggacaaaggcgtcattgaaaaatgttttgatgccctggcggaatggcgtcatgtggcgcgtgatgttagcggtcgtgcgctgccgtgtggccattacattcctgaagaagccagtgacgagctggtcgcggaaatgttatcattttttgaagccgtagaacag

SEQ ID NO: 30 - protein, 307 aa, unidentified
MLELPNDKRDAMAFENFTPFRVAVGDVDIFGVKGGAGPPLLLLHGHPQSHLIWQRCAARLAAHFTVIATDLRGYGASGKPASDATHMPYSKRTMAADQVAVMRHFGFDKFLVCAHDRGARVAHRMALDHADAVERLMLLDIAPTLAMYEATDRTFATLYFHWFFLIQPEPLPETLIGANPAAYVDAVMGGRHAGLAPFDPAALEAYRAALAQPGAVHAMCEDYRASASIDLEHDRADIERGHKIGCPLRVLWGDKGVIEKCFDALAEWRHVARDVSGRALPCGHYIPEEASDELVAEMLSFFEAVEQ

SEQ ID NO: 31 - DNA, 888 bp, unidentified
  source 1..888: mol_type = other DNA
atggccttcgaaaatttcaccccgttccgcgtggcagtaggtgatgttgatatcttcggagtgaaaggtggcgcaggtcctccgttacttctgctgcacggccatccacaaagtcatcttatttgggcacgctgtgctgcccagctggcggaacattttacggtaattgcgactgacttacgtgggtacggcgcgagcggcaaacccccgtcagatgcggaccataccccgtattcgaaacgagtgatggcagctgatcaggtggcagtcatgcgccacttcggatttgaaagatttctggtctgtgcgcacgatcgtggcgctcgtgttgctcaccgtatggccctggatcacccggacgccgttgaacgccttatgttactggatatcgcccctacactggccatgtacgaagcgaccgatcgcacgtttgctaccctatactttcattggttctttctcatccagccagaaccgctcccggaaactctgattggagcgaacccacgtgcgtatgtggacgcggtaatgggttctcgacatgccggcctcgcacctttcgacccggcggcactggatgcgtatcgttccgcgctggcgcaacccggtgcggtccatgcaatgtgcgaggactatcgcgccagcgccagcatcgatctggaactggatagggccgacattgagcgtgggcataaaattggttgtccactgcgcgttttgtggggtgataagggcgttattgagaaatgctttgatgctttgggggagtggcgtcgggtcgcgcgcgatgtgtcgggccggtccctggactgcggccactatataccggaggaagccagtgaagaattggtggttgaaatgttagcattttttgaggctgtggaacag

SEQ ID NO: 32 - protein, 296 aa, unidentified
MAFENFTPFRVAVGDVDIFGVKGGAGPPLLLLHGHPQSHLIWARCAAQLAEHFTVIATDLRGYGASGKPPSDADHTPYSKRVMAADQVAVMRHFGFERFLVCAHDRGARVAHRMALDHPDAVERLMLLDIAPTLAMYEATDRTFATLYFHWFFLIQPEPLPETLIGANPRAYVDAVMGSRHAGLAPFDPAALDAYRSALAQPGAVHAMCEDYRASASIDLELDRADIERGHKIGCPLRVLWGDKGVIEKCFDALGEWRRVARDVSGRSLDCGHYIPEEASEELVVEMLAFFEAVEQ

SEQ ID NO: 33 - DNA, 888 bp, unidentified
  source 1..888: mol_type = other DNA
atggcatttgaaaatttcaccccgttccgcgttgcagtaggcgacgttgacatctttggggtcaagggtggtgcgggcccgccgctgttgttattgcacggtcatccgcagagccatctcatttggcagcgttgcgcagctcagctggcgaaacattttactgtcatagcgacggatctccgcggctacggagcgagcggcaaaccaccatcagacgcgcaacacactccgtattctaaaagggcgatggccgcggatcaagtggctgtaatgcgcgagtttgggtttgaacgattccttgtctgcgcacacgatcgtggtgcccgtgtggctcatcgtatggctctggaccacccggacgccgtagagcgcctgatgctgctggatattgcaccgacgctagccatgtatgaagccaccgatcgcgcgttcgcgacccactatttccattggttttttctgatccagccggaaccgctccccgagacactgattggaatgaaccctgccgcgtatgtggatgctgttatgggagcacgtcacgcggggctggctcccttcgagcctgatgcgttagacgcctatcgttcggccctggcacaacctggcgccgtgcatgcaatgtgtgaagattaccgcgccagtgccagtatcgatcttgaacatgacagagcggatattgaacgcggccataaaatcgcgtgcccgttacgtgtgctttggggtgataaaggtgttattggcaagtgtttcgatgcgttggctgagtggcgccacgtcgcacgggatgtgtccggccgggcgctgagctgtggtcattacattccagaagaagccccagacgaactgatcgcagagatgctgtcgttttttgaagccgttgaacag

SEQ ID NO: 34 - protein, 296 aa, unidentified
MAFENFTPFRVAVGDVDIFGVKGGAGPPLLLLHGHPQSHLIWQRCAAQLAKHFTVIATDLRGYGASGKPPSDAQHTPYSKRAMAADQVAVMREFGFERFLVCAHDRGARVAHRMALDHPDAVERLMLLDIAPTLAMYEATDRAFATHYFHWFFLIQPEPLPETLIGMNPAAYVDAVMGARHAGLAPFEPDALDAYRSALAQPGAVHAMCEDYRASASIDLEHDRADIERGHKIACPLRVLWGDKGVIGKCFDALAEWRHVARDVSGRALSCGHYIPEEAPDELIAEMLSFFEAVEQ

SEQ ID NO: 35 - DNA, 885 bp, unidentified
  source 1..885: mol_type = other DNA
atggcatttgaaaatttcacacctttccgcgtggcggtgggtgatgtggatatctttggcatgaaaggcgggacgggtccccctctcttgctgctgcatggtcatccgcaaagccatctgatttggcaccgctgcgccgcgcaacttgcggcgcatttcaccgtcattgccacagatctgcgcgggtatggtgctagcggcaagccaccgagtgatgcgacccacactccgtatagtaaacgcaccatggcggcagatcaggtagccgtaatgcggcattttggctttgcccgttttctcctgtgtgcacacgaccgtggcgcgcgtgttgcgcaccgcatggcgctggatcacgctgatgcggtggagcgtctaatgttgctggacattgcgccgacgctggccatgtatgaagccactgaccgcgcctttgcgacgcgctactttcactggttctttcttattcagccggaaccgctgccggaaaccttgatcggtatgaaccccgctgcctatgtggatgcggtcatggggggtcggcatgccggactcgcgccattcgagccatccagcctggacgcgtatcgtgcggccctggcacagccgggcgcagtacacgctatgtgtgaagactaccgtgcttcagcttccatcgatctggagcatgaccgagccgatatagaaagaggagcaaaagttggctgtcctctgagggttttatggggagataaaggtgtgatcgaacagtgctttgatgctttagctgaatggcgtcatgtcgcacgcgatgcatcgggccgtgccctgccgtgcggccattacattccggaagaagccccagacgaacttttagcggagatgttatctttcttcgcagcagttgag

SEQ ID NO: 36 - protein, 295 aa, unidentified
MAFENFTPFRVAVGDVDIFGMKGGTGPPLLLLHGHPQSHLIWHRCAAQLAAHFTVIATDLRGYGASGKPPSDATHTPYSKRTMAADQVAVMRHFGFARFLLCAHDRGARVAHRMALDHADAVERLMLLDIAPTLAMYEATDRAFATRYFHWFFLIQPEPLPETLIGMNPAAYVDAVMGGRHAGLAPFEPSSLDAYRAALAQPGAVHAMCEDYRASASIDLEHDRADIERGAKVGCPLRVLWGDKGVIEQCFDALAEWRHVARDASGRALPCGHYIPEEAPDELLAEMLSFFAAVE

SEQ ID NO: 37 - DNA, 1041 bp, Mycobacterium sp.
  source 1..1041: mol_type = other DNA
atgagcgaaactatactaagtctgcgtttaggcgcgcacacctcacgtgctcggggcgtaccgggtcgcggttgctatggcgtagccgtaccggcggcccagcatgcgccgcaacgtttcgtcgatagcgctggcgtgcgcattgcagtatatgaggaaggtaacccggaagggccgacggttgttctggcgcatgggtggccggactcgcacgttctttgggatggagtcgttccgctgctggctgaacgcttcaggatcattcgttacgacaatcgtggggtgggtttgtcaagtgcgccaaaaccggtgtcggcctatgcaatgggcttattcgcggacgattttgcggcagtcgctggtgaactcagtcctggacgtccagttcatgtgttagcccacgattggggctcagttggtgtttgggagtatctgaagcgacctggtgccggtgacagagttgcgtcctttaccagtgtgtccgggccgtctcaagatcagcttgcgaactacgtctttggcggtctgcgccgtccttggcagccgcgacgcttcggacgcgcagcgagccaggctctgcggctgacctacatggtgtttttttctatcccagttgcggccccggccctgatccgcctgacgctgagctctgcggcattgcgtcgccgcgtggtggataatattccgtatagccagattcatcactccgcagatgtcgcccgtgatgcagcacgctccgtgaaaatctaccctgccaattattttcgtacttttgcggggctcggccgcggcggccatgccgtacaggtggtggacgtgccggtacaactgattgtcaacacacgcgataaatacgtccgtccccacggctatgacgataccgcgcgttgggtgcctcgcctctggcggagagatattaaagctggtcatttttcgccaatgagccatcccgccgttatggccgctgcagtccatgatttcgcggacttggcggagggcaaaccaccctcggatgaaatgcttcgtgcacaggtgcggcga

SEQ ID NO: 38 - protein, 347 aa, Mycobacterium sp.
MSETILSLRLGAHTSRARGVPGRGCYGVAVPAAQHAPQRFVDSAGVRIAVYEEGNPEGPTVVLAHGWPDSHVLWDGVVPLLAERFRIIRYDNRGVGLSSAPKPVSAYAMGLFADDFAAVAGELSPGRPVHVLAHDWGSVGVWEYLKRPGAGDRVASFTSVSGPSQDQLANYVFGGLRRPWQPRRFGRAASQALRLTYMVFFSIPVAAPALIRLTLSSAALRRRVVDNIPYSQIHHSADVARDAARSVKIYPANYFRTFAGLGRGGHAVQVVDVPVQLIVNTRDKYVRPHGYDDTARWVPRLWRRDIKAGHFSPMSHPAVMAAAVHDFADLAEGKPPSDEMLRAQVRR

SEQ ID NO: 39 - DNA, 888 bp, unidentified
  source 1..888: mol_type = other DNA
atggcatttgaagattttactccctttagcgtcacggttggcgacgtggacatttttggcgttaaaggtggcgcggggccaccgctcctgttgctgcatggccatcctcaatcccacctgatttggcagcgctgtgccgcccagttagctcaacatttcacggttatcgcaaccgatctcagaggttatggtgcaagttccaaaccgagcagtgacgcgcaccatactccgtattcaaaacggaccatggcagccgatcaagtagcggtaatgcgccacctgggttttgagcgattcctggtttgtgcccacgatcgtggggcgcgagtggcgcaccgtatggcgctggatcacgctgacgctgtagaaaggctgatgttgctggatattgcccccaccctagctatgtatgaagcgaccgaccgcacattcgcaacactgtactttcattggttctttttaattcagcctgagccgctgccagagacgttaataggagccaacccggctgcctacgtggatagcgtgatgggttctcgtcatgctggccttggtccgtttgatccggaagcactggcggcgtatcgctcggcgctggcccagcctggcgctgttcatgcgatgtgcgaagattatcgtgcgtcagcgagtatcgatttagaacacgaccgtgcagacattgagcgtggccataaaatcgcatgtccgctgcgcgtcctgtggggagataagggagtgattgaaaaatgctttgacgccctcggggaatggcgccaggtggcacgcgatgtctcgggtcgtgcgctttcttgcggccattacatcccagaagaggccccggatgagttggtcgcggaaatgcttagcttcttcgaagccatcgaacgg

SEQ ID NO: 40 - protein, 296 aa, unidentified
MAFEDFTPFSVTVGDVDIFGVKGGAGPPLLLLHGHPQSHLIWQRCAAQLAQHFTVIATDLRGYGASSKPSSDAHHTPYSKRTMAADQVAVMRHLGFERFLVCAHDRGARVAHRMALDHADAVERLMLLDIAPTLAMYEATDRTFATLYFHWFFLIQPEPLPETLIGANPAAYVDSVMGSRHAGLGPFDPEALAAYRSALAQPGAVHAMCEDYRASASIDLEHDRADIERGHKIACPLRVLWGDKGVIEKCFDALGEWRQVARDVSGRALSCGHYIPEEAPDELVAEMLSFFEAIER

SEQ ID NO: 41 - DNA, 888 bp, unidentified
  source 1..888: mol_type = other DNA
atgttttttgaagactttacgccgtttcggttcgcagatggagaagttgatattcatggcgtcaaaggtggtgctggtcccccgctactgttgctgcacggtcatccgcagaaccacctgatctggcaccgttgcgcggcacgcttagcgcagcatttcaccgttatagctccagatctgcgaggttatggagcctcggggaaaccggcgggagacgccgcgcatcttacctacagtaaacgtgccatggctgccgaccagatggccttaatgcgtcatttcggccacgaacgcttcctggtgtgtgcgcacgatcgcggcgcccgagtagctcaccgtctggcccttgaccatccggcagcagtggaacggctgatgttactggatattgcgccgaccctcgcgatgtatgagcgcacagatcgtgcattcgccaccgcttattttcactggttttttcttattcagcctgcgccgctgcccgaaacgctgattgaggcgaatccagcggcctatgttgacggggtcatgtcttcacgccacgctggtctggcaccgtttgctccggaagcactggatgcgtatcgtcgcgctctcgcccaacctggcgcggtgcatgcgatgtgtgaggactaccgcgccgcggcaactatcgatttggaacatgatcgggccgatttagaacgtgggaacaaaattggttgtcctctccgcgtgctgtggggcgaacatggcgtgatcgaacaatgctttgaaccactggatgaatggcgtaaggtcgccagagatgtatccggcagggcattgccctgcggccattacatcccagaggaggcgccggacgagttgattgcagaaatgatgcgcttcttcgatgcgactgaaagc

SEQ ID NO: 42 - protein, 296 aa, unidentified
MFFEDFTPFRFADGEVDIHGVKGGAGPPLLLLHGHPQNHLIWHRCAARLAQHFTVIAPDLRGYGASGKPAGDAAHLTYSKRAMAADQMALMRHFGHERFLVCAHDRGARVAHRLALDHPAAVERLMLLDIAPTLAMYERTDRAFATAYFHWFFLIQPAPLPETLIEANPAAYVDGVMSSRHAGLAPFAPEALDAYRRALAQPGAVHAMCEDYRAAATIDLEHDRADLERGNKIGCPLRVLWGEHGVIEQCFEPLDEWRKVARDVSGRALPCGHYIPEEAPDELIAEMMRFFDATES

SEQ ID NO: 43 - DNA, 855 bp, unidentified
  source 1..855: mol_type = other DNA
atgctgtatgtgaacggggtagatatcagctaccgcaaaggtggcaccggtccaggattgctgctcctgcacggtcatccgcaaacccatgtcatctggcacaaagtagcgggtaatcaactcgccgaacattttactgtcgtggctgctgatctgcgcggctacggtgactcctcgaagccgttagcagacgatttgcacgccaattattccaaacgtcagatggcgcgcgacggcgttgaattagatgcgggaccgggtcgttttgaacagttttctgttctggcgcatgatcgtggcgcgcgcgtggctcatcggctcgccctggatcacccgagtgcagtccaacgtatggttctattggatatcgctccgacgttaagcatgtatgcgcagacagatgaagcctttgcgcgtgcgtactggcattggttcttccttattcgacctgctccactgccagaagcgttaattggctcgaacccggaactgtatctgcgcagcgtaatgggcagtcgctcagcgggattgaaacccttcactgacgaagccttcgccgagtatttgagatgcctgcagctgcctggtaccgcacgggggatctgtgaagactatcgtgcagccgcggggattgacttagagcatgatcaggccgatattgatgccggccaccatctgaacctgcccctgctggtgatgtggggtgcagagggcacggtcggtcgttgctttgaacctcttaaagagtggcagaaagtggcgacggacgttagggggaaggcactgccggcaggccactacatagcagaggaagtgccggaactgctgcttggcgaagttctcacctttcttcgc

SEQ ID NO: 44 - protein, 285 aa, unidentified
MLYVNGVDISYRKGGTGPGLLLLHGHPQTHVIWHKVAGNQLAEHFTVVAADLRGYGDSSKPLADDLHANYSKRQMARDGVELDAGPGRFEQFSVLAHDRGARVAHRLALDHPSAVQRMVLLDIAPTLSMYAQTDEAFARAYWHWFFLIRPAPLPEALIGSNPELYLRSVMGSRSAGLKPFTDEAFAEYLRCLQLPGTARGICEDYRAAAGIDLEHDQADIDAGHHLNLPLLVMWGAEGTVGRCFEPLKEWQKVATDVRGKALPAGHYIAEEVPELLLGEVLTFLR

(19) United States
(12) Patent Application Publication
(10) Pub. No.: US 2025/0065383 A1
(43) Pub. Date: Feb. 27, 2025

(54) Methods and Compositions for Removing PFA

(71) Applicant: BluumBio Inc., Berkeley, CA (US)

(72) Inventors: Katherine French, Albany, CA (US); Azion White, Oakland, CA (US); Andrew Hendrickson, Lafayette, CA (US); Jordan Baker, Oakland, CA (US)

(73) Assignee: BluumBio Inc., Berkeley, CA (US)

(21) Appl. No.: 18/814,014

(22) Filed: Aug. 23, 2024

Related U.S. Application Data
(60) Provisional application No. 63/578,753, filed on Aug. 25, 2023.

(51) Int. Cl. B09C 1/10

(52) U.S. Cl. CPC B09C 1/10; B09C 2101/00

(57) ABSTRACT

The present disclosure provides recombinant defluorinating enzymes for the remediation of PFAs, PCBs, and other organo-halides, polynucleotides encoding the recombinant defluorinating enzymes, host cells expressing the recombinant defluorinating enzymes, and methods of using the recombinant defluorinating enzymes. Host cells can be engineered to express the recombinant defluorinating enzymes, for remediation of PFAs, PCBs, and other organo-halides.

The official copy of the Sequence Listing is submitted concurrently with the specification as an xml file, made with WIPO Sequence Version 2.1.0, via EFS-Web, with a file name of “BBI0008.xml”, a creation date of Oct. 4, 2024, and a size of 70 kilobytes. The Sequence Listing filed via EFS-Web is part of the specification and is incorporated in its entirety by reference herein.

### CROSS-REFERENCE TO RELATED APPLICATIONS

This application claims priority to U.S. provisional application Ser. No. 63/578,753 filed Aug. 25, 2024, which is hereby incorporated by reference in its entirety for all purposes.

### BACKGROUND

The global population continues to rise at an astonishing rate, with estimates suggesting it will be in excess of 9 billion in 2050. The intensive agricultural and industrial systems needed to support such a large number of people will inevitably cause an accumulation of soil, water and air pollution. Estimates have attributed pollution to 62 million deaths each year, 40% of the global total, while the World Health Organization (WHO) have reported that around 7 million people are killed each year from the air they breathe. Water systems fare little better, with an estimated 70% of industrial waste dumped into surrounding water courses. The world generates 1.3 billion tons of rubbish every year, the majority of which is stored in landfill sites or dumped into the oceans.

Per- and polyfluoroalkyl substances (PFASs) have been in use since 1940 in various formulations in the industrial and consumer sectors due to their high chemical and thermal stability. In recent years, PFASs have caused global concern due to their presence in different water and soil matrices, which threatens the environment and human health. These compounds have been reported to be linked to the development of serious human diseases, including but not limited to cancer. For this reason, PFASs have been considered as persistent organic compounds (COPs) and contaminants of emerging concern (CECs).

PFAS chemicals are everywhere and they don't break down. This is why PFAS chemicals are known as forever chemicals because they never go away. The chemistry is complex because PFAS are not one chemical compound, they are a class of chemical compounds that share the common carbon-fluorine bond. However, they vary widely by their size, structure, toxicity, and mobility in the environment. The carbon to fluorine bond is one of the strongest bonds in organic chemistry, making PFAS compounds particularly resistant to degradation. Since they do not break down and they were used in lots of materials, they are being found everywhere in the environment.

PFAS are resistant to treatment and degradation, and typically go through water and wastewater treatment plants untouched and end up in discharges to surface water and to the land. Since they persist and go largely untreated, they often cycle through the environment and create widespread impact.

It's very difficult to remediate PFAS. Many typical water purification techniques are not able to remove PFAS from water. These ineffective techniques include bio-degradation, micron filtration, sand filtration, ultrafiltration, coagulation, flocculation, clarification, and oxidation by ultraviolet light, hypochlorite, chlorine dioxide, chloramine, ozone, or permanganate. None of these techniques will work. The only techniques that have been found to remove PFAS from water, are carbon adsorption, ion exchange, and reverse osmosis.

PFAS compounds are very resistant to biological, chemical and heat degradation; therefore, many of the remediation techniques that are used for petroleum and chlorinated solvent sites are largely ineffective on PFAS. Since they cannot be easily degraded, they need to be removed. Most remediation technologies to date have focused on pumping water from the ground and treating it through either reverse osmosis systems or filtration (carbon or ionic) media. However, this simply concentrates PFAS onto a different media that now needs disposal. Soil impacts are typically excavated and disposed of at off-site disposal facilities. As this issue comes to light, more disposal facilities may reject these waste streams.

Cleaning up PFAS contamination from human activities is one of the greatest unmet challenges of the twenty-first century.

### SUMMARY

Disclosed herein are defluorinating enzymes, nucleic acids encoding the defluorinating enzymes, host cells engineered with nucleic acids encoding the defluorinating enzymes, and compositions comprising multiple species of microorganisms including host cells engineered with nucleic acids encoding the defluorinating enzymes. The disclosure also relates to methods of remediating or removing fluorinated alkyl compounds from water or solids (e.g., soil or landfills) using the defluorinating enzymes, host cells engineered with nucleic acids encoding the defluorinating enzymes, and compositions comprising multiple species of microorganisms including host cells engineered with nucleic acids encoding the defluorinating enzymes.

Defluorinating enzymes disclosed herein can have an amino acid sequence of one of SEQ ID NO: 2, 4, 6, 8, 10, 12, 14, 16, 18, 20, 22, 24, 26, 28, 30, 32, 34, 36, 38, 40, 42, or 44, or an amino acid sequence that has 70%, 80%, 90%, 95% or 99% sequence identity with one of SEQ ID NO: 2, 4, 6, 8, 10, 12, 14, 16, 18, 20, 22, 24, 26, 28, 30, 32, 34, 36, 38, 40, 42, or 44. Defluorinating enzymes disclosed herein can be encoded by a nucleic acid having the sequence of one of SEQ ID NO: 1, 3, 5, 7, 9, 11, 13, 15, 17, 19, 21, 23, 25, 27, 29, 31, 33, 35, 37, 39, 41, or 43, or a nucleic acid sequence that has 70%, 80%, 90%, 95% or 99% sequence identity with one of SEQ ID NO: 1, 3, 5, 7, 9, 11, 13, 15, 17, 19, 21, 23, 25, 27, 29, 31, 33, 35, 37, 39, 41, or 43. The defluorinating enzyme may also be encoded by a nucleic acid that hybridizes under stringent hybridization conditions to a nucleic acid having the sequence or complement of one of SEQ ID NO: 1, 3, 5, 7, 9, 11, 13, 15, 17, 19, 21, 23, 25, 27, 29, 31, 33, 35, 37, 39, 41, or 43.

Nucleic acids described herein include constructs and expression constructs that can express the defluorinating enzyme encoded therein. In an aspect, the construct or expression construct encoding the defluorinating enzyme can be transferred from a donor host cell to a recipient host cell. Transfer of the constructs can be done by homologous recombination, conjugation, transfection or transformation. Conjugation systems used herein can be promiscuous systems able to transfer nucleic acids from a donor cell to many different types of recipient cells. For example, IncA/C conjugative plasmids have a broad host range which include members of Beta-, Gamma-, and Delta-proteobacteria classes. IncP and IncPromA conjugative plasmids can transfer to a broad range of soil bacteria including recipients from eleven (11) different bacterial phyla.

Host cells for the defluorinating enzymes include, for example, aerobic, anaerobic, or facultative anaerobic microorganisms. Aerobic microorganisms include, for example, Acidimicrobium, Arthrobacter, Bacillus megaterium, Bacillus subtilis, candidatus microthrix, Delftia acidovorans, E. coli, Hyphomicrobium, Moraxella, Pseudomonas putida, several Pseudomonad species, Rhodococcus jostii, Rhodoferax, Rhodobacter, Tetrasphaera, Trichococcus. Anaerobic microorganisms include, for example, Acetivibrio, Achromobacter, Alcaligenes, Anaerolineaceae, Bacteroides, Bacillus subtilis, Bacteroides, Bifidobacterium (in the phylum Actinobacteria), Clostridium, Clostridium bornimense, Dehalobacter, Dehalococcoides, Desulfobacteraceae, Fermentimonas caenicola, Geobacter, Herbinix hemicellulosilytica, Herbinix luporum, Herbivorax saccincola, Lactobacillus, Methanobacterium, Methanobrevibacter, Methanoculleus, Methanospirillum, Methanothermobacter, Pelotomaculum, Petrimonas mucosa, Proteiniborus indolifex, Proteiniphilum saccharofermentans, Rhodopseudomonas palustris, Ruminococcus, Smithllela, Staphylococcus aureus, Streptococcus, Syntrophobacter, Syntrophus and Syntrophomonas, Thermotoga.

In an aspect, the defluorinating enzymes can increase the release of fluorine from fluorinated alkyl compounds such as, for example, fluoroacetate, trifluoroacetate, pentafluoropropionic acid, and perfluorooctanoic acid. Host cells engineered with the defluorinating enzymes can have an increased growth rate when the host cell uses a fluorinated alkyl compound as a carbon source. The defluorinating enzymes can have increased activity for releasing fluorine from fluorinated alkyl compounds when compared to a reference enzyme.

The defluorinating enzymes described herein can be used for the remediation of water, solids, landfills, soil, or biosolids. For example, defluorinating enzymes, host cells engineered with nucleic acids encoding the defluorinating enzymes, and compositions comprising multiple species of microorganisms including host cells engineered with nucleic acids encoding the defluorinating enzymes can be used in methods to remediate fluorinated compounds found in the environment, e.g., water, solids, landfills, soil, or biosolids. These methods involve contacting the defluorinating enzymes, host cells engineered with nucleic acids encoding the defluorinating enzymes, and compositions comprising multiple species of microorganisms including host cells engineered with nucleic acids encoding the defluorinating enzymes with the fluorinated compounds so that these compounds can be defluorinated.

The construct encoding the defluorinating enzyme can be engineered into a desired organism, and the construct can become part of a chromosome, or it can exist extra-chromosomally. The construct can also be designed so it is transferred by conjugation to other bacterial cells present in the sample to be remediated (e.g., soil or water bacteria). This imparts to the soil/water bacteria genes/enzymes that improve the ability of those bacteria to degrade fluorinated compounds, and/or utilize those fluorinated compounds as a carbon source. When these constructs are used to remediate fluorinated compounds, host cells with the construct encoding the defluorinating enzyme can be introduced to the environment (e.g., water, solids, landfills, soil, or biosolids) with the fluorinated compounds so that the host cells transfer the construct to bacteria and/or other organisms (e.g., plants) in the environment imparting to those other bacteria or organisms the ability to degrade the fluorinated compounds.

### DETAILED DESCRIPTION

Before the various embodiments are described, it is to be understood that the teachings of this disclosure are not limited to the particular embodiments described, and as such can, of course, vary. It is also to be understood that the terminology used herein is for the purpose of describing particular embodiments only, and is not intended to be limiting, since the scope of the present teachings will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, some exemplary methods and materials are now described.

As will be apparent to those of skill in the art upon reading this disclosure, each of the individual embodiments described and illustrated herein has discrete components and features which can be readily separated from or combined with the features of any of the other several embodiments without departing from the scope or spirit of the present teachings. Any recited method can be carried out in the order of events recited or in any other order which is logically possible.

As used in this specification and the appended claims, the singular forms “a”, “an” and “the” include plural referents unless the context clearly indicates otherwise. Thus, for example, reference to “a polypeptide” includes more than one polypeptide.

The section headings used herein are for organizational purposes only and not to be construed as limiting the subject matter described.

### Definitions

As used herein, the terms “protein”, “polypeptide,” and “peptide” are used interchangeably and are defined to mean a polymer of at least two amino acids covalently linked by an amide bond, regardless of length or post-translational modification (e.g., glycosylation, phosphorylation, lipidation, myristilation, ubiquitination, etc.). Included within this definition are D- and L-amino acids, and mixtures of D- and L-amino acids. In some embodiments of the descriptions of polypeptides, the standard single or three letter abbreviations are used for the genetically encoded amino acids (see, e.g., IUPAC-IUB Joint Commission on Biochemical Nomenclature, “Nomenclature and Symbolism for Amino Acids and Peptides,” Eur. J. Biochem. 138:9-37, 1984).

As used herein, the terms “polynucleotide” or “nucleic acid’ are used interchangeably and are defined to mean two or more nucleosides that are covalently linked together. The polynucleotide may be wholly comprised ribonucleosides (i.e., an RNA), wholly comprised of 2′ deoxyribonucleotides (i.e., a DNA) or mixtures of ribo- and 2′ deoxyribonucleosides. While the nucleosides will typically be linked together via standard phosphodiester linkages, the polynucleotides may include one or more non-standard linkages. The polynucleotide may be single-stranded or double-stranded, or may include both single-stranded regions and double-stranded regions. Moreover, while a polynucleotide will typically be composed of the naturally occurring encoding nucleobases (i.e., adenine, guanine, uracil, thymine and cytosine), it may include one or more modified and/or synthetic nucleobases, such as, for example, inosine, xanthine, hypoxanthine, etc. Preferably, such modified or synthetic nucleobases will be encoding nucleobases.

As used herein, the term “coding sequence” is defined to mean a portion of a nucleic acid (e.g., a gene) that encodes an amino acid sequence of a protein.

As used herein, the terms “wild-type” is defined to mean the form found predominantly in nature. For example, a wild-type polypeptide or polynucleotide sequence is a sequence predominantly present in an organism that can be isolated from a source in nature and which has not been intentionally modified by human manipulation.

As used herein, the terms “recombinant” or “engineered” or “non-naturally occurring” are used interchangeably and are defined to mean modified polypeptides or nucleic acids which polypeptides or nucleic acids are modified in a manner that would not otherwise exist in nature, or is produced or derived from synthetic materials and/or by manipulation using recombinant techniques. Non-limiting examples include, among others, recombinant cells expressing genes that are not found within the native (non-recombinant) form of the cell or express native genes that are otherwise expressed at a different level.

As used herein, the terms “percentage of sequence identity” and “percentage homology” are used interchangeably and are defined to mean comparisons among polynucleotides or polypeptides, and are determined by comparing two optimally aligned sequences over a comparison window, where the portion of the polynucleotide or polypeptide sequence in the comparison window may comprise additions or deletions (i.e., gaps) as compared to the reference sequence for optimal alignment of the two sequences. The percentage may be calculated by determining the number of positions at which the identical nucleic acid base or amino acid residue occurs in both sequences to yield the number of matched positions, dividing the number of matched positions by the total number of positions in the window of comparison and multiplying the result by 100 to yield the percentage of sequence identity. Alternatively, the percentage may be calculated by determining the number of positions at which either the identical nucleic acid base or amino acid residue occurs in both sequences or a nucleic acid base or amino acid residue is aligned with a gap to yield the number of matched positions, dividing the number of matched positions by the total number of positions in the window of comparison and multiplying the result by 100 to yield the percentage of sequence identity. Those of skill in the art appreciate that there are many established algorithms available to align two sequences. Optimal alignment of sequences for comparison can be conducted, e.g., by the local homology algorithm of Smith and Waterman, Adv Appl Math. 2:482, 1981; by the homology alignment algorithm of Needleman and Wunsch, J Mol Biol. 48:443, 1970; by the search for similarity method of Pearson and Lipman, Proc Natl Acad Sci. USA 85:2444, 1988; by computerized implementations of these algorithms (GAP, BESTFIT, FASTA, and TFASTA in the GCG Wisconsin Software Package), or by visual inspection (see generally, Current Protocols in Molecular Biology, F. M. Ausubel et al., eds., Greene Publishing Associates, Inc. and John Wiley & Sons, Inc., (1995 Supplement). Examples of algorithms that are suitable for determining percent sequence identity and sequence similarity are the BLAST and BLAST 2.0 algorithms, which are described in Altschul et al., J. Mol. Biol. 215:403-410, 1990; and Altschul et al., Nucleic Acids Res. 25 (17): 3389-3402, 1977; respectively. Software for performing BLAST analyses is publicly available through the National Center for Biotechnology Information website. BLAST for nucleotide sequences can use the BLASTN program with default parameters, e.g., a wordlength (W) of 11, an expectation (E) of 10, M=5, N=−4, and a comparison of both strands. BLAST for amino acid sequences can use the BLASTP program with default parameters, e.g., a wordlength (W) of 3, an expectation (E) of 10, and the BLOSUM62 scoring matrix (see Henikoff and Henikoff, Proc Natl Acad Sci. USA 89:10915, 1989). Exemplary determination of sequence alignment and % sequence identity can also employ the BESTFIT or GAP programs in the GCG Wisconsin Software package (Accelrys, Madison WI), using default parameters provided.

As used herein, the term “reference sequence” is defined to mean a defined sequence used as a basis for a sequence comparison. A reference sequence may be a subset of a larger sequence, for example, a segment of a full-length gene or polypeptide sequence. Generally, a reference sequence is at least 20 nucleotide or amino acid residues in length, at least 25 residues in length, at least 50 residues in length, or the full length of the nucleic acid or polypeptide. Since two polynucleotides or polypeptides may each (1) comprise a sequence (i.e., a portion of the complete sequence) that is similar between the two sequences, and (2) may further comprise a sequence that is divergent between the two sequences, sequence comparisons between two (or more) polynucleotides or polypeptide are typically performed by comparing sequences of the two polynucleotides or polypeptides over a “comparison window” to identify and compare local regions of sequence similarity. In an aspect, a “reference sequence” can be based on a primary amino acid sequence, where the reference sequence is a sequence that can have one or more changes to the primary sequence.

As used herein, the term “substantial identity” refers to a polynucleotide or polypeptide sequence that has at least 80 percent sequence identity, at least 85 percent identity and 89 to 95 percent sequence identity, more usually at least 99 percent sequence identity as compared to a reference sequence over a comparison window of at least 20 residue positions, frequently over a window of at least 30-50 residues, wherein the percentage of sequence identity is calculated by comparing the reference sequence to a sequence that includes deletions or additions which total 20 percent or less of the reference sequence over the window of comparison. In specific embodiments applied to polypeptides, the term “substantial identity” means that two polypeptide sequences, when optimally aligned, such as by the programs GAP or BESTFIT using standard parameters, i.e., default parameters, share at least 80 percent sequence identity, preferably at least 89 percent sequence identity, at least 95 percent sequence identity or more (e.g., 99 percent sequence identity). Preferably, residue positions which are not identical differ by conservative amino acid substitutions.

As used herein, the terms “corresponding to”, “reference to” or “relative to” are used interchangeably when used in the context of the numbering of a given amino acid or polynucleotide sequence and are defined in this context to mean the numbering of the residues of a specified reference sequence when the given amino acid or polynucleotide sequence is compared to the reference sequence. In other words, the residue number or residue position of a given polymer is designated with respect to the reference sequence rather than by the actual numerical position of the residue within the given amino acid or polynucleotide sequence. For example, a given amino acid sequence, such as that of a defluorinating enzyme, can be aligned to a reference sequence by introducing gaps to optimize residue matches between the two sequences. In these cases, although the gaps are present, the numbering of the residue in the given amino acid or polynucleotide sequence is made with respect to the reference sequence to which it has been aligned. As such, the term “corresponding to”, “reference to” or “relative to” also refers to a residue that is analogous, homologous, or equivalent to an enumerated residue in a reference polypeptide. In addition, in some embodiments, crystal structure coordinates of a reference sequence may be used as an aid in determining a homologous polypeptide residue's three dimensional structure and location of equivalent residues.

As used herein, the terms “consensus sequence” and “canonical sequence” are defined to mean an archetypical amino acid sequence against which all variants of a particular protein or sequence of interest are compared. The terms also refer to a sequence that sets forth the nucleotides that are most often present in a DNA sequence of interest. For each position of a gene, the consensus sequence gives the amino acid that is most abundant in that position in a multiple sequence alignment (MSA).

As used herein, the terms “optimal alignment” or “optimally aligned” are defined to mean the alignment of two (or more) sequences giving the highest percent identity score. For example, optimal alignment of two polypeptide sequences can be achieved by aligning the sequences such that the maximum number of identical amino acid residues in each sequence are aligned together or by using software programs or procedures described herein or known in the art. Optimal alignment of two nucleic acid sequences can be achieved by aligning the sequences such that the maximum number of identical nucleotide residues in each sequence are aligned together. Two sequences (e.g., polypeptide sequences) may be deemed “optimally aligned” when they are aligned using defined parameters, such as a defined amino acid substitution matrix, gap existence penalty (also termed gap open penalty), and gap extension penalty, so as to achieve the highest similarity score possible for that pair of sequences. Optimal alignment can be done manually or by using software programs or procedures described herein or known in the art. e.g., the BLASTP program for amino acid sequences and the BLASTN program for nucleic acid sequences.

As used herein, the terms “amino acid substitution” or “amino acid difference” are defined to mean a change in the amino acid residue at a position of a polypeptide sequence relative to the amino acid residue at a corresponding position in a reference sequence which is the primary translation product starting at the methionine initiation codon. The positions of amino acid differences generally are referred to herein as “Xn,” where n refers to the corresponding position in the reference sequence upon which the residue difference is based. For example, a “residue difference at position X as compared to the primary translation product starting at the methionine initiation codon” refers to a change of the amino acid residue at the polypeptide position corresponding to position X of a wild-type protein. Thus, if the reference polypeptide of the primary translation starting at the methionine initiation codon product for a wild type gene has a valine at position X, then an “amino acid substitution” or “residue difference at position X as compared to reference sequence” refers to an amino acid substitution of any residue other than valine at the position of the polypeptide corresponding to position X of the reference sequence. In most instances herein, the specific amino acid substitution or amino acid residue difference at a position is indicated as “XnY” where “Xn” specifies the corresponding position as described above, and “Y” is the single letter identifier of the amino acid found in the engineered polypeptide (i.e., the different residue than in the reference polypeptide). In an aspect, where more than one amino acid can appear at a specified residue position, the alternative amino acids can be listed in the form XnY/Z, where Y and Z represent alternate amino acid residues. In some instances, the present disclosure also provides specific amino acid differences denoted by the conventional notation “AnB”, where A is the single letter identifier of the residue in the reference sequence, “n” is the number of the residue position in the reference sequence, and B is the single letter identifier of the residue substitution in the sequence of the engineered polypeptide. Furthermore, in some instances, a polypeptide of the present disclosure can include one or more amino acid residue differences relative to a reference sequence, which is indicated by a list of the specified positions where changes are made relative to the reference sequence.

As used herein, the terms “conservative amino acid substitution” or “conservative amino acid difference” are defined to mean a change in the amino acid at a residue position to a different residue having a similar side chain, and thus typically involves substitution of the amino acid in the polypeptide with amino acids within the same or similar defined class of amino acids. By way of example and not limitation, an amino acid with an aliphatic side chain may be substituted with another aliphatic amino acid, e.g., alanine, valine, leucine, and isoleucine; an amino acid with hydroxyl side chain is substituted with another amino acid with a hydroxyl side chain, e.g., serine and threonine; an amino acid having aromatic side chains is substituted with another amino acid having an aromatic side chain, e.g., phenylalanine, tyrosine, tryptophan, and histidine; an amino acid with a basic side chain is substituted with another amino acid with a basic side chain, e.g., lysine and arginine; an amino acid with an acidic side chain is substituted with another amino acid with an acidic side chain, e.g., aspartic acid or glutamic acid; and a hydrophobic or hydrophilic amino acid is replaced with another hydrophobic or hydrophilic amino acid, respectively. Exemplary conservative substitutions are provided in Table 1 below.

TABLE 1

| Residue | Possible Conservative Substitutions |
|---|---|
| A, L, V, I | Other aliphatic (A, L, V, I) |
| | Other non-polar (A, L, V, I, G, M) |
| G, M | Other non-polar (A, L, V, I, G, M) |
| D, E | Other acidic (D, E) |
| K, R | Other basic (K, R) |
| N, Q, S, T | Other polar |
| H, Y, W, F | Other aromatic (H, Y, W, F) |
| C, P | None |

As used herein, the terms “non-conservative substitution” or “non-conservative amino acid difference” are defined to mean a change in the amino acid at a residue position to a different residue with significantly differing side chain properties. Non-conservative substitutions may use amino acids between, rather than within, the defined groups and affects (a) the structure of the peptide backbone in the area of the substitution (e.g., proline for glycine), (b) the charge or hydrophobicity, or (c) the bulk of the side chain. By way of example and not limitation, an exemplary non-conservative substitution can be an acidic amino acid substituted with a basic or aliphatic amino acid; an aromatic amino acid substituted with a small amino acid; and a hydrophilic amino acid substituted with a hydrophobic amino acid.

As used herein, the term “deletion” is defined to mean a modification of a polypeptide by removal of one or more amino acids from the reference polypeptide or modification of a nucleic acid by removal of one or more nucleotides from the reference nucleic acid. For example, deletions can comprise removal of 1 or more amino acids, 2 or more amino acids, 5 or more amino acids, 10 or more amino acids, 15 or more amino acids, or 20 or more amino acids, up to 10% of the total number of amino acids, or up to 20% of the total number of amino acids making up the reference enzyme while retaining enzymatic activity. Deletions can be directed to the internal portions and/or terminal portions of the polypeptide. In various embodiments, the deletion can comprise a continuous segment or can be discontinuous.

As used herein, the term “insertion” is defined to mean a modification to a polypeptide by addition of one or more amino acids from the reference polypeptide, or modification of a nucleic acid by addition of one or more nucleic acids. The variant defluorinating enzyme can comprise insertions of one or more amino acids. Insertions can be in the internal portions of the polypeptide, or to the carboxy or amino terminus. Insertions as used herein include fusion proteins as is known in the art. The insertion can be a contiguous segment of amino acids or separated by one or more of the amino acids in the reference polypeptide.

As used herein, the term “gene” is defined to mean a polynucleotide (e.g., a DNA segment) that encodes a polypeptide. The term includes regions preceding and following the coding regions as well as any intervening sequences when present (e.g., introns) between individual coding segments (exons).

As used herein, the term “homologous genes” is defined to mean a pair of genes which correspond to each other and which are identical or similar to each other. The term encompasses genes that are separated by speciation (i.e., the development of new species) (e.g., orthologous genes), as well as genes that have been separated by genetic duplication (e.g., paralogous genes).

As used herein, the terms “ortholog” and “orthologous genes” are defined to mean genes in different species that have evolved from a common ancestral gene (i.e., a homologous gene) by speciation. Typically, orthologs retain the same function during the course of evolution. Identification of orthologs finds use in the reliable prediction of gene function in newly sequenced genomes.

As used herein, the terms “paralog” and “paralogous genes” are defined to mean genes that are related by duplication within a genome. Generally, paralogs tend to evolve into new functions, even though some functions are often related to the original one.

As used herein, the term “chromosomal integration” is defined to mean the process whereby an incoming sequence is introduced into the chromosome of a host cell. The homologous regions of the transforming DNA align with homologous regions of the chromosome. Subsequently, the sequence between the homology boxes is replaced by the incoming sequence in a double crossover (i.e., homologous recombination). In some embodiments, homologous sections of an inactivating chromosomal segment of a DNA construct align with the flanking homologous regions of the indigenous chromosomal region of a host cell chromosome. Subsequently, the indigenous chromosomal region is deleted by the DNA construct in a double crossover (i.e., homologous recombination).

As used herein, the term “homologous recombination” is defined to mean the exchange of DNA fragments between two DNA molecules or paired chromosomes at the site of identical or nearly identical nucleotide sequences. In some embodiments, chromosomal integration is homologous recombination.

As used herein, the term “isolated polypeptide” is defined to mean a polypeptide which is substantially separated from other contaminants that naturally accompany it, e.g., protein, lipids, and polynucleotides. The term embraces polypeptides which have been removed or purified from their naturally-occurring environment or expression system (e.g., host cell or in vitro synthesis). The defluorinating enzyme may be present within a cell, present in the cellular medium, or prepared in various forms, such as lysates or isolated preparations. As such, in some embodiments, the defluorinating enzyme can be an isolated polypeptide.

As used herein, the term “substantially pure polypeptide” is defined to mean a composition in which the polypeptide species is the predominant species present (i.e., on a molar or weight basis it is more abundant than any other individual macromolecular species in the composition), and is generally a substantially purified composition when the object species comprises at least about 50 percent of the macromolecular species present by mole or % weight. Generally, a substantially pure defluorinating enzyme composition will comprise about 60% or more, about 70% or more, about 80% or more, about 90% or more, about 95% or more, and about 98% or more of all macromolecular species by mole or % weight present in the composition. In some embodiments, the object species is purified to essential homogeneity (i.e., contaminant species cannot be detected in the composition by conventional detection methods) wherein the composition consists essentially of a single macromolecular species. Solvent species, small molecules (<500 Daltons), and elemental ion species are not considered macromolecular species. In some embodiments, the isolated defluorinating enzyme is a substantially pure polypeptide composition.

As used herein, the term “improved enzyme property” is defined to mean a variant defluorinating enzyme that exhibits an improvement in any enzyme property as compared to a reference defluorinating enzyme. For the defluorinating enzyme described herein, the comparison is generally made to the naturally occurring enzyme having defluorinating enzyme activity, although in some aspects, the comparator defluorinating enzyme polypeptide can be a variant defluorinating enzyme. Enzyme properties for which improvement is desirable include, but are not limited to, enzymatic activity (which can be expressed in terms of percent conversion of the substrate), thermo stability, solvent stability, pH activity profile, cofactor requirements, refractoriness to inhibitors (e.g., substrate or product inhibition), or substrate specificity.

As used herein, the term “increased enzymatic activity” is defined to mean an improved property of the defluorinating enzyme, which can be represented by an increase in specific activity (e.g., product produced/time/weight protein) or an increase in percent conversion of the substrate to the product (e.g., percent conversion of starting amount of substrate to product in a specified time period using a specified amount of defluorinating enzyme) as compared to a reference defluorinating enzyme.

Any property relating to enzyme activity may be affected, including the enzyme properties of Kₘ, Vₘₐₓ or k_{cat}, changes of which can lead to increased enzymatic activity. Improvements in enzyme activity can be from about 1.2 times the enzymatic activity of the corresponding defluorinating enzyme, to as much as 2 times, 5 times, 10 times, 20 times, 25 times, 50 times or more enzymatic activity than the comparator defluorinating enzyme. Comparisons of enzyme activities are made using a defined preparation of enzyme, a defined assay under a set condition, and one or more defined substrates, as further described in detail herein. Generally, when lysates are compared, the numbers of cells and the amount of protein assayed are determined as well as use of identical expression systems and identical host cells to minimize variations in amount of enzyme produced by the host cells and present in the lysates.

As used herein, the term “conversion” is defined to mean the enzymatic conversion of the substrate(s) to the corresponding product(s). “Percent conversion” refers to the percent of the substrate that is converted to the product within a period of time under specified conditions. Thus, the “enzymatic activity” or “activity” of a defluorinating enzyme can be expressed as “percent conversion” of the substrate to the product.

As used herein, the term “specificity” as used in reference to an biocatalyst or enzyme is defined to mean the discrimination of the biocatalyst for a substrate compound.

As used herein, the term “relative specificity” is defined to mean the specificity of a biocatalyst or enzyme for one substrate compound over another or other substrate compounds.

As used herein, the term “stringent hybridization conditions” is defined to mean hybridizing in 50% formamide at 5×SSC at a temperature of 42° C. and washing the filters in 0.2×SSC at 60° C. (1×SSC is 0.15M NaCl, 0.015M sodium citrate.) Stringent hybridization conditions also encompasses low ionic strength and high temperature for washing, for example 0.015 M sodium chloride/0.0015 M sodium citrate/0.1% sodium dodecyl sulfate at 50° C.; hybridization with a denaturing agent, such as formamide, for example, 50% (v/v) formamide with 0.1% bovine serum albumin/0.1% Ficoll/0.1% polyvinylpyrrolidone/50 mM sodium phosphate buffer at pH 6.5 with 750 mM sodium chloride, 75 mM sodium citrate at 42° C.; or 50% formamide, 5×SSC (0.75 M NaCl, 0.075 M sodium citrate), 50 mM sodium phosphate (pH 6.8), 0.1% sodium pyrophosphate, 5×Denhardt's solution, sonicated salmon sperm DNA (50 μg/ml), 0.1% SDS, and 10% dextran sulfate at 42° C., with washes at 42° C. in 0.2×SSC (sodium chloride/sodium citrate) and 50% formamide at 55° C., followed by a high-stringency wash consisting of 0.1×SSC containing EDTA at 55° C.

As defined herein, the term “heterologous” polynucleotide or polypeptide is defined to mean any polynucleotide or polypeptide that is not naturally found in a host cell. As such, the term includes polynucleotides that are removed from a host cell, subjected to laboratory manipulation, and then reintroduced into a host cell. In some embodiments, the introduced polynucleotide expresses the heterologous polypeptide.

As used herein, the term “codon optimized” is defined to mean changes in the codons of the polynucleotide encoding a protein to those preferentially used in a particular organism such that the encoded protein is efficiently expressed in the organism of interest. Although the genetic code is degenerate in that most amino acids are represented by several codons, called “synonyms” or “synonymous” codons, it is well known that codon usage by particular organisms is nonrandom and biased towards particular codon triplets. This codon usage bias may be higher in reference to a given gene, genes of common function or ancestral origin, highly expressed proteins versus low copy number proteins, and the aggregate protein coding regions of an organism's genome. In some aspects, the polynucleotides encoding the defluorinating enzymes may be codon optimized for optimal production from the host organism selected for expression.

As used herein, the term “control sequence” is defined to include all components, which are necessary or advantageous for the expression of a polynucleotide and/or polypeptide of the present disclosure. Each control sequence may be native or foreign to the nucleic acid sequence encoding the polypeptide. Such control sequences include, but are not limited to, a leader, polyadenylation sequence, propeptide sequence, promoter, signal peptide sequence, and transcription terminator. At a minimum, the control sequences include a promoter, and transcriptional and where appropriate, translational stop signals. The control sequences may be provided with linkers for the purpose of introducing specific restriction sites facilitating ligation of the control sequences with the coding region of the nucleic acid sequence encoding a polypeptide.

As used herein, the term “operably linked” is defined to mean a configuration in which a control sequence is appropriately placed (i.e., in a functional relationship) at a position relative to a polynucleotide of interest such that the control sequence directs or regulates the expression of the polynucleotide and/or polypeptide of interest.

As used herein, the term “promoter sequence” is defined to mean a nucleic acid sequence that is recognized by a host cell for expression of a polynucleotide of interest, such as a coding sequence or gene. The promoter sequence contains transcriptional control sequences, which mediate the expression of a polynucleotide of interest. The promoter may be any nucleic acid sequence which shows transcriptional activity in the host cell of choice including mutant, truncated, and hybrid promoters, and may be obtained from genes encoding extracellular or intracellular polypeptides either homologous or heterologous to the host cell.

As used herein, the term “suitable reaction conditions” is defined to mean those conditions in the reaction solution (e.g., ranges of enzyme loading, substrate loading, cofactor loading, temperature, pH, buffers, co-solvents, etc.) under which a defluorinating enzyme of the present disclosure is capable of converting substrate compound to a product compound.

As used herein, the terms “microbial,” “microbial organism” or “microorganism” are defined to mean any organism that exists as a microscopic cell that is included within the domains of archaea, bacteria or eukarya. Therefore, the term is intended to encompass prokaryotic or eukaryotic cells or organisms having a microscopic size and includes bacteria, archaea and eubacteria of all species as well as eukaryotic microorganisms such as yeast and fungi. The term also includes cell cultures of any species that can be cultured for the production of a biochemical.

### Defluorinating Enzymes

The disclosure provides defluorinating enzymes, polynucleotides encoding these enzymes, host cells containing the polynucleotides, and methods for using the enzymes and host cells for the bioremediation of fluorinated compounds. Where the description relates to polypeptides, it is to be understood that it also describes the polynucleotides encoding the polypeptides.

Some of the defluorinating enzymes disclosed herein can defluorinate a fluorinated compound using a glutathione-dependent mechanism involving a nucleophilic attack on the β-carbon atom and formation of fluoride and S-(carboxymethyl) glutathione. Defluorination can be carried out by anionic proteins having glutathione transferase activity, though the anionic fraction contains nearly 10% of proteins without this activity but also capable of defluorination of fluorinated compounds.

Defluorinating enzymes can include, for example, BDF1, BDF2, BDF3, BDF4, BDF5, BDF6, BDF7, BDF8, BDF9, BDF10, BCF11, BDF12, BDF13, BDF14, BDF15, BDF16, BDF17, BDF18, BDF19, BDF20, BDF21, and BDF22.

BDF1. Fluoroacetate dehalogenase from Delftia acidovorans, Moraxella sp. B. BDF1 can act on fluoroacetate. The nucleic acid sequence and the amino acid sequence for BDF1 are below:

(SEQ ID NO: 1)
ATGGACTTTCCAGGATTCAAGAACAGCACCGTTACCGTGGATGGTGTGG
ACATCGCCTACACCGTAAGCGGCGAAGGCCCTCCGGTGCTGATGCTGCA
TGGGTTCCCGCAGAACCGGGCCATGTGGGCGCGCGTGGCTCCCCAACTC
GCCGAGCACCATACCGTGGTGTGTGCCGACCTGCGAGGCTATGGCGATT
CGGACAAGCCCAAGTGCCTGCCGGACCGGTCAAACTACTCATTCCGCAC
GTTTGCCCATGACCAACTCTGTGTGATGCGCCACCTGGGGTTCGAGCGC
TTCCACCTCGTCGGACATGATCGCGGCGGGCGTACCGGTCACCGCATGG
CGCTGGATCATCCCGAAGCGGTGCTGTCGCTGACCGTCATGGACATCGT
GCCGACGTATGCGATGTTCATGAACACCAACCGTCTGGTTGCCGCTTCC
TACTGGCATTGGTATTTCCTGCAGCAGCCTGAGCCGTTCCCCGAGCACA
TGATCGGTCAGGACCCGGACTTCTTCTATGAGACCTGTTTGTTCGGGTG
GGGGGCAACCAAGGTGTCGGACTTTGACCAACAAATGCTGAACGCATAT
CGGGAGTCTTGGCGCAACCCAGCCATGATTCACGGCTCATGCTCGGACT
ACCGCGCCGCCGCAACAATTGACCTTGAACACGATAGCGCGGACATCCA
ACGGAAGGTGGAATGCCCCACCTTGGTTTTCTACGGCTCAAAGGGGCAG
ATGGGGCAGCTATTCGACATACCAGCCGAGTGGGCAAAGCGCTGCAACA
ACACTACAAACGCATCTCTGCCAGGAGGCCATTTCTTCGTGGATCAGTT
CCCCGCGGAAACATCAGAGATTCTTTTGAAGTTTCTTGCTCGAAACGGC
TGA
(SEQ ID NO: 2)
MDFPGFKNSTVTVDGVDIAYTVSGEGPPVLMLHGFPQNRAMWARVAPQL
AEHHTVVCADLRGYGDSDKPKCLPDRSNYSFRTFAHDQLCVMRHLGFER
FHLVGHDRGGRTGHRMALDHPEAVLSLTVMDIVPTYAMFMNTNRLVAAS
YWHWYFLQQPEPFPEHMIGQDPDFFYETCLFGWGATKVSDFDQQMLNAY
RESWRNPAMIHGSCSDYRAAATIDLEHDSADIQRKVECPTLVFYGSKGQ
MGQLFDIPAEWAKRCNNTTNASLPGGHFFVDQFPAETSEILLKFLARNG

BDF2. Fluoroacetate dehalogenase from Burkholderia sp. FA1. BDF2 enzyme was specific to haloacetates, and fluoroacetate was the best substrate. The activities toward chloroacetate and bromoacetate were less than 5% of the activity toward fluoroacetate. The Km and Vmax values for the hydrolysis of fluoroacetate were 5.1 mM and 11 μmol per minute milligram, respectively. The nucleic acid sequence and the amino acid sequence for BDF2 are below:

(SEQ ID NO: 3)
ATGTTTGAAGGATTCGAGCGACGCCTTGTCGATGTCGGTGACGTAACGA
TCAACTGCGTCGTAGGCGGTAGCGGTCCGGCGCTTCTATTGCTCCACGG
TTTTCCGCAGAACCTTCACATGTGGGCCCGCGTCGCCCCCTTGCTCGCA
AACGAGTACACCGTCGTCTGTGCGGATCTGCGGGGCTACGGCGGTTCGT
CGAAGCCGGTGGGCGCCCCCGACCATGCCAACTACTCCTTTCGTGCAAT
GGCATCCGACCAGCGTGAATTGATGCGAACGCTGGGGTTCGAGCGGTTT
CACCTGGTCGGACACGATCGGGGCGGAAGAACGGGGCATCGCATGGCGC
TGGACCACCCCGATAGCGTGCTCTCGCTCGCCGTTCTGGACATCATCCC
AACCTATGTGATGTTCGAAGAAGTCGACCGTTTCGTGGCACGGGCCTAC
TGGCATTGGTATTTTCTTCAGCAGCCTGCGCCTTATCCCGAGAAGGTCA
TTGGCGCCGATCCCGACACCTTTTACGAAGGCTGTCTCTTCGGCTGGGG
CGCGACGGGTGCTGATGGCTTCGACCCCGAGCAACTGGAAGAGTATCGA
AAACAATGGCGCGATCCCGCAGCAATTCACGGCAGTTGCTGCGACTACC
GGGCCGGCGGGACGATCGACTTCGAACTCGACCACGGGGACCTGGGCCG
GCAGGTCCAGTGCCCTGCCTTGGTGTTTTCCGGTTCTGCCGGCCTGATG
CACTCTCTCTTCGAGATGCAGGTCGTCTGGGCGCCGCGACTGGCGAACA
TGCGTTTCGCATCGCTGCCGGGTGGGCACTTCTTCGTCGATCGGTTCCC
CGACGACACGGCACGCATCCTTCGCGAGTTTCTAAGTGATGCGCGCAGC
GGTATCCACCAGACCGAGCGAAGAGAATCATGA
(SEQ ID NO: 4)
MFEGFERRLVDVGDVTINCVVGGSGPALLLLHGFPQNLHMWARVAPLLA
NEYTVVCADLRGYGGSSKPVGAPDHANYSFRAMASDQRELMRTLGFERF
HLVGHDRGGRTGHRMALDHPDSVLSLAVLDIIPTYVMFEEVDRFVARAY
WHWYFLQQPAPYPEKVIGADPDTFYEGCLFGWGATGADGFDPEQLEEYR
KQWRDPAAIHGSCCDYRAGGTIDFELDHGDLGRQVQCPALVFSGSAGLM
HSLFEMQVVWAPRLANMRFASLPGGHFFVDRFPDDTARILREFLSDARS
GIHQTERRES

BDF3. Fluoroacetate dehalogenase from Rhodopseudomonas palustris. BDF3 is a member of the haloacid dehalogenase (HADH) family and can break the C—F bond by a S_{N}2 reaction, and degrade polyfluorinated compounds. The nucleic acid sequence and the amino acid sequence for BDF3 are below:

(SEQ ID NO: 5)
ATGCCCGATCTCGCCGACTTGTTTCCGGGCTTCGGCTCGGAATGGATCA
ACACCTCTTCGGGCCGGATCTTCGCGCGCGTCGGCGGTGACGGACCGCC
GCTATTGTTGCTGCACGGCTTTCCGCAGACCCATGTGATGTGGCACCGC
GTTGCGCCGAAGCTGGCCGAGCGCTTCAAGGTGATCGTCGCCGATCTGC
CCGGTTACGGCTGGTCGGATATGCCGGAGAGCGACGAGCAGCACACGCC
CTACACCAAGCGGGCGATGGCCAAGCAACTGATCGAGGCGATGGAGCAG
CTCGGCCACGTGCACTTTGCGCTCGCCGGCCATGATCGCGGTGCGCGCG
TCAGCTATCGGCTGGCACTGGATTCGCCGGGCCGGCTGTCGAAGCTCGC
CGTGCTCGATATCCTGCCGACCTACGAGTACTGGCAGCGGATGAACCGC
GCCTATGCGCTCAAGATCTATCACTGGAGCTTCCTGGCGCAGCCGGCTC
CGCTGCCGGAAAATCTGCTCGGCGGCGATCCTGATTTCTACGTCAAAGC
CAAGCTGGCGAGCTGGACGCGGGCAGGCGACCTGTCGGCGTTCGATCCG
CGTGCCGTCGAGCATTATCGTATTGCATTCGCTGACCCGATGCGCCGCC
ACGTGATGTGCGAGGACTATCGCGCCGGCGCCTATGCGGATTTCGAGCA
CGACAAGATCGATGTCGAAGCCGGCAACAAGATTCCGGTGCCGATGCTG
GCGCTGTGGGGCGCTTCCGGCATCGCACAGTCGGCCGCGACGCCGCTCG
ATGTCTGGAGAAAGTGGGCGTCCGACGTGCAGGGCGCGCCGATCGAGTC
CGGGCATTTTCTTCCCGAGGAAGCGCCGGATCAGACCGCCGAGGCGCTG
GTAAGGTTCTTCAGCGCCGCGCCTTGA
(SEQ ID NO: 6)
MPDLADLFPGFGSEWINTSSGRIFARVGGDGPPLLLLHGFPQTHVMWHR
VAPKLAERFKVIVADLPGYGWSDMPESDEQHTPYTKRAMAKQLIEAMEQ
LGHVHFALAGHDRGARVSYRLALDSPGRLSKLAVLDILPTYEYWQRMNR
AYALKIYHWSFLAQPAPLPENLLGGDPDFYVKAKLASWTRAGDLSAFDP
RAVEHYRIAFADPMRRHVMCEDYRAGAYADFEHDKIDVEAGNKIPVPML
ALWGASGIAQSAATPLDVWRKWASDVQGAPIESGHFLPEEAPDQTAEAL
VRFFSAAP

BDF4. Tetrachloroethene Dehalogenase from Dehalospirillum multivorans. BDF4 can be a corrinoid-Fe/S protein. The nucleic acid sequence and the amino acid sequence for BDF4 are below:

(SEQ ID NO: 7)
ATGATCAGCCCGGCCATCTTGGAGATCCGTTTTGGCCGCAAGTTAGACC
GTGAACTGGTGATATGGTATTTCAATATCGTCCCAACAGGTCGTTATCG
AAAAGTGATGAACCTGATTGACAAACGCCAGGAGATTGTTGAAGCGGCG
GCGGCGCTGATGCATTCGAAAGGGTACGAAAATACCAAATTGTCCGATA
TCCTGAAAGAAGGTCAGTTGATGGAAAAAGAAAAATGTAACAATGATGA
ACCGGCAACCATGGATAAGGAGAAATCTAACAACGATAAACCGGCCACG
AAAATTAATCGCCGTCAGTTCTTAAAATTTGGCGCTGGCGCCAGCTCTG
GCATTGCAATTGCGACCGCGGCTACGGCTCTTGGTGGCAAATCCTTAAT
CGACCCGAAACAGGTTTACGCCGGCACCGTCAAAGAACTGGATGAACTC
CCGTTTAATATCCCCGCAGATTATAAACCGTTTACTAATCAACGTAACA
TTTTCGGTCAAGCGGTGCTGGGCGTACCGGAGCCCCTCGCCCTGGTGGA
ACGCTTCGATGAAGTACGGTGGAACGGGTGGCAGACCGACGGTTCACCA
GGCCTGACCGTGCTGGACGGTGCCGCCGCACGCGCCAGCTTTGCAGTCG
ACTACTATTTTAACGGGGAAAACAGTGCGTGTCGCGCAAATAAAGGATT
TTTCGAATGGCACCCTAAAGTTCCGGAACTTAACTTCAAATGGGGCGAC
CCGGAACGCAATATTCACAGCCCGGGAGTGAAGTCTGCAGAGGAAGGGA
CCATGGCAGTAAAACGTATGGCGCGCTTTTTCGGAGCGGCCAAGGCCGG
TATTGCTCCCTTCGATAAACGATGGGTGTTTACTGAGACAGCGGCATTC
GTGAAAACGCCTGAGGGTGAAGACTTGAAGTTCATCCCGCCAGATTTTG
GCTTTGAGCCCAAACATGTCATCAGTATGATTATCCCTCAGAGTCTAGA
GGGTGTAAAGTGCGCACCTTCGTTTTTAGGGTCGGCCGAGTATGGTCTG
AGCTTTGCCCAGATTGGTTATGCCGCGTTTGGCCTGTCAATGTTCATTA
AAGATCTGGGATATCATGCTGTTCCGATAGGGTCCGATTCAGCGCTGAG
CATCCCTATAGCTATTCAAGCTGGCCTCGGTGAATATTCTCGTTCAGGC
CAAATGATTACTCCTGAATTTGGCCCGAATGTCCGTCTGTGCGAGGTTT
TCACGGATATGCCACTGAACCACGATAAGCCGATTTCCTTCGGTGTGAC
AGAATTTTGTAAGACCTGTAAAAAATGTGCGGAAGCATGTCCACCTCAG
GCAATCAGCTACGAAGATCCGACTATTGACGGTCCGCGGGGCCAGATGC
ATAATAGTGGCATTAAAAGGTGGTACGTGGATCCAGTCAAGTGCTTTGA
ATTTTGGAGCAGAGACAATGTTCGCAACTGCTGCGGAGCCTGCATCGCG
GCGTGCCCATTCACGAAGCCCGAGGCGTGGCATCACACCCTTATTCGGT
CGCTTGTTGGTGCGCCGGTAATCACGCCGTTTATGAAAGATATGGATGA
CATTTTTGGCTACGGGAAACCGAACGAAAAAGCTAAAGCGGATTGGTGG
AAATAG
(SEQ ID NO: 8)
MISPAILEIRFGRKLDRELVIWYFNIVPTGRYRKVMNLIDKRQEIVEAA
AALMHSKGYENTKLSDILKEGQLMEKEKCNNDEPATMDKEKSNNDKPAT
KINRRQFLKFGAGASSGIAIATAATALGGKSLIDPKQVYAGTVKELDEL
PFNIPADYKPFTNQRNIFGQAVLGVPEPLALVERFDEVRWNGWQTDGSP
GLTVLDGAAARASFAVDYYFNGENSACRANKGFFEWHPKVPELNFKWGD
PERNIHSPGVKSAEEGTMAVKRMARFFGAAKAGIAPFDKRWVFTETAAF
VKTPEGEDLKFIPPDFGFEPKHVISMIIPQSLEGVKCAPSFLGSAEYGL
SFAQIGYAAFGLSMFIKDLGYHAVPIGSDSALSIPIAIQAGLGEYSRSG
QMITPEFGPNVRLCEVFTDMPLNHDKPISFGVTEFCKTCKKCAEACPPQ
AISYEDPTIDGPRGQMHNSGIKRWYVDPVKCFEFWSRDNVRNCCGACIA
ACPFTKPEAWHHTLIRSLVGAPVITPFMKDMDDIFGYGKPNEKAKADWWK

BDF5. Acidimicrobiaceae TMED77 (T7RdhA) can catalyze the degradation of per- and polyfluoroalkyl substances (PFASs). The nucleic acid sequence and the amino acid sequence for BDF5 are below:

(SEQ ID NO: 9)
ATGCATACGGGCCGTAATGACGATACCAAACGTAGCCGTACTAGGAATG
GTATCCGCACCCTGCCGGATGCCTCGGACGGGAACATTGGATTTTTGAT
TAATGATAACTTTCGTGGCTTTTCGCAGGTCGATGATGTGTTTTGTCGT
TCTCAGTACGATCCGGAAATCAAAACCCCGCACTCGCAACGTTTTTATG
ATATGTACCGTAGACCTCTGGCGAACTGGCGCAATTCCGAAGGCTATGG
TCAGCACGACTATGCCTTCCGCAATGCAACGTGGCATGTTGCCGATATC
TTTGCGGAGCTCCGTGAAGTGGATGACCGACGGGATGGCTTCCTGGACC
CGTTATCTTTCTTGAAAGACGGTCCCGAAGAAATGGTTGAGTTTAATAG
CCTGACCGAGTCATCTCAAGTTATTAAACAGGCTGGTAAGACTATTGGA
GCAGATTTGATTGGTATCACCAAATTCGACAGTCGGTGGAGTTACTCTG
AACTTTTTAGCATCCAGTCCCTTTCCCCGAAGCCCAATGAACTAGATGA
TGATCTCAAAAACGTGATCGTGATTGGTCAAAGCATGGACAGCGAACTG
TTAGAAACGGCGCCGAGCGCATTAAGTGGCGCGGCCACAGGTATGGGTT
ACTCTCAGGATGCACTGGTGCTGCTGACCTTAAGTCAGTTTATACGCAA
CCTTGGCTATCGGGCTGTCCCAAGCATGAACGACTCGGCTCTGGCCATC
CCGTATGCGGTCCAGGCTGGTCTGGGGGAATATGGTAAGCACGGACTGG
TAATCACGCCAGAGTTTGGCAGCAGCGTGCGCTTTGGCAAAATTTTCAC
CGACATGCCGCTGCTTCTGGATAAACCGATTCAGTTTGGCGTTTCGGAT
ATGTGTAATATATGTAACGCGTGCAGCAAGGCCTGCCCATCAAAAGCGA
TTCCGGATGGGAAACCATCACCTGTAACCTTTAACCGTAGTAACATTAG
CGGGGTCACTAAGTGGACCATCGATGGCGAAGCGTGTTTCTCCTACTGG
ACGAAAATTAACACGGATTGCGCAGTATGCATTCGCGTTTGCCCTTTCA
CAAGAGACTATACTAAATTCCGCCATCGTCTCTGGCTGAAATTGTCAGG
CTCGCGTTTCCGCAAAATTGCCCTGCGCATCGACCAAAAATCCAAACGA
GGGAAACGCGTGAAGAGTCGCACATGGTGGTCCTCAGAGAATTAG
(SEQ ID NO: 10)
MHTGRNDDTKRSRTRNGIRTLPDASDGNIGFLINDNERGFSQVDDVFCR
SQYDPEIKTPHSQRFYDMYRRPLANWRNSEGYGQHDYAFRNATWHVADI
FAELREVDDRRDGFLDPLSFLKDGPEEMVEFNSLTESSQVIKQAGKTIG
ADLIGITKFDSRWSYSELFSIQSLSPKPNELDDDLKNVIVIGQSMDSEL
LETAPSALSGAATGMGYSQDALVLLTLSQFIRNLGYRAVPSMNDSALAI
PYAVQAGLGEYGKHGLVITPEFGSSVRFGKIFTDMPLLLDKPIQFGVSD
MCNICNACSKACPSKAIPDGKPSPVTFNRSNISGVTKWTIDGEACFSYW
TKINTDCAVCIRVCPFTRDYTKFRHRLWLKLSGSRFRKIALRIDQKSKR
GKRVKSRTWWSSEN

BDF6. Defluorinating enzyme from Desulfoluna. The nucleic acid sequence and the amino acid sequence for BDF6 are below:

(SEQ ID NO: 11)
ATGGATTCCGAGCATCATCCAGAAAAAAAAATTGATCTGTCGCGCCGCA
AATTTGTTACCCTTGGTGCGGCGTCGGCTGTGGCGGGTAGTACGATGCT
GGCCACGCTTCCGTCTCAAGTGATGGCGGAAGCCTCAAAGGGTATGACT
GGCAAGCAGCCGACCAGTCTAGCGGATAATATCGATAGCGCTGTTTACC
AACGGTTTCATCAAAAAAACACCGCCTTTTGTCAGGCACTCTCAGGTAC
GTTCCCGCAGGGCGGTCAGGCACTGAAGATGTTGGGGAATACATCCAGC
GAGCTGGGGCAGCGGCAGCTGGACAAAGCGTTGTCTGACAGTGGCTGGT
ACATCCACCAATTAATAGCGAACGGGACTTCCCTGTCGGGCCCGGAAAC
TGTGGCATATGCGCGCGATAATGAGATTGCTCGTGAACGTTATGAATTC
ACGTCTCCTGAAGAGGCCTCACATTATATTAAAAAAGCGGCAAGATTCT
TGGGTGCGGACCTTGTGGGTATCACACCATACGACGAGCGCTGGACCTA
TGCCAGCTTCTACGATCATCTGAAACAACAGAACGTCCCCCCAACCTTA
CCTTTTACCCCGAAGAGTGTGATAGTGCTGGGCTTCGAGATGGATTATG
AAGCCATGACAACCGCGCCGAGCGGAATCTCGGGAGCCGCGGTAGGTCA
GGGGTATTCCGAGATGGCTATCACAGGAGCCAGCCTGCGTAAGTTCATT
ACGTCAATTGGGTATAAAGTATTTGCTACCGGCAACGATGTCGCCTTAA
ACATCCCATACGGTATTGCTGCGGGCCTGGGCGAAGCAGGCCGCAATGG
CATCCTCGTGACTTACGAATATGGCCCGCGTGTCCGTTTGTGCAAAGTT
TTTACGGAAATGGATTTAGCCTGCGACCATCCCGTCAGCTTTGGCGTTC
AGCACTTCTGCGAAACGTGTATGCTGTGCGCCAAAGCATGTCCCGGCCA
CGCGATTTCGAAAGAAAAAGAACCTAGCTTTGAAATCAATGATGAGTGC
AACAATCCGGGAGTAGAAAAATGGGCAATTGATGCAAAGAAATGCCTGC
TCGCTTGGGGTAAAACCAAAAGCGATTGTGCAACCTGTATTACCTCTTG
CCCGTACAACAAACCGAACTTTTGGCACCATCGCCTGGTCGATAAGGTT
AATCACATGATGCCGGGGTCTGTGCACAGTGTAATGCGAGAAATGGACA
AACTGTTCGGTTATGGCAATTCCTTTGACAAAAAAGCGGTTGACCATTT
TTGGAAAAGCTAG
(SEQ ID NO: 12)
MDSEHHPEKKIDLSRRKFVTLGAASAVAGSTMLATLPSQVMAEASKGMT
GKQPTSLADNIDSAVYQRFHQKNTAFCQALSGTFPQGGQALKMLGNTSS
ELGQRQLDKALSDSGWYIHQLIANGTSLSGPETVAYARDNEIARERYEF
TSPEEASHYIKKAARFLGADLVGITPYDERWTYASFYDHLKQQNVPPTL
PFTPKSVIVLGFEMDYEAMTTAPSGISGAAVGQGYSEMAITGASLRKFI
TSIGYKVFATGNDVALNIPYGIAAGLGEAGRNGILVTYEYGPRVRLCKV
FTEMDLACDHPVSFGVQHFCETCMLCAKACPGHAISKEKEPSFEINDE
CNNPGVEKWAIDAKKCLLAWGKTKSDCATCITSCPYNKPNFWHHRLVDK
VNHMMPGSVHSVMREMDKLFGYGNSFDKKAVDHFWKS

BDF7. Defluorinating enzyme from Marinifilaceae. The nucleic acid sequence and the amino acid sequence for BDF7 are below:

(SEQ ID NO: 13)
ATGAAAAAAAAAGAGAAGCCGACCGCGGTCAACCGCCGGGATTTTCTCA
AGTTCGGGTCAATTACTGCCGTGGCTGGGGCGGCAACCCTGGCGGCTAT
GCCGAAGAAAGCGGCCGCGGATAAACTGGACAAACATTTGGTGGAGGAA
TTAGTAACCATCCATGATGACTTCCCTGCGGAGGTACGCGATGACTATG
TTCCGGCGCGCAACTGGGATCATGTCCAGGCTCGTAGCATTTTTGTTGA
TGCGGTGCGTGCCATCGGCGACGACGTTGAAGACGATATAGTAGCGGAT
GGTCAAGCATTCGTCCAAAAGATGAATTTTGCATGGGATAATTCGAAAG
TGGGCCACACTCAAGCTGATAAAGCACTGCTGAGCGGGGCGTGGGCCAT
GAACAATTTTGCCGCAGGCCCTAGCCCCGCGGCAATTCCGGACTATGGT
GTTAACAGTTGGGAACAAAAGACGCAGAAGAATCCACACGCACTATTCG
ATAACGACTACGTCGTAAAAGATAAATGGAAATTTGAATCTAAAGAGGA
AGCCGCGAATCAGATTAAACGTGCCGCCCGCATGTTTGGCGCTGATCTT
GTTGGGATCACTCGGAGAGATAAACGCTGGGATTATTCGAAGTTCCTTA
ACCCCGTCCCGCCGTTAGCTCGTCGTGCCTTTGCCGGACCGCCGACACC
GGAACAGATGGAAGAAATGCATAATTGGGGCCCGGATAAATTTGTGACC
GATTGGTCCGATTTCCCTTTTGAACCAAAAACCGTCATCGTCATGGCCT
TTGAAATGGACTACGAAGGCATCAGTGCGATGCCAAGTTATGTGGGGAG
TGCTGCGGCCGGCGCTGGTTACTCACGAATGGCAGAGACGCCATACCAG
CTGGCGGTGTACCTGAAAAATTTGGGATATCATGCAGTTTCCGCGGGTA
ACGACATGGGACTGTCCGTGCCTTATGCGATCGCAGCTGGTCTGGGCGA
GAATTCTCGACTGGGACAGGTGGTTACGTACAAATACGGTCCGAGGGTT
CGCATTGCAAAAGTATACACGGATTTTGACTTTGTCGAATACGATAAAC
CTAAATCGTTTGGCGTGATGGAATTCTGCAAAAACTGTATGCGCTGTGC
CGATGCCTGTCCGACCAAAGCCATTAGCTTCGATAAAGAACCATCTTTT
GAACCGACCCATAAGAATAAAGATAACGCATGGTATAACATTAAAGGTG
TTAAAAAATATCACGTTGATGCCAAGTCATGTTTCCAGCTCTGGGGCGA
ATTGGGCGATGACTGCGGTGTATGCATGGCATCCTGCCCATATAATAAA
CCCGACTTCTGGCATCATCGTCTGGTGGACAGCGCGACAGCGGCGATGC
CGGGTCCGGTGCACGATTTTATGCGTGAGATGGATAAATTATTCGGTTA
TGGCAACGTGGATGACAAAGACGCGGTGAAAAAGTTTTATAGCCCCAAA
GGCAAGTCGTATGACGGTCACTAG
(SEQ ID NO: 14)
MKKKEKPTAVNRRDFLKFGSITAVAGAATLAAMPKKAAADKLDKHLVEE
LVTIHDDFPAEVRDDYVPARNWDHVQARSIFVDAVRAIGDDVEDDIVAD
GQAFVQKMNFAWDNSKVGHTQADKALLSGAWAMNNFAAGPSPAAIPDYG
VNSWEQKTQKNPHALFDNDYVVKDKWKFESKEEAANQIKRAARMFGADL
VGITRRDKRWDYSKFLNPVPPLARRAFAGPPTPEQMEEMHNWGPDKFVT
DWSDFPFEPKTVIVMAFEMDYEGISAMPSYVGSAAAGAGYSRMAETPYQ
LAVYLKNLGYHAVSAGNDMGLSVPYAIAAGLGENSRLGQVVTYKYGPRV
RIAKVYTDFDFVEYDKPKSFGVMEFCKNCMRCADACPTKAISFDKEPSF
EPTHKNKDNAWYNIKGVKKYHVDAKSCFQLWGELGDDCGVCMASCPYNK
PDFWHHRLVDSATAAMPGPVHDFMREMDKLFGYGNVDDKDAVKKFYSPK
GKSYDGH

BDF8. Defluorinating enzyme. The nucleic acid sequence and the amino acid sequence for BDF8 are below:

(SEQ ID NO: 15)
ATGGAAGAGCAAAACATCGTCCAATTAGATGAAAACAAAGATCCTGAAG
TGAAAAAAGTGAAACCGGCGGGGTTTTTCCAGGATCGTGTTAGATGGGT
TCGCCCCTTGGGTCGCTCGCGTCTCATTGAGCTGCCGGGCAAAGCCGTT
GCGGAAACCGTATCAACGCAGCTGGATAAAAAGCTCGTAAAGGAATGGC
CGGAAATGCCGGTGAAAATTCGTTCGGATTATAAAAGGATGCCGCAAAA
GAACACCATTTTCAATCGTGCCTTTAGCGGGGACGCCCCGAAACACCAG
AAGATGATGGGCGCCTTCTGGCATCCTGAGCCGCGTAAAGAACCAGGAT
GGACACAGCTGGACTATGCACTTGAAAAGGCCGCCTGGAGCGTCAATGA
CACCATGGCACCATTTAGCCAGGCGGGCATTCCGAACACGCCTGCATAC
CGCTGGGACATGAAACCCGATAGTCAGACATACCGTTTTAATTCCACCC
ATGAAGCAACTAAAGCAGTCAAACGTGCTGCTCGCTTCCTGGGCGCTGA
TCTGGTTGGTATTGCACGTTATGATGAACGCTGGGTGTATAGTTCCTTT
TATGATCCACTGAAAAACCAGGAAATCCCCGCGGATCTTCCGTTCAAAC
CTAAATCTGTAATCGTGATGGCGGTCGAGATGGATTACGCGGCATTTGG
CACGGCACCCACGGTTTTAGCATCCGCCGGCGCTGGTAAGGGCTACAGC
GAAATGGCTGTGACCGCGACCTCAGTGGCTCATTTCATCAGCAACCTGG
GGTACAAAGCGTTTGGCGCCGGTAATGATATTGCCATGTCAGTCCCGTA
TGCGATCGCAGCGGGTCTGGGTGAGGCCGCTCGCAATGGGATGGTTGTA
ACTTATAAATACGGCCCGCGCGTCCGGCTATGCAAGGTGTTCACGGAAA
TGGAGTTGGAGTGGGACAAACCGGTGACCTTTGGAGTTCGGCATTTTTG
TGAAAATTGCATGCGATGCGCGGACGCCTGCCCGTCTAAAGCCATACCA
AAAGACAAAAAACCAAGCTTTAAAGTCAATAACAAAAGTAACAACCCGG
GTGTGGAAAAATGGGCGGTTGATGCGGAAAAATGTTTTGAGTTTTGGTG
CAAAAATGGTGGCGATTGTGGCACGTGTATCTCGAGTTGCCCGTACAAT
AAGCCAGAATTCTGGCACCATAAAATGGTAGATAAATTAACAGCGCTGA
TGCCTGGACCGGTGCACTCTTTCATGCGCGAGATGGACATTACTTTCGG
GTATGGTAACACCTATGACAAGAAGGCGGTGAAAAAATTTTGGAACGAA
GAATCCTAG
(SEQ ID NO: 16)
MEEQNIVQLDENKDPEVKKVKPAGFFQDRVRWVRPLGRSRLIELPGKAV
AETVSTQLDKKLVKEWPEMPVKIRSDYKRMPQKNTIFNRAFSGDAPKHQ
KMMGAFWHPEPRKEPGWTQLDYALEKAAWSVNDTMAPFSQAGIPNTPAY
RWDMKPDSQTYRENSTHEATKAVKRAARFLGADLVGIARYDERWVYSSF
YDPLKNQEIPADLPFKPKSVIVMAVEMDYAAFGTAPTVLASAGAGKGYS
EMAVTATSVAHFISNLGYKAFGAGNDIAMSVPYAIAAGLGEAARNGMVV
TYKYGPRVRLCKVFTEMELEWDKPVTFGVRHFCENCMRCADACPSKAIP
KDKKPSFKVNNKSNNPGVEKWAVDAEKCFEFWCKNGGDCGTCISSCPYN
KPEFWHHKMVDKLTALMPGPVHSFMREMDITFGYGNTYDKKAVKKFWNE
ES

BDF9. Defluorinating enzyme from Deltaproteobacteria. The nucleic acid sequence and the amino acid sequence for BDF9 are below:

(SEQ ID NO: 17)
ATGTGGACTTCCAAGACCGGCAATCCTCGCACATATCGCATCGTCGGTA
GTCAACGGCAAGTGGATGAACGTGAAACCCCGCATCCGCGCGTCGAGCG
CGGGGAACTCGGCGATCGTCTGCTGAACTGGCGGAAAACTCGCGCGGGG
CAGGATCCATTCCGGCGCATCTTTGGGGTGGGCGGTGGAGATCCGAAAA
ATTGCTTACAGTACATTATGAAACAAGCCCCGGAAGGCGGCGTCAACCC
GAACCCGGTTCCGGTACCCGATCCGGTTACGATGACCCGCGACATCAAA
GAGGTGGCCCGTTTCTTTGGTGCTGACGTCGTGGGAATTACATATCTGG
ACCAGGCCTACGTCTACTCGCACCGTGCAAGACCTAATCCGGCCACGGG
TGAAAAACCAGGTGATCCTATTAAAGTTCCGCACCGATATGCAATCTGC
ATGGGCTTTGCATCAGACTACGAAAAATTTCTCAGCAACAATTCCCGTA
TTTCGGATGCTGAGTATGGATTAGGTAACCAGCGTATGATTCCGACCAC
CTTTATGCTGGCGGCATATATCCGTGAAATGGGCTATCCGGCCCGCTCG
CATGACTACGCGCGTGGTGAAGTAAATCCCATTCCCCTAGCTGTGAATG
CGGGTTTGGGCGAACTCGGGCGTCATGGTATGCTGATACACGAAGATTA
TGGCAGTCGCATCCATCTGAGTGTGGTGACAACCGATTTGCCACTGGCG
GTGGACCAGCCCGTAGACATTGGTGTAGAGGACGTGTGTAAATATTGTA
TGAAATGCGCGAGGACCTGTCCGTCACACAGCATCCCATTCAGCGATAA
AGAAGTACACAATGGCGTCGAGCGTTACCGTATTAATGTTGATAGCTGC
TACAAGTACCGCTTAGCGGGCAAAGATAAGTGGACCAACTGTGTTATCT
GCGTTTCTGCCTGCTGTTATAACAAGCCGAAAGCTTGGTGGCATACTCT
GGCCGTGAAATCTATTAAATGGACGCCGATACCTCTTAGAGTTCTTATT
ATCAAGCCACTTCTGTGGATGGATGATCTGTTTTGGGGCAAACGACCGT
GGAAACACATGAAATGGCTGCGCTATGACAACGCACCGGAACCTGCGTT
CTGTAACATTCCAGGGTGCAGCGTGCAGCATACGAACTTGCAGCATAAG
CCTCTGCATACGGCGTAG
(SEQ ID NO: 18)
MWTSKTGNPRTYRIVGSQRQVDERETPHPRVERGELGDRLLNWRKTRAG
QDPFRRIFGVGGGDPKNCLQYIMKQAPEGGVNPNPVPVPDPVTMTRDIK
EVARFFGADVVGITYLDQAYVYSHRARPNPATGEKPGDPIKVPHRYAIC
MGFASDYEKFLSNNSRISDAEYGLGNQRMIPTTFMLAAYIREMGYPARS
HDYARGEVNPIPLAVNAGLGELGRHGMLIHEDYGSRIHLSVVTTDLPLA
VDQPVDIGVEDVCKYCMKCARTCPSHSIPFSDKEVHNGVERYRINVDSC
YKYRLAGKDKWTNCVICVSACCYNKPKAWWHTLAVKSIKWTPIPLRVLI
IKPLLWMDDLFWGKRPWKHMKWLRYDNAPEPAFCNIPGCSVQHTNLQHK
PLHTA

BDF10. Defluorinating enzyme from Deltaproteobacteria. The nucleic acid sequence and the amino acid sequence for BDF10 are below:

(SEQ ID NO: 19)
ATGCTGAGCTCTAAACAAAACACGCCTCGTAGCTACCGTATCGTCGGCC
CACAGCGCCAGCTGGACGAACGCGAAACCCCGCACCCGAAAGTAGATCG
CGGTGAATTCGGCGCGCGTCTGCGCGATTGGCGGAAGAACCGTGCGGGC
TCCGATGCCTTCCGTCGTCTGTTCGGTGGTGGGGGCGAGGGTGATCCAA
ACAATACGCTGCAACAGATTATGAAGCAGGCACCGGAAGGGAAAGTTAA
CCCGAATCAGCTCCCTATTGATGACCCCGCAGAAATGGCGAAACAGATA
AAGGGCGTTGCGCAGTACCTGGGTGCCGACGTAGCAGGGATCTGTGAAT
TAAATCCGCTCTATGTTTATTCCCATCGCGCCCGGGGTAACGCTGCGAT
GGGGGAAAAGCCCGGTGATCCGATTGTTATGCCGCATAGGTTTGCCATC
TGCCTGGGATTTGCGTCAAGTTACGAACGCTATATGTCCAATAATTCTA
AAATTTCGGATACCGAATATCAATTTGGCAATAACCACGCCATCGTGCC
TACTTTTCAGTTGGCAAGCTATATCAGAGAAATGGGTTACCCAGCGACG
GCACATCATCACGGTCGCAGCTCGGTAAACCCAATTCCGCTTGCGATTA
ATGCCGGACTGGGCGAACTGGGCCGTCACGGCATGTTAATCCATGAAAA
ATATGGTAGTCGACTGCACTTAACCGTGGTTACCTGTGATCTGCCTTTG
GCGGTGGACAAACCGGTGGACATAGGCGTGGAGGAATTTTGTAAATATT
GTAAAAAGTGCGCGCGTACATGCCCGAGTCATTCAATTCCGTTCGGCGA
TAAAACTGTCGTCAATGGCGTTGAGAAATACGCTATCAACGTCGAGAGC
TGTTATAAATACAAATTGGCTGGCCGAGGAGAATGGACCAACTGCGTGG
TGTGCGTGTCGTCTTGTTGCTATAATAAAGCGGATACGTGGTACCATGA
CTTAGCAATGTGGTCAGTAAAAGTGACACCGCCGAAATTGCGGGTCCTC
GTGGTCAAACCGCTACTGTGGATCGATGACCTTATTTGGGGAAAGCGCC
CCTGGAAGCATATGAAATGGCTTGGTTACGATAACGCCCCAGAGCCTGT
TTATTGCACCATTGCAGGGTGCACCGCTAAACACGCCAAACTGCAACAT
AAAAAACTGCACACTGCTTAG
(SEQ ID NO: 20)
MLSSKQNTPRSYRIVGPQRQLDERETPHPKVDRGEFGARLRDWRKNRAG
SDAFRRLFGGGGEGDPNNTLQQIMKQAPEGKVNPNQLPIDDPAEMAKQI
KGVAQYLGADVAGICELNPLYVYSHRARGNAAMGEKPGDPIVMPHRFAI
CLGFASSYERYMSNNSKISDTEYQFGNNHAIVPTFQLASYIREMGYPAT
AHHHGRSSVNPIPLAINAGLGELGRHGMLIHEKYGSRLHLTVVTCDLPL
AVDKPVDIGVEEFCKYCKKCARTCPSHSIPFGDKTVVNGVEKYAINVES
CYKYKLAGRGEWTNCVVCVSSCCYNKADTWYHDLAMWSVKVTPPKLRVL
VVKPLLWIDDLIWGKRPWKHMKWLGYDNAPEPVYCTIAGCTAKHAKLQH
KKLHTA

BDF11. Defluorinating enzyme from Acidimicrobiaceae. The nucleic acid sequence and the amino acid sequence for BDF11 are below:

(SEQ ID NO: 21)
ATGCATACCGGCCGCAACGACGCAGCGCTCCGTGCACGTACTCGGGGGC
GAGCCCGTGCGGCGGCGACAGCGTCCGATACGGACGCGGGTTTTACCGT
GGAAGCCAACTTTGAACGTTTTAGCCAGGCCGATGACGTGTTTTCGCGT
TCGCGCACCGACAGTGAGCTTCGCGATGAAAAAGCAGATAAATTTTATT
CAACTTATCGGCGGCCTCTGGAAAATTGGCGCAAAGCGAAGGGGTTCCG
CCAGTTAGATTATGCATTCCGTAACGCAACCTGGCATGTAGCCGACGTT
TTCGCCGAAATGTATGAGGATGACGATCGCCGAGATGGATTTCTGGACC
CACTTAGCATGTTGCGCGATGGCGCTGCGGAACAAGTCGACTGTGGCTC
CCCGAGTGATGCAAGCAAACTGTTGAAACACGCTGCGTCTACCGCGGGC
GCGGACCTGGTCGGCGTTGCGGCATATGATGAACGTTGGACCTACACGG
ATCGTTTCTCACAGGCCACCGGCACCGGAAAACCGAACCCGTTACCCGA
AGAAATTAATAAAGTTATTGTCATTGGTCAAGCCATGGATGAGAGATTG
ATTGATACTGCTCCTAGCGCACTGTCTGGCGCGGCCACGGGGATGGGCT
ATTCACAGGACGCGGTTGTGCTGCTGACCGTGGCTCAATTCATTCGTAA
TCTCGGTTACACTGCCGTTGCCAGCATGAATGATACCGCTCTGGCAATC
CCGTACGCTATCAAAGCGGGCCTGGGTGAATATGGTAAGCATGGACTGG
TAATTACGCCCGAGTTCGGGACGTCAGTCCGCTTCGGCAAGATTTTTAC
GGACATGCCACTTCGTGAAGATACCCCGATCCGCTTTGGTGTCGAGGAG
ATGTGCAATATTTGCAACGCATGCAGTAAAGCTTGTCCGTCCCGTGCCA
TCCCGGATAAGAAACCGTCTACGGACCGCCACAACAAATCTAATATCGT
GGGTATTCGTAAATGGAGTATAGACGGTGAAAAGTGCTTTAGCTACTGG
AGCAAAATCAACTCGGATTGCTCGGTGTGTGTGCGAGTTTGTCCTTACA
CACGCGATTACACACAGAGACGGAATCGCGCCTGGCTGCGCTTAGCCGA
TTCCCCGCTCCGTAAACTAGCTCTGAGGATCGATCGCCGTATAGGTGGC
GGGAAACGCGTGCAGGCGGAAACATGGTGGCCAGTATAG
(SEQ ID NO: 22)
MHTGRNDAALRARTRGRARAAATASDTDAGFTVEANFERFSQADDVFSR
SRTDSELRDEKADKFYSTYRRPLENWRKAKGFRQLDYAFRNATWHVADV
FAEMYEDDDRRDGFLDPLSMLRDGAAEQVDCGSPSDASKLLKHAASTAG
ADLVGVAAYDERWTYTDRFSQATGTGKPNPLPEEINKVIVIGQAMDERL
IDTAPSALSGAATGMGYSQDAVVLLTVAQFIRNLGYTAVASMNDTALAI
PYAIKAGLGEYGKHGLVITPEFGTSVRFGKIFTDMPLREDTPIRFGVEE
MCNICNACSKACPSRAIPDKKPSTDRHNKSNIVGIRKWSIDGEKCFSYW
SKINSDCSVCVRVCPYTRDYTQRRNRAWLRLADSPLRKLALRIDRRIGG
GKRVQAETWWPV

BDF12. Defluorinating enzyme from Rhodobacteraceae. The nucleic acid sequence and the amino acid sequence for BDF12 are below:

(SEQ ID NO: 23)
ATGTCTAAACACCAGAATTATCCAATTCAGCATGAACACGATGCTTCTG
CCGGCATCGTGGTCACTGAGGACTTTGAACGCTTTAGCCAACGAAATGA
TATTTTCACACGCGCATTTTGGGACGATTCGGTCCGGACTAAGCAAACC
AAAGCCTTTTTTGCCTCCTATCGTATGGAGGCGGCACCGCGCCGCGGGA
GCGGATTCTCCCAGCGCGACTTTGCACTGCGTAACGCGTCGTGGCTGAT
CAGCGACGTGGTGAGTAATCGTAACGCGGAAAACGGAATGCGTGAAGGT
TTCCAGGCGCCCATTCAACCGGATACGCCCGTGGCAGAAGAGCGTATTG
ATGTGGATGATCCAGGCCGCATGTCAGTTGAAATCAAACGTATTGCTGG
TTTTTTCGGAGCTGACTTATGTGGCATAACCGACATGGATGAACGCTGG
ATTTATGCCGCACGTGTGGATACGCGTGATATGTCAGACGCGCCGCACG
ATCTGCCGGCGGGCCTGTCATCGGTGATCGTCCTGGGCCATGAAATGGA
TCGCGAACTCGTGGCCACGTACCCGTCCGCCCTGGCGGGTGCCGCCACC
GGCCGTGAATACTCGCATGAAGCGAGCATTGTTATGCAGTTAGCGGCGT
ATATTCGCAATCTGGGGTACGAAGCGGTTCCGAGTATGAACGATACGGC
ACTCGTAATACCTTATGCAGTTAAAGCCGGCCTGGGCGAATACGCCCGG
AACCAGCTCGTAATCACCCCGGAGTTGGGTCCGCGTCTTAGATTTAGCA
AAATTTTCACAAATCTTCCGCTGACGCATGATACACCGAAGCCGAAAGG
GGTACGCGCATTCTGTGACATCTGCACCAGGTGTGCGGATGCATGCCCA
GTTAAAGCTCTTCCCTACGGTCCACCTTCTACCGATACCGCTAACATTA
GCGCTATCAAAGGCGTCCGGAAGTGGACCAGTGATGCGGAGAAATGCTT
TAGTTTTTGGGCCAAACTGTCCAGCGACTGCGCCATCTGCATGAGAGTT
TGTCCTTTCAACCGCGACTATAAAACTGCGGGTAATCGCCTGTGGCTGA
AGTTGGCTCTGGGTCCTTTCCGGCGATTGGCGTTATGGCTAGCACGTAA
TCATGGTCCACGTCGCAAACCGGATGAGTGGTGGCGTGGCATTGGGTAG
(SEQ ID NO: 24)
MSKHQNYPIQHEHDASAGIVVTEDFERFSQRNDIFTRAFWDDSVRTKQT
KAFFASYRMEAAPRRGSGFSQRDFALRNASWLISDVVSNRNAENGMREG
FQAPIQPDTPVAEERIDVDDPGRMSVEIKRIAGFFGADLCGITDMDERW
IYAARVDTRDMSDAPHDLPAGLSSVIVLGHEMDRELVATYPSALAGAAT
GREYSHEASIVMQLAAYIRNLGYEAVPSMNDTALVIPYAVKAGLGEYAR
NQLVITPELGPRLRFSKIFTNLPLTHDTPKPKGVRAFCDICTRCADACP
VKALPYGPPSTDTANISAIKGVRKWTSDAEKCFSFWAKLSSDCAICMRV
CPFNRDYKTAGNRLWLKLALGPFRRLALWLARNHGPRRKPDEWWRGIG

BDF13. Defluorinating enzyme from Paraburkholderia. The nucleic acid sequence and the amino acid sequence for BDF13 are below:

(SEQ ID NO: 25)
ATGACTCTCTCGGTTCAAAATTTGTCTGGTTGGAAAGAGTGTTCGGTAA
GTACGGTGACGTGGCCGAACCCTCCGCGGTTAGATACGCAGCGTTTTTA
TAACGCCCTCACTAACTACGATAAACGGCTGGCGATGCCATTTGAAGAC
TTCACCCCGTTCCGTGTTGCTGCAGGAGATGTCGACATATTTGGCGTAA
AAGGCGGTGCAGGCCCGCCGTTGCTGCTGCTGCACGGCCACCCCCAGAC
ACATTTGATTTGGCATCGGTGTGTGGCGCAACTGGCCAAACATTTCACC
ATTATTGCGACGGATCTGCGTGGGTACGGAGCCTCCGCGAAACCTGAAA
GCGACGCTACACACGCCGCCTATAGCAAGCGTGCTATGGCAGCTGATCA
GGTAGCTGTTATGCGACACTTTGGCTACGAAAGATTTCTGGTGTGCGCG
CATGATCGCGGCGCACGAGTGGCCCACCGTATGGCCCTTGACCATCCTG
ATGCGGTCGAACGCTTAATGCTGCTTGATATCGCCCCGACCCTCGCTAT
GTACGAAGCAACTGATAGGACCTTCGCAACCTTGTATTTTCACTGGTTC
TTTCTGATCCAACCAGAGCCGTTACCTGAAACCCTGATTGGTGCGAATC
CAGACGTGTATGTCGACCGCGTGATGGGTAGCCGTCATGCGGGCTTAGC
CCCGTTTGCGCCAGAAGCACTTGATGCGTATCGTAGTGCTCTACGCCAG
CCCGGCGCCGTACATGCGATGTGTGAAGACTACCGCGCATCAGCGACGA
TTGATCTGGAACACGACCGCGCGGATATTGAGTGCGGTCATAAGATCGG
TTGTCCGCTGCGCGTGCTGTGGGGTGAAGAAGGGGTTATCCAGAAATGC
TTCGAGCCGCTGGATGAATGGCGCCGTGTTGCGCGCGATGTTTCCGGAC
GTGCCCTGCCCTGCGGGCATTATATCCCGGAGGAAGTCCCGGAAGACCT
GGTGACCGAGATGCTTGCGTTCTTTGAGGCAGTCGAACAG
(SEQ ID NO: 26)
MTLSVQNLSGWKECSVSTVTWPNPPRLDTQRFYNALTNYDKRLAMPFED
FTPFRVAAGDVDIFGVKGGAGPPLLLLHGHPQTHLIWHRCVAQLAKHFT
IIATDLRGYGASAKPESDATHAAYSKRAMAADQVAVMRHFGYERFLVCA
HDRGARVAHRMALDHPDAVERLMLLDIAPTLAMYEATDRTFATLYFHWF
FLIQPEPLPETLIGANPDVYVDRVMGSRHAGLAPFAPEALDAYRSALRQ
PGAVHAMCEDYRASATIDLEHDRADIECGHKIGCPLRVLWGEEGVIQKC
FEPLDEWRRVARDVSGRALPCGHYIPEEVPEDLVTEMLAFFEAVEQ

BDF14. Defluorinating enzyme from Paraburkholderia. The nucleic acid sequence and the amino acid sequence for BDF14 are below:

(SEQ ID NO: 27)
ATGTTCTTCGAAGATTTTACCCCGTTTCGTTTTGCCGCCGACGATGTGG
ACATCTATGGCGTTAAAGGCGGTGCGGGCCCTCCGCTGTTGCTTTTACA
CGGGCACCCGCAGTCCCATTTGATTTGGCATAGATGCGCCGCCCGCCTT
GCGGAACACTTTACCGTTATCGCTACCGACTTACGAGGCTACGGCGCCT
CTGCTAAGCCCCCGTCGGACGCAAGCCATATGCCGTACTCAAAACGGGC
TATGGCAGCAGATCAGGTTGCGGTGATGCGCCACTTCGGTTTCGACCAG
TTTCTGGTCTGCGCGCATGATCGGGGAGCGCGCGTGGCGCACCGCATGG
CTTTAGACCATCCCGCCGCAGTGGAGCGTCTGATGCTGCTCGATATAGC
ACCGACTCTGGCGATGTATGAAGGAACCGATCGCACGTTTGCCACGCTG
TATTTTCATTGGTTCTTCCTGATTCAGCCAGAGCCATTGCCAGAAACAC
TAATTGAAGGCAACCCGGCGGCTTACGTTGATAGGGTCATGGGTAGCCG
CCATGCCGGCCTGGCCCCGTTTGCACCACAAGCCCTTGAAGCGTATCGT
AACGCGTTACGCCAACCGGGCGCCGTACACGCAATGTGTGAAGACTATC
GTGCAGCGGCGACTATCGATCTGGAACATGATCGTGCGGATATTGAGCG
TGGTAATAAAATTGGTTGTCCTCTCCGCGTGCTGTGGGGGGTAGACGGT
GTCATCGAAAAATGCTTCGAACCTCTCGTGGAGTGGCGTAAAGTCGCGC
GAGATATCAGTGGTCGTGCTCTGCCCTGTGGGCATTACATTCCGGAGGA
GGCGCCGGATGAACTGGTAGCAGAAATGCTGAGTTTTTTTGAAGCTGTT
GATCTG
(SEQ ID NO: 28)
MFFEDFTPFRFAADDVDIYGVKGGAGPPLLLLHGHPQSHLIWHRCAARL
AEHFTVIATDLRGYGASAKPPSDASHMPYSKRAMAADQVAVMRHFGFDQ
FLVCAHDRGARVAHRMALDHPAAVERLMLLDIAPTLAMYEGTDRTFATL
YFHWFFLIQPEPLPETLIEGNPAAYVDRVMGSRHAGLAPFAPQALEAYR
NALRQPGAVHAMCEDYRAAATIDLEHDRADIERGNKIGCPLRVLWGVDG
VIEKCFEPLVEWRKVARDISGRALPCGHYIPEEAPDELVAEMLSFFEAV
DL

BDF15. Defluorinating enzyme from Paraburkholderia. The nucleic acid sequence and the amino acid sequence for BDF15 are below:

(SEQ ID NO: 29)
ATGCTGGAACTTCCGAACGATAAACGCGATGCAATGGCCTTCGAGAATT
TTACGCCATTTCGCGTTGCGGTGGGTGATGTGGATATCTTTGGGGTGAA
AGGGGGCGCAGGCCCGCCCTTGCTTCTGCTTCACGGCCATCCGCAGAGC
CATCTGATTTGGCAACGCTGTGCAGCTCGTTTGGCGGCACACTTCACGG
TTATCGCGACGGACTTACGGGGCTATGGTGCTTCTGGTAAGCCGGCGTC
CGATGCCACCCATATGCCTTATTCGAAACGCACCATGGCTGCGGATCAG
GTCGCCGTGATGCGCCATTTCGGCTTCGATAAGTTTCTAGTATGCGCTC
ACGATAGAGGAGCGCGTGTTGCACACCGGATGGCCCTGGACCACGCGGA
CGCGGTAGAACGCCTGATGTTGCTGGACATTGCTCCGACACTGGCAATG
TATGAGGCGACCGACAGGACTTTCGCGACCTTATACTTCCACTGGTTCT
TTCTCATCCAACCAGAGCCCCTGCCGGAGACTCTGATTGGTGCAAACCC
AGCCGCATATGTTGACGCAGTGATGGGAGGACGTCATGCGGGTTTAGCC
CCGTTTGATCCGGCCGCGCTCGAAGCTTATCGCGCCGCTCTCGCTCAGC
CTGGCGCAGTCCATGCCATGTGCGAGGACTACCGTGCGAGTGCAAGCAT
CGATCTGGAACATGATCGTGCCGATATAGAACGCGGTCACAAAATTGGC
TGCCCATTGCGAGTGCTGTGGGGGGACAAAGGCGTCATTGAAAAATGTT
TTGATGCCCTGGCGGAATGGCGTCATGTGGCGCGTGATGTTAGCGGTCG
TGCGCTGCCGTGTGGCCATTACATTCCTGAAGAAGCCAGTGACGAGCTG
GTCGCGGAAATGTTATCATTTTTTGAAGCCGTAGAACAG
(SEQ ID NO: 30)
MLELPNDKRDAMAFENFTPFRVAVGDVDIFGVKGGAGPPLLLLHGHPQS
HLIWQRCAARLAAHFTVIATDLRGYGASGKPASDATHMPYSKRTMAADQ
VAVMRHFGFDKFLVCAHDRGARVAHRMALDHADAVERLMLLDIAPTLAM
YEATDRTFATLYFHWFFLIQPEPLPETLIGANPAAYVDAVMGGRHAGLA
PFDPAALEAYRAALAQPGAVHAMCEDYRASASIDLEHDRADIERGHKIG
CPLRVLWGDKGVIEKCFDALAEWRHVARDVSGRALPCGHYIPEEASDEL
VAEMLSFFEAVEQ

BDF16. Defluorinating enzyme from Paraburkholderia. The nucleic acid sequence and the amino acid sequence for BDF16 are below:

(SEQ ID NO: 31)
ATGGCCTTCGAAAATTTCACCCCGTTCCGCGTGGCAGTAGGTGATGTTG
ATATCTTCGGAGTGAAAGGTGGCGCAGGTCCTCCGTTACTTCTGCTGCA
CGGCCATCCACAAAGTCATCTTATTTGGGCACGCTGTGCTGCCCAGCTG
GCGGAACATTTTACGGTAATTGCGACTGACTTACGTGGGTACGGCGCGA
GCGGCAAACCCCCGTCAGATGCGGACCATACCCCGTATTCGAAACGAGT
GATGGCAGCTGATCAGGTGGCAGTCATGCGCCACTTCGGATTTGAAAGA
TTTCTGGTCTGTGCGCACGATCGTGGCGCTCGTGTTGCTCACCGTATGG
CCCTGGATCACCCGGACGCCGTTGAACGCCTTATGTTACTGGATATCGC
CCCTACACTGGCCATGTACGAAGCGACCGATCGCACGTTTGCTACCCTA
TACTTTCATTGGTTCTTTCTCATCCAGCCAGAACCGCTCCCGGAAACTC
TGATTGGAGCGAACCCACGTGCGTATGTGGACGCGGTAATGGGTTCTCG
ACATGCCGGCCTCGCACCTTTCGACCCGGCGGCACTGGATGCGTATCGT
TCCGCGCTGGCGCAACCCGGTGCGGTCCATGCAATGTGCGAGGACTATC
GCGCCAGCGCCAGCATCGATCTGGAACTGGATAGGGCCGACATTGAGCG
TGGGCATAAAATTGGTTGTCCACTGCGCGTTTTGTGGGGTGATAAGGGC
GTTATTGAGAAATGCTTTGATGCTTTGGGGGAGTGGCGTCGGGTCGCGC
GCGATGTGTCGGGCCGGTCCCTGGACTGCGGCCACTATATACCGGAGGA
AGCCAGTGAAGAATTGGTGGTTGAAATGTTAGCATTTTTTGAGGCTGTG
GAACAG
(SEQ ID NO: 32)
MAFENFTPFRVAVGDVDIFGVKGGAGPPLLLLHGHPQSHLIWARCAAQL
AEHFTVIATDLRGYGASGKPPSDADHTPYSKRVMAADQVAVMRHFGFER
FLVCAHDRGARVAHRMALDHPDAVERLMLLDIAPTLAMYEATDRTFATL
YFHWFFLIQPEPLPETLIGANPRAYVDAVMGSRHAGLAPFDPAALDAYR
SALAQPGAVHAMCEDYRASASIDLELDRADIERGHKIGCPLRVLWGDKG
VIEKCFDALGEWRRVARDVSGRSLDCGHYIPEEASEELVVEMLAFFEAV
EQ

BDF17. Defluorinating enzyme from Paraburkholderia. The nucleic acid sequence and the amino acid sequence for BDF17 are below:

(SEQ ID NO: 33)
ATGGCATTTGAAAATTTCACCCCGTTCCGCGTTGCAGTAGGCGACGTTG
ACATCTTTGGGGTCAAGGGTGGTGCGGGCCCGCCGCTGTTGTTATTGCA
CGGTCATCCGCAGAGCCATCTCATTTGGCAGCGTTGCGCAGCTCAGCTG
GCGAAACATTTTACTGTCATAGCGACGGATCTCCGCGGCTACGGAGCGA
GCGGCAAACCACCATCAGACGCGCAACACACTCCGTATTCTAAAAGGGC
GATGGCCGCGGATCAAGTGGCTGTAATGCGCGAGTTTGGGTTTGAACGA
TTCCTTGTCTGCGCACACGATCGTGGTGCCCGTGTGGCTCATCGTATGG
CTCTGGACCACCCGGACGCCGTAGAGCGCCTGATGCTGCTGGATATTGC
ACCGACGCTAGCCATGTATGAAGCCACCGATCGCGCGTTCGCGACCCAC
TATTTCCATTGGTTTTTTCTGATCCAGCCGGAACCGCTCCCCGAGACAC
TGATTGGAATGAACCCTGCCGCGTATGTGGATGCTGTTATGGGAGCACG
TCACGCGGGGCTGGCTCCCTTCGAGCCTGATGCGTTAGACGCCTATCGT
TCGGCCCTGGCACAACCTGGCGCCGTGCATGCAATGTGTGAAGATTACC
GCGCCAGTGCCAGTATCGATCTTGAACATGACAGAGCGGATATTGAACG
CGGCCATAAAATCGCGTGCCCGTTACGTGTGCTTTGGGGTGATAAAGGT
GTTATTGGCAAGTGTTTCGATGCGTTGGCTGAGTGGCGCCACGTCGCAC
GGGATGTGTCCGGCCGGGCGCTGAGCTGTGGTCATTACATTCCAGAAGA
AGCCCCAGACGAACTGATCGCAGAGATGCTGTCGTTTTTTGAAGCCGTT
GAACAG
(SEQ ID NO: 34)
MAFENFTPFRVAVGDVDIFGVKGGAGPPLLLLHGHPQSHLIWQRCAAQL
AKHFTVIATDLRGYGASGKPPSDAQHTPYSKRAMAADQVAVMREFGFER
FLVCAHDRGARVAHRMALDHPDAVERLMLLDIAPTLAMYEATDRAFATH
YFHWFFLIQPEPLPETLIGMNPAAYVDAVMGARHAGLAPFEPDALDAYR
SALAQPGAVHAMCEDYRASASIDLEHDRADIERGHKIACPLRVLWGDKG
VIGKCFDALAEWRHVARDVSGRALSCGHYIPEEAPDELIAEMLSFFEAV
EQ

BDF18. Defluorinating enzyme from Paraburkholderia. The nucleic acid sequence and the amino acid sequence for BDF18 are below:

(SEQ ID NO: 35)
ATGGCATTTGAAAATTTCACACCTTTCCGCGTGGCGGTGGGTGATGTGG
ATATCTTTGGCATGAAAGGCGGGACGGGTCCCCCTCTCTTGCTGCTGCA
TGGTCATCCGCAAAGCCATCTGATTTGGCACCGCTGCGCCGCGCAACTT
GCGGCGCATTTCACCGTCATTGCCACAGATCTGCGCGGGTATGGTGCTA
GCGGCAAGCCACCGAGTGATGCGACCCACACTCCGTATAGTAAACGCAC
CATGGCGGCAGATCAGGTAGCCGTAATGCGGCATTTTGGCTTTGCCCGT
TTTCTCCTGTGTGCACACGACCGTGGCGCGCGTGTTGCGCACCGCATGG
CGCTGGATCACGCTGATGCGGTGGAGCGTCTAATGTTGCTGGACATTGC
GCCGACGCTGGCCATGTATGAAGCCACTGACCGCGCCTTTGCGACGCGC
TACTTTCACTGGTTCTTTCTTATTCAGCCGGAACCGCTGCCGGAAACCT
TGATCGGTATGAACCCCGCTGCCTATGTGGATGCGGTCATGGGGGGTCG
GCATGCCGGACTCGCGCCATTCGAGCCATCCAGCCTGGACGCGTATCGT
GCGGCCCTGGCACAGCCGGGCGCAGTACACGCTATGTGTGAAGACTACC
GTGCTTCAGCTTCCATCGATCTGGAGCATGACCGAGCCGATATAGAAAG
AGGAGCAAAAGTTGGCTGTCCTCTGAGGGTTTTATGGGGAGATAAAGGT
GTGATCGAACAGTGCTTTGATGCTTTAGCTGAATGGCGTCATGTCGCAC
GCGATGCATCGGGCCGTGCCCTGCCGTGCGGCCATTACATTCCGGAAGA
AGCCCCAGACGAACTTTTAGCGGAGATGTTATCTTTCTTCGCAGCAGTT
GAG
(SEQ ID NO: 36)
MAFENFTPFRVAVGDVDIFGMKGGTGPPLLLLHGHPQSHLIWHRCAAQL
AAHFTVIATDLRGYGASGKPPSDATHTPYSKRTMAADQVAVMRHFGFAR
FLLCAHDRGARVAHRMALDHADAVERLMLLDIAPTLAMYEATDRAFATR
YFHWFFLIQPEPLPETLIGMNPAAYVDAVMGGRHAGLAPFEPSSLDAYR
AALAQPGAVHAMCEDYRASASIDLEHDRADIERGAKVGCPLRVLWGDKG
VIEQCFDALAEWRHVARDASGRALPCGHYIPEEAPDELLAEMLSFFAAV
E

BDF19. Defluorinating enzyme from Mycobacterium. The nucleic acid sequence and the amino acid sequence for BDF19 are below:

(SEQ ID NO: 37)
ATGAGCGAAACTATACTAAGTCTGCGTTTAGGCGCGCACACCTCACGTG
CTCGGGGCGTACCGGGTCGCGGTTGCTATGGCGTAGCCGTACCGGCGGC
CCAGCATGCGCCGCAACGTTTCGTCGATAGCGCTGGCGTGCGCATTGCA
GTATATGAGGAAGGTAACCCGGAAGGGCCGACGGTTGTTCTGGCGCATG
GGTGGCCGGACTCGCACGTTCTTTGGGATGGAGTCGTTCCGCTGCTGGC
TGAACGCTTCAGGATCATTCGTTACGACAATCGTGGGGTGGGTTTGTCA
AGTGCGCCAAAACCGGTGTCGGCCTATGCAATGGGCTTATTCGCGGACG
ATTTTGCGGCAGTCGCTGGTGAACTCAGTCCTGGACGTCCAGTTCATGT
GTTAGCCCACGATTGGGGCTCAGTTGGTGTTTGGGAGTATCTGAAGCGA
CCTGGTGCCGGTGACAGAGTTGCGTCCTTTACCAGTGTGTCCGGGCCGT
CTCAAGATCAGCTTGCGAACTACGTCTTTGGCGGTCTGCGCCGTCCTTG
GCAGCCGCGACGCTTCGGACGCGCAGCGAGCCAGGCTCTGCGGCTGACC
TACATGGTGTTTTTTTCTATCCCAGTTGCGGCCCCGGCCCTGATCCGCC
TGACGCTGAGCTCTGCGGCATTGCGTCGCCGCGTGGTGGATAATATTCC
GTATAGCCAGATTCATCACTCCGCAGATGTCGCCCGTGATGCAGCACGC
TCCGTGAAAATCTACCCTGCCAATTATTTTCGTACTTTTGCGGGGCTCG
GCCGCGGCGGCCATGCCGTACAGGTGGTGGACGTGCCGGTACAACTGAT
TGTCAACACACGCGATAAATACGTCCGTCCCCACGGCTATGACGATACC
GCGCGTTGGGTGCCTCGCCTCTGGCGGAGAGATATTAAAGCTGGTCATT
TTTCGCCAATGAGCCATCCCGCCGTTATGGCCGCTGCAGTCCATGATTT
CGCGGACTTGGCGGAGGGCAAACCACCCTCGGATGAAATGCTTCGTGCA
CAGGTGCGGCGA
(SEQ ID NO: 38)
MSETILSLRLGAHTSRARGVPGRGCYGVAVPAAQHAPQRFVDSAGVRIA
VYEEGNPEGPTVVLAHGWPDSHVLWDGVVPLLAERFRIIRYDNRGVGLS
SAPKPVSAYAMGLFADDFAAVAGELSPGRPVHVLAHDWGSVGVWEYLKR
PGAGDRVASFTSVSGPSQDQLANYVFGGLRRPWQPRRFGRAASQALRLT
YMVFFSIPVAAPALIRLTLSSAALRRRVVDNIPYSQIHHSADVARDAAR
SVKIYPANYFRTFAGLGRGGHAVQVVDVPVQLIVNTRDKYVRPHGYDDT
ARWVPRLWRRDIKAGHFSPMSHPAVMAAAVHDFADLAEGKPPSDEMLRA
QVRR

BDF20. Defluorinating enzyme from Paraburkholderia. The nucleic acid sequence and the amino acid sequence for BDF20 are below:

(SEQ ID NO: 39)
ATGGCATTTGAAGATTTTACTCCCTTTAGCGTCACGGTTGGCGACGTGG
ACATTTTTGGCGTTAAAGGTGGCGCGGGGCCACCGCTCCTGTTGCTGCA
TGGCCATCCTCAATCCCACCTGATTTGGCAGCGCTGTGCCGCCCAGTTA
GCTCAACATTTCACGGTTATCGCAACCGATCTCAGAGGTTATGGTGCAA
GTTCCAAACCGAGCAGTGACGCGCACCATACTCCGTATTCAAAACGGAC
CATGGCAGCCGATCAAGTAGCGGTAATGCGCCACCTGGGTTTTGAGCGA
TTCCTGGTTTGTGCCCACGATCGTGGGGCGCGAGTGGCGCACCGTATGG
CGCTGGATCACGCTGACGCTGTAGAAAGGCTGATGTTGCTGGATATTGC
CCCCACCCTAGCTATGTATGAAGCGACCGACCGCACATTCGCAACACTG
TACTTTCATTGGTTCTTTTTAATTCAGCCTGAGCCGCTGCCAGAGACGT
TAATAGGAGCCAACCCGGCTGCCTACGTGGATAGCGTGATGGGTTCTCG
TCATGCTGGCCTTGGTCCGTTTGATCCGGAAGCACTGGCGGCGTATCGC
TCGGCGCTGGCCCAGCCTGGCGCTGTTCATGCGATGTGCGAAGATTATC
GTGCGTCAGCGAGTATCGATTTAGAACACGACCGTGCAGACATTGAGCG
TGGCCATAAAATCGCATGTCCGCTGCGCGTCCTGTGGGGAGATAAGGGA
GTGATTGAAAAATGCTTTGACGCCCTCGGGGAATGGCGCCAGGTGGCAC
GCGATGTCTCGGGTCGTGCGCTTTCTTGCGGCCATTACATCCCAGAAGA
GGCCCCGGATGAGTTGGTCGCGGAAATGCTTAGCTTCTTCGAAGCCATC
GAACGG
(SEQ ID NO: 40)
MAFEDFTPFSVTVGDVDIFGVKGGAGPPLLLLHGHPQSHLIWQRCAAQL
AQHFTVIATDLRGYGASSKPSSDAHHTPYSKRTMAADQVAVMRHLGFER
FLVCAHDRGARVAHRMALDHADAVERLMLLDIAPTLAMYEATDRTFATL
YFHWFFLIQPEPLPETLIGANPAAYVDSVMGSRHAGLGPFDPEALAAYR
SALAQPGAVHAMCEDYRASASIDLEHDRADIERGHKIACPLRVLWGDKG
VIEKCFDALGEWRQVARDVSGRALSCGHYIPEEAPDELVAEMLSFFEAI
ER

BDF21. Defluorinating enzyme from Paraburkholderia. The nucleic acid sequence and the amino acid sequence for BDF21 are below:

(SEQ ID NO: 41)
ATGTTTTTTGAAGACTTTACGCCGTTTCGGTTCGCAGATGGAGAAGTTG
ATATTCATGGCGTCAAAGGTGGTGCTGGTCCCCCGCTACTGTTGCTGCA
CGGTCATCCGCAGAACCACCTGATCTGGCACCGTTGCGCGGCACGCTTA
GCGCAGCATTTCACCGTTATAGCTCCAGATCTGCGAGGTTATGGAGCCT
CGGGGAAACCGGCGGGAGACGCCGCGCATCTTACCTACAGTAAACGTGC
CATGGCTGCCGACCAGATGGCCTTAATGCGTCATTTCGGCCACGAACGC
TTCCTGGTGTGTGCGCACGATCGCGGCGCCCGAGTAGCTCACCGTCTGG
CCCTTGACCATCCGGCAGCAGTGGAACGGCTGATGTTACTGGATATTGC
GCCGACCCTCGCGATGTATGAGCGCACAGATCGTGCATTCGCCACCGCT
TATTTTCACTGGTTTTTTCTTATTCAGCCTGCGCCGCTGCCCGAAACGC
TGATTGAGGCGAATCCAGCGGCCTATGTTGACGGGGTCATGTCTTCACG
CCACGCTGGTCTGGCACCGTTTGCTCCGGAAGCACTGGATGCGTATCGT
CGCGCTCTCGCCCAACCTGGCGCGGTGCATGCGATGTGTGAGGACTACC
GCGCCGCGGCAACTATCGATTTGGAACATGATCGGGCCGATTTAGAACG
TGGGAACAAAATTGGTTGTCCTCTCCGCGTGCTGTGGGGCGAACATGGC
GTGATCGAACAATGCTTTGAACCACTGGATGAATGGCGTAAGGTCGCCA
GAGATGTATCCGGCAGGGCATTGCCCTGCGGCCATTACATCCCAGAGGA
GGCGCCGGACGAGTTGATTGCAGAAATGATGCGCTTCTTCGATGCGACT
GAAAGC
(SEQ ID NO: 42)
MFFEDFTPFRFADGEVDIHGVKGGAGPPLLLLHGHPQNHLIWHRCAARL
AQHFTVIAPDLRGYGASGKPAGDAAHLTYSKRAMAADQMALMRHFGHER
FLVCAHDRGARVAHRLALDHPAAVERLMLLDIAPTLAMYERTDRAFATA
YFHWFFLIQPAPLPETLIEANPAAYVDGVMSSRHAGLAPFAPEALDAYR
RALAQPGAVHAMCEDYRAAATIDLEHDRADLERGNKIGCPLRVLWGEHG
VIEQCFEPLDEWRKVARDVSGRALPCGHYIPEEAPDELIAEMMRFFDAT
ES

BDF22. Defluorinating enzyme. The nucleic acid sequence and the amino acid sequence for BDF22 are below:

(SEQ ID NO: 43)
ATGCTGTATGTGAACGGGGTAGATATCAGCTACCGCAAAGGTGGCACCG
GTCCAGGATTGCTGCTCCTGCACGGTCATCCGCAAACCCATGTCATCTG
GCACAAAGTAGCGGGTAATCAACTCGCCGAACATTTTACTGTCGTGGCT
GCTGATCTGCGCGGCTACGGTGACTCCTCGAAGCCGTTAGCAGACGATT
TGCACGCCAATTATTCCAAACGTCAGATGGCGCGCGACGGCGTTGAATT
AGATGCGGGACCGGGTCGTTTTGAACAGTTTTCTGTTCTGGCGCATGAT
CGTGGCGCGCGCGTGGCTCATCGGCTCGCCCTGGATCACCCGAGTGCAG
TCCAACGTATGGTTCTATTGGATATCGCTCCGACGTTAAGCATGTATGC
GCAGACAGATGAAGCCTTTGCGCGTGCGTACTGGCATTGGTTCTTCCTT
ATTCGACCTGCTCCACTGCCAGAAGCGTTAATTGGCTCGAACCCGGAAC
TGTATCTGCGCAGCGTAATGGGCAGTCGCTCAGCGGGATTGAAACCCTT
CACTGACGAAGCCTTCGCCGAGTATTTGAGATGCCTGCAGCTGCCTGGT
ACCGCACGGGGGATCTGTGAAGACTATCGTGCAGCCGCGGGGATTGACT
TAGAGCATGATCAGGCCGATATTGATGCCGGCCACCATCTGAACCTGCC
CCTGCTGGTGATGTGGGGTGCAGAGGGCACGGTCGGTCGTTGCTTTGAA
CCTCTTAAAGAGTGGCAGAAAGTGGCGACGGACGTTAGGGGGAAGGCAC
TGCCGGCAGGCCACTACATAGCAGAGGAAGTGCCGGAACTGCTGCTTGG
CGAAGTTCTCACCTTTCTTCGC
(SEQ ID NO: 44)
MLYVNGVDISYRKGGTGPGLLLLHGHPQTHVIWHKVAGNQLAEHFTVVA
ADLRGYGDSSKPLADDLHANYSKRQMARDGVELDAGPGRFEQFSVLAHD
RGARVAHRLALDHPSAVQRMVLLDIAPTLSMYAQTDEAFARAYWHWFFL
IRPAPLPEALIGSNPELYLRSVMGSRSAGLKPFTDEAFAEYLRCLQLPG
TARGICEDYRAAAGIDLEHDQADIDAGHHLNLPLLVMWGAEGTVGRCFE
PLKEWQKVATDVRGKALPAGHYIAEEVPELLLGEVLTFLR

It is to be understood that various orthologs and paralogs, including orthologs and paralogs of SEQ ID NOs: 1-44, can be used.

In some aspects, the defluorinating enzyme can have at least 60%, 65%, 70%, 75%, 80%, 85%, 90%, 91%, 92%, 93%, 94%, 95%, 96%, 97%, 98%, 99% or more amino acid sequence identity to one of the above described defluorinating enzymes, for example, the defluorinating enzymes of SEQ ID NOs: 2, 4, 6, 8, 10, 12, 14, 16, 18, 20, 22, 24, 26, 28, 30, 32, 34, 36, 38, 40, 42, or 44.

In some aspects, the defluorinating enzyme can have at least 60%, 65%, 70%, 75%, 80%, 85%, 90%, 91%, 92%, 93%, 94%, 95%, 96%, 97%, 98%, 99% or more nucleic acid sequence identity to one of the above described defluorinating enzymes, for example, the defluorinating enzymes of SEQ ID NOs: 1, 3, 5, 7, 9, 11, 13, 15, 17, 19, 21, 23, 25, 27, 29, 31, 33, 35, 37, 39, 41, or 43. In some aspects, the defluorinating enzyme can encoded by a nucleic acid that hybridizes under stringent hybridization conditions to one of SEQ ID NOs: 1, 3, 5, 7, 9, 11, 13, 15, 17, 19, 21, 23, 25, 27, 29, 31, 33, 35, 37, 39, 41, or 43, or their complement.

In some aspects, the defluorinating enzyme can be in various forms, for example, such as an isolated preparation, as a substantially purified preparation, whole cells transformed with gene(s) encoding the polypeptide, and/or as cell extracts and/or lysates of such cells. The enzymes can be lyophilized, spray-dried, precipitated or be in the form of a crude paste, as further discussed below. In some aspects, any of the defluorinating enzymes expressed in a host cell can be recovered from the cells and or the culture medium using any one or more of the well-known techniques for protein purification, including, among others, lysozyme treatment, sonication, filtration, salting-out, ultra-centrifugation, and chromatography.

Chromatographic techniques for isolation of the defluorinating enzyme include, among others, reverse phase chromatography high performance liquid chromatography, ion exchange chromatography, gel electrophoresis, and affinity chromatography. Conditions for purifying a particular enzyme will depend, in part, on factors such as net charge, hydrophobicity, hydrophilicity, molecular weight, molecular shape, etc., and will be apparent to those having skill in the art.

In some aspects, affinity techniques may be used to isolate defluorinating enzymes. In some aspects, for affinity chromatography purification, any antibody which specifically binds the defluorinating enzyme may be used. For the production of antibodies, various host animals, including but not limited to rabbits, mice, rats, etc., may be immunized by injection with a defluorinating enzyme, or a fragment thereof. The defluorinating enzyme or fragment may be attached to a suitable carrier, such as BSA, by means of a side chain functional group or linkers attached to a side chain functional group. In some aspects, the affinity purification can use a specific ligand bound by the defluorinating enzyme.

### Polynucleotides and Expression Vectors

In another aspect, polynucleotides can encode any of the recombinant defluorinating enzymes described herein. The recombinant polynucleotides may be operatively linked to one or more control sequences that control gene expression to create a recombinant polynucleotide capable of expressing the recombinant polypeptide. Expression constructs containing a heterologous polynucleotide encoding the defluorinating enzyme can be introduced into appropriate host cells to express the corresponding recombinant defluorinating enzyme.

Accordingly, in some aspects, the polynucleotide encodes a recombinant defluorinating enzyme having at least 60%, 65%, 70%, 75%, 80%, 85%, 90%, 91%, 92%, 93%, 94%, 95%, 96%, 97%, 98%, 99% or more sequence identity to a reference amino acid sequence selected from: SEQ ID NOs: 2, 4, 6, 8, 10, 12, 14, 16, 18, 20, 22, 24, 26, 28, 30, 32, 34, 36, 38, 40, 42, or 44.

The polynucleotides can be capable of hybridizing under stringent conditions to a reference polynucleotide sequence selected from SEQ ID NOs: 1, 3, 5, 7, 9, 11, 13, 15, 17, 19, 21, 23, 25, 27, 29, 31, 33, 35, 37, 39, 41, or 43, or a complement thereof, and encodes a polypeptide having defluorinating activity described herein.

In some aspects, the polynucleotides are codon optimized to fit the host cell in which the protein is being produced. For example, preferred codons used in bacteria are used to express the gene in bacteria; preferred codons used in yeast are used for expression in yeast; and preferred codons used in mammals are used for expression in mammalian cells. In some aspects, all codons need not be replaced to optimize the codon usage of the defluorinating enzyme since the natural sequence will comprise preferred codons and because use of preferred codons may not be required for all amino acid residues.

In another aspect, the polynucleotide encoding a recombinant defluorinating enzyme may be manipulated in a variety of ways to provide for expression of the polypeptide. The polynucleotides encoding the polypeptides can be provided as expression vectors where one or more control sequences are present to regulate the expression of the polynucleotides and/or polypeptides. Manipulation of the isolated polynucleotide prior to its insertion into a vector may be desirable or necessary depending on the expression vector. The techniques for modifying polynucleotides utilizing recombinant DNA methods are well known in the art. Guidance is provided in Sambrook et al., Molecular Cloning: A Laboratory Manual, 3rd Ed., Cold Spring Harbor Laboratory Press (2001); and Current Protocols in Molecular Biology, Ausubel. F. ed., Greene Pub. Associates, (1998), with updates to 2006.

In some aspects, the control sequences include among others, promoters, enhancers, leader sequences, polyadenylation sequences, propeptide sequences, signal peptide sequences, and transcription terminators. Other control sequences will be apparent to the person of skill in the art.

Suitable promoters can be selected based on the host cells used. For bacterial host cells, suitable promoters for directing transcription of the nucleic acid constructs of the present disclosure, include the promoters obtained from the E. coli lac operon, Streptomyces coelicolor agarase gene (dagA), Bacillus subtilis levansucrase gene (sacB), Bacillus licheniformis alpha-amylase gene (amyL), Bacillus stearothermophilus maltogenic amylase gene (amyM), Bacillus amyloliquefaciens alpha-amylase gene (amyQ), Bacillus licheniformis penicillinase gene (penP), Bacillus subtilis xylA and xylB genes, and prokaryotic beta-lactamase gene, the tac promoter, or the T7 promoter.

Exemplary promoters for filamentous fungal host cells, include promoters obtained from the genes for Aspergillus oryzae TAKA amylase, Rhizomucor miehei aspartic proteinase, Aspergillus niger neutral alpha-amylase, Aspergillus niger acid stable alpha-amylase, Aspergillus niger or Aspergillus awamori glucoamylase (glaA), Rhizomucor miehei lipase, Aspergillus oryzae alkaline protease, Aspergillus oryzae triose phosphate isomerase, Aspergillus nidulans acetamidase, and Fusarium oxysporum trypsin-like protease (WO 96/00787), as well as the NA2-tpi promoter (a hybrid of the promoters from the genes for Aspergillus niger neutral alpha-amylase and Aspergillus oryzae triose phosphate isomerase), and mutant, truncated, and hybrid promoters thereof. Exemplary yeast cell promoters can be from the genes can be from the genes for Saccharomyces cerevisiae enolase (ENO-1), Saccharomyces cerevisiae galactokinase (GAL1), Saccharomyces cerevisiae alcohol dehydrogenase/glyceraldehyde-3-phosphate dehydrogenase (ADH2/GAP), and Saccharomyces cerevisiae 3-phosphoglycerate kinase.

Exemplary promoters for insect cells include, among others, those based on polyhedron, PCNA, OplE2, OplE1, Drosophila metallothionein, and Drosophila actin 5C. In some embodiments, insect cell promoters can be used with Baculoviral vectors.

Exemplary promoters for plant cells include, among others, those based on cauliflower mosaic virus (CaMV) 35S, polyubiquitin gene (PvUbi1 and PvUbi2), rice (Oryza sativa) actin 1 (OsAct1) and actin 2 (OsAct2) promoters, the maize ubiquitin 1 (ZmUbi1) promoter, and multiple rice ubiquitin (RUBQ1, RUBQ2, rubi3) promoters.

Exemplary promoters for mammalian cells include, among others, CMV IE promoter, elongation factor 1α-subunit promoter, ubiquitin C promoter, Simian Virus 40 promoter, and phosphoglycerate Kinase-1 promoter.

The control sequence may also be a suitable leader sequence, a nontranslated region of an mRNA that is important for translation by the host cell. The leader sequence is operably linked to the 5′ terminus of the nucleic acid sequence encoding the polypeptide. Any leader sequence that is functional in the host cell of choice may be used.

The control sequence may also be a polyadenylation sequence, a sequence operably linked to the 3′ terminus of the nucleic acid sequence and which, when transcribed, is recognized by the host cell as a signal to add polyadenosine residues to transcribed mRNA. Any polyadenylation sequence which is functional in the host cell of choice may be used in the present invention.

The control sequence may also be a signal peptide coding region that codes for an amino acid sequence linked to the amino terminus of a polypeptide and directs the encoded polypeptide into the cell's secretory pathway. The 5′ end of the coding sequence of the nucleic acid sequence may inherently contain a signal peptide coding region naturally linked in translation reading frame with the segment of the coding region that encodes the secreted polypeptide. Alternatively, the 5′ end of the coding sequence may contain a signal peptide coding region that is foreign to the coding sequence. Any signal peptide coding region which directs the expressed polypeptide into the secretory pathway of a host cell of choice may be used in the present disclosure.

The control sequence may also be a propeptide coding region that codes for an amino acid sequence positioned at the amino terminus of a polypeptide. The resultant polypeptide is known as a proenzyme or propolypeptide (or a zymogen in some cases). A propolypeptide can be converted to a mature active polypeptide by catalytic or autocatalytic cleavage of the propeptide from the propolypeptide. Where both signal peptide and propeptide regions are present at the amino terminus of a polypeptide, the propeptide region is positioned next to the amino terminus of a polypeptide and the signal peptide region is positioned next to the amino terminus of the propeptide region.

The control sequence may also be a suitable transcription terminator sequence, a sequence recognized by a host cell to terminate transcription. The terminator sequence is operably linked to the 3′ terminus of the nucleic acid sequence encoding the polypeptide. Any terminator which is functional in the host cell of choice may be used.

It may also be desirable to add regulatory sequences, which allow the regulation of the expression of the polypeptide relative to the growth of the host cell. Examples of regulatory systems are those which cause the expression of the gene to be turned on or off in response to a chemical or physical stimulus, including the presence of a regulatory compound. In prokaryotic host cells, suitable regulatory sequences include the lac, tac, and trp operator systems. In yeast host cells, suitable regulatory systems include, as examples, the ADH2 system or GAL1 system. In filamentous fungi, suitable regulatory sequences include the TAKA alpha-amylase promoter, Aspergillus niger glucoamylase promoter, and Aspergillus oryzae glucoamylase promoter.

In another aspect, the present disclosure is also directed to a recombinant expression vector comprising a polynucleotide encoding a defluorinating enzyme, and one or more expression regulating regions such as a promoter and a terminator, a replication origin, etc., depending on the type of hosts into which they are to be introduced.

The expression vector may be an autonomously replicating vector, i.e., a vector that exists as an extrachromosomal entity, the replication of which is independent of chromosomal replication, e.g., a plasmid, an extrachromosomal element, a minichromosome, or an artificial chromosome. The vector may contain any means for assuring self-replication. Alternatively, the vector may be one which, when introduced into the host cell, is integrated into the genome and replicated together with the chromosome(s) into which it has been integrated. Furthermore, a single vector or plasmid or two or more vectors or plasmids which together contain the total DNA to be introduced into the genome of the host cell, or a transposon may be used. The expression vector can exist as a single copy in the host cell, or maintained at higher copy numbers, e.g., up to 4 for low copy number and 50 or more for high copy number.

In some aspects, the expression vector contains one or more selectable markers, which permit selection of transformed cells. A selectable marker is a gene the product of which provides for biocide or viral resistance, resistance to heavy metals, prototrophy to auxotrophs, and the like. Examples of bacterial selectable markers are the dal genes from Bacillus subtilis or Bacillus licheniformis, or markers, which confer antibiotic resistance such as ampicillin, kanamycin, chloramphenicol (Example 1) or tetracycline resistance. Suitable markers for yeast host cells are ADE2, HIS3, LEU2, LYS2, MET3, TRP1, and URA3. Selectable markers for use in a filamentous fungal host cell include, but are not limited to, amdS (acetamidase), argB (ornithine carbamoyltransferase), bar (phosphinothricin acetyltransferase), hph (hygromycin phosphotransferase), niaD (nitrate reductase), pyrG (orotidine-5′-phosphate decarboxylase), sC (sulfate adenyltransferase), and trpC (anthranilate synthase), as well as equivalents thereof. Embodiments for use in an Aspergillus cell include the amdS and pyrG genes of Aspergillus nidulans or Aspergillus oryzae and the bar gene of Streptomyces hygroscopicus.

### Host Cells

In another aspect, the present disclosure provides a host cell comprising a polynucleotide encoding a recombinant defluorinating enzyme of the present disclosure. Host cells can be prokaryotic or eukaryotic cells. Prokaryotic host cells include bacteria, e.g., eubacteria, such as Gram-negative or Gram-positive organisms, for example, any species of Acidovorax, Agrobacterium, Alicyclobacillus, Anabaena, Anacystis, Arthrobacter, Azobacter, Bacillus, Brevibacterium, Chromatium, Clostridium, Corynebacterium, Enterobacter, Erwinia, Escherichia, Lactobacillus, Lactococcus, Mesorhizobium, Methylobacterium, Microbacterium, Phormidium, Pseudomonas, Rhodobacter, Rhodopseudomonas, Rhodospirillum, Rhodococcus, Salmonella, Scenedesmun, Serratia, Shigella, Staphylococcus, Strepromyces, Synnecoccus, Vibrio, and Zymomonas, including, e.g., Bacillus amyloliquefacines, Bacillus subtilis, Brevibacterium ammoniagenes, Brevibacterium immariophilum, Clostridium acetobutylicum, Clostridium beigerinckii, Clostridium Beijerinckii, Clostridium saccharoperbutylacetonicum, Clostridium saccharobutylicum, Clostridium aurantibutyricum, Clostridium tetanomorphum, Enterobacter sakazakii, Bacillus cereus, Escherichia coli, Lactococcus lactis, Mesorhizobium loti, Pseudomonas aeruginosa, Pseudomonas fluorescens, Pseudomonas mevalonii, Pseudomonas pudica, Rhodobacter capsulatus, Rhodobacter sphaeroides, Rhodospirillum rubrum, Salmonella enterica, Salmonella typhi, Salmonella typhimurium, Serratia marcescens, Shigella dysenteriae, Shigella flexneri, Shigella sonnei, Staphylococcus aureus, Vibrio natriegens, and the like. Further examples of prokaryotic host cells include: Bacillus such as B. megaterium, B. lichenformis or B. subtilis; Pantoea, such as P. citrea; Pseudomonas, such as P. alcaligenes; Streptomyces, such as S. lividans or S. rubiginosus; Escherichia, such as E. coli; Enterobacter; Streptococcus; Archaea, such as Methanosarcina mazei; or Corynebacterium, such as C. glutamicum. The host cell can be a gram-positive bacterium such as, for example, strains of Streptomyces (e.g., s. lividans, S. coelicolor, or S. griseus) and Bacillus. The host cell can also be a gram-negative bacterium, such as, for example, E. coli and other enterics, or Pseudomonas sp. The host cell can be a soil bacteria including, for example, Bacillus (e.g., B. megaterium, B. thuringiensis, B. subtilis, B. mycoides, B. pumillus), Acidobacteriota, Verrucomicrobia, Burkholderia pseudomallei, rhizobium, Bateriodota, Streptomyces, Paenibacillus, Brevibacillus, Sporosarcina, Lysinibacillus, Psychrobacillus, Cohnella, Sporosarcina, Staphylococcus, Agrobacterium, Arthrobacter, Micromonospora, Actinomadura, Pseudomonas, Rhodococcus, Alcaligenes, Flavobacterium, Hyphomicrobium, Clostridium, Ralstonia, Collimonas, Nitrobacter, Geobacillus, Stenotrophomonas, Pseudonocardia, Deinococcus, Variovorax, Phenylobacterium, Bradyrhizobium, Saccharomonospora, Geodermatophilus, Pseudolabrys, Gemmatimonas, Frankia, Reyranella, Variibacter, Azotobacter, Nocardioides, Terriglobus, Microbispora, Microbacterium, Promicromonospora, Glycomyces, Amycolatopsis, Spirillospora, Actinopolyspora, Kitasatospora, Thermomonospora, Saccharothrix, Nocardiopsis, Microtetraspora, Pilimelia, Bryobacter, Rhizomicrobium, Firmicutes, Proteobacteria, Bacteroidetes, Actinobacteria, Nocardia, Actinoplanes, Flexibacter, Mycobacterium, Ralstonia, and Haliangium. The host cell can be a petroleum degrading bacterium including, for example, Achromobacter (e.g., Achromobacter xylosoxidans DN002), Acinetobacter (e.g., sp. RAG-1), Aeromonas (e.g., A. hydrophila), Agmenellum (e.g., quadruplicatum), Alcanivorax, Alcaligenes (e.g., A. xylosoxidans), Alkanindiges, Alteromonas, Arthrobacter, Bacillus (e.g., B. Megaterium, B. subtilis, B. licheniformis), Burkholderia, Cycloclasticus, Dietzia (e.g., Dietzia sp. DQ12-45-1b), Enterobacter, Gordonia sp., Kocuria, Marinobacter, Mycobacterium, Ochrobactrum, Oleispira, Pandoraea, Pseudomonas (e.g., P. aeruginosa, P. luorescens, P. putida), Rhodococcus (e.g., R. equi), Staphylococcus, Stenotrophomonas (e.g., S. maltophilia), Streptobacillus, Streptococcus, Thallassolituus, and Xanthomonas sp.

Other host cells include, for example, Paenibacillus sp. TCA20, Brevibacillus laterosporus LMG 15441, Brevibacillus laterosporus LMG 15441, Tetrasphaera japonica T1-X7, Paenibacillus tyrfis, Metabacillus indicus (Bacillus indicus), Paenibacillus macerans (Bacillus macerans), bacterium YEK0313, Pontibacillus yanchengensis Y32, Pontibacillus chungwhensis BH030062, Pontibacillus halophilus JSM 076056=DSM 19796, Halobacillus sp. BBL2006, Jeotgalibacillus campisalis, Bradyrhizobium elkanii, Aneurinibacillus migulanus (Bacillus migulanus), Paenibacillus sp. IHBB 10380, Paenibacillus beijingensis, Bradyrhizobium sp. LTSP885, Saccharothrix sp. ST-888, Archangium gephyra, Streptomyces sp. Mg1, Variovorax paradoxus, Alkalihalobacillus macyae, Chondromyces crocatus, Peribacillus loiseleuriae, Rossellomorea marisflavi, Priestia koreensis, Bacillus sp. FJAT-22058, Mycolicibacterium obuense, Paenibacillus sp. DMB20, Actinobacteria bacterium OK074, Pseudonocardia sp. EC080619-01, Rossellomorea vietnamensis, Corynebacterium lowii, Paenibacillus sp. Leaf72, Afipia sp. Root123D2, Rhizobium sp. Root149, Variibacter gotjawalensis, Mycobacterium sp. Root135, Neobacillus massiliamazoniensis, Planococcus rifietoensis, Aneurinibacillus soli, Streptomyces sp. NRRL S-1521, Streptomyces sp. DSM 15324, Variovorax sp. WDL1, Erythrobacter sp. YT30, Variovorax sp. PAMC 28711, Tardiphaga robiniae, Paenibacillus antarcticus, Paenibacillus swuensis, Paenibacillus bovis, Bacillus sp. SJS, Bacillus sp. SJS, Domibacillus aminovorans, Paenibacillus sp. KS1, Paenibacillus sp. KS1, Streptomyces sp. PTY08712, Bradyrhizobium sp. LMTR 3, Mesorhizobium hungaricum, Paenibacillus nuruki, Variovorax sp. CF079, Alteribacillus persepolensis, Afipia sp. GAS231, Streptomyces sp. cf386, Streptomyces sp. cf386, Actinopolymorpha singaporensis, Halopseudomonas salegens, Thalassobacillus cyri, Mesobacillus persicus, Rhodospirillales bacterium URHD0017, Salipaludibacillus aurantiacus, Rhizobium sp. NFR07, Mesorhizobium albiziae, Paenibacillus sp. 1_12, Gracilibacillus orientalis, Pseudonocardia ammonioxydans, Variovorax sp. PDC80, Marinobacter daqiaonensis, Rossellomorea aquimaris, Streptomyces sp. F-1, Alicyclobacillus montanus, Pseudonocardia thermophila, Bradyrhizobium erythrophlei, Planococcus lenghuensis, Bacillus sp. MRMR6, Paenibacillus rhizosphaerae, Enhydrobacter aerosaccus, Paludisphaera borealis, Saccharothrix sp. ALI-22-I, Fulvimarina manganoxydans, Priestia filamentosa, Paenibacillus uliginis N3/975, Mesorhizobium australicum, Streptomyces albireticuli, Cohnella sp. CIP 111063, Dermatophilus congolensis, Variovorax sp. JS1663, Variovorax sp. JS1663, Melittangium boletus DSM 14713

Pseudonocardia sp. MH-G8, Paenibacillus sp. 7516, Paenibacillus sp. 7541, Bacillus sp. AFS018417, Bacillus sp. AFS018417, Streptomyces cinnamoneus (Streptoverticillium cinnamoneum), Streptomyces sp. JV178, Streptomyces showdoensis, Paenibacillus sp. CAA11, Jeotgalibacillus proteolyticus, Alkalicoccus saliphilus, Vitiosangium sp. (strain GDMCC 1.1324), Actinomycetospora cinnamomea, Actinomycetospora cinnamomea, Paenibacillus sambharensis, Paenibacillus donghaensis, Thermosporothrix hazakensis, Thermogemmatispora tikiterensis, Thermoflavimicrobium daqui, Paenibacillus paeoniae, Geodermatophilus sp. LHW52908, Bacillus salacetis, Kutzneria buriramensis, Falsibacillus albus, Arthrobacter oryzae, Streptomyces sp. TLI_185, Variovorax sp. DXTD-1, Streptomyces luteoverticillatus (Streptoverticillium luteoverticillatus), Streptomyces luteoverticillatus (Streptoverticillium luteoverticillatus), Dictyobacter aurantiacus, Tengunoibacter tsumagoiensis, Dictyobacter kobayashii, Dictyobacter alpinus, Pseudonocardiaceae bacterium YIM PH 21723, Variovorax sp. MHTC-1, Variovorax gossypii, Mesobaculum littorinae, Neorhizobium lilium, Phreatobacter sp. NMCR1094, Ktedonosporobacter rubrisoli, Paenibacillaceae bacterium, Monosporascus sp. 5C6A, Nocardioides iriomotensis, bacterium, Kribbella antibiotica, Saccharibacillus brassicae, Blastococcus sp. CT_GayMR19, Halobacillus salinus, Streptomyces sporangiiformans, Pseudonocardia asaccharolytica DSM 44247=NBRC 16224, Streptomyces spectabilis, Variovorax sp, Oryzihumus leptocrescens, Arthrobacter sp. KBS0703, Amycolatopsis rhizosphaerae, Paenibacillus sp. N4, Paenibacillus sp. N4, Nocardioides albidus, Vineibacter terrae, Paenibacillus faecis, Dictyobacter vulcani, Streptomyces alboniger, Streptomyces spongiae, Pseudalkalibacillus caeni, Rhodospirillales bacterium, Streptomyces liangshanensis, Streptomyces sp. DSM 40868, Micromonospora sp. WMMC415, Bacillus anthracis, Lichenicola cladoniae, Sulfitobacter sediminilitoris, Variovorax sp. PBL-E5, Candidatus Afipia apatlaquensis, Variovorax sp. PAMC28562, Ktedonobacteria bacterium brp13, Streptomyces sp. SID4985, Streptomyces sp. SID5789, Streptomyces sp. QHH-9511, Epidermidibacterium keratini, Streptomyces ferrugineus, Streptomyces ferrugineus, Mesorhizobium sp. L-8-10, Mesorhizobium sp. L-8-10, Paenibacillus phyllosphaerae, Crossiella cryophile, Streptomyces olivoverticillatus, Streptomyces nymphaeiformis, Nonomuraea endophytica, Metabacillus lacus, Paenibacillus lutrae, Streptomyces sp. R302, Actinomycetospora sp. TBRC 11914, Rotaria sp. Silwood1, Adineta steineri, Rotaria sp. Silwood1, Didymodactylos carnosus, Rotaria sp. Silwood1, Rotaria sp. Silwood1, Halosaccharopolyspora lacisalsi, Saccharopolyspora gloriosae, Nocardiopsis metallicus, Pontixanthobacter aestiaquae, Pseudonocardia bannensis, Altererythrobacter lutimaris, Ktedonospora formicarum, Reticulibacter mediterranei, Ktedonospora formicarum, Oligoflexus sp, marine gamma proteobacterium HTCC2143, Erythrobacter sp. NAP1, Bacillus pumilus (strain SAFR-032), Herpetosiphon aurantiacus (strain ATCC 23779/DSM 785/114-95), Nakamurella multipartita (strain ATCC 700099/DSM 44233/CIP 104796/JCM 9543/NBRC 105858/Y-104) (Microsphaera multipartita), Nakamurella multipartita (strain ATCC 700099/DSM 44233/CIP 104796/JCM 9543/NBRC 105858/Y-104) (Microsphaera multipartita), Streptomyces scabiei (strain 87.22), Streptosporangium roseum (strain ATCC 12428/DSM 43021/JCM 3005/NI 9100), Naegleria gruberi (Amoeba), Geobacillus sp. (strain Y412MC10), Priestia megaterium (strain ATCC 12872/QMB1551) (Bacillus megaterium), Streptomyces sp. e14, Ktedonobacter racemifer DSM 44963, Ktedonobacter racemifer DSM 44963, Streptomyces himastatinicus ATCC 53653

Ahrensia sp. R2A130, Paenibacillus polymyxa (strain SC2) (Bacillus polymyxa), Pseudonocardia dioxanivorans (strain ATCC 55486/DSM 44775/JCM 13855/CB1190), Paenibacillus sp. HGF7, Bradyrhizobiaceae bacterium SG-6C

Paenibacillus dendritiformis C454, Paenibacillus dendritiformis C454, Deinococcus gobiensis (strain DSM 21396/JCM 16679/CGMCC 1.7299/1-0), Halobacillus halophilus (strain ATCC 35676/DSM 2266/JCM 20832/KCTC 3685/LMG 17431/NBRC 102448/NCIMB 2269) (Sporosarcina halophila), Fictibacillus macauensis ZFHKF-1, Novosphingobium sp. Rr 2-17, Neobacillus bataviensis LMG 21833, Kineosphaera limosa NBRC 100340, Singulisphaera acidiphila (strain ATCC BAA-1392/DSM 18658/VKM B-2454/MOB10), Halobacillus sp. BAB-2008, Bacillus subtilis (strain 168), Bacillus subtilis (strain 168), Priestia megaterium (strain ATCC 14581/DSM 32/CCUG 1817/JCM 2506/NBRC 15308/NCIMB 9376/NCTC 10342/NRRL B-14308/VKM B-512/Ford 19) (Bacillus megaterium), Erythrobacter litoralis (strain HTCC2594), Bacillus licheniformis (strain ATCC 14580/DSM 13/JCM 2505/CCUG 7422/NBRC 12200/NCIMB 9375/NCTC 10341/NRRL NRS-1264/Gibson 46), Bacillus cereus (strain ATCC 14579/DSM 31/CCUG 7414/JCM 2152/NBRC 15305/NCIMB 9373/NCTC 2599/NRRL B-3711), Bradyrhizobium diazoefficiens (strain JCM 10833/BCRC 13528/IAM 13628/NBRC 14792/USDA 110), Cystobacter fuscus DSM 2262, Cystobacter fuscus DSM 2262, Paenibacillus sp. JCM 10914, Alkalihalobacillus wakoensis JCM 9140, Kutzneria albida DSM 43870, Kutzneria sp. 744.

Eukaryotic host cells can include, for example, fungi, algal, plant, or mammalian cells. Fungal host cells include, for example, are fungi cells, including, but not limited to, fungi of the genera Aciculoconidium, Ambrosiozyma, Arthroascus, Arxiozyma, Ashbya, Aspergillus, Babjevia, Bensingtonia, Botryoascus, Botryozyma, Brettanomyces, Bullera, Bulleromyces, Candida, Chlamydomonas, Chrysosporium, Citeromyces, Clavispora, Cryptococcus, Cystofilobasidium, Debaryomyces, Dekkara, Dipodascopsis, Dipodascus, Eeniella, Endomycopsella, Eremascus, Eremothecium, Erythrobasidium, Fellomyces, Filobasidium, Fusarium, Galactomyces, Geotrichum, Guilliermondella, Hanseniaspora, Hansenula, Holtermannia, Hormoascus, Hyphopichia, Issatchenkia, Kloeckera, Kloeckeraspora, Kluyveromyces, Kondoa, Kuraishia, Kurtzmanomyces, Leucosporidium, Lipomyces, Lodderomyces, Malassezia, Metschnikowia, Mrakia, Myxozyma, Nadsonia, Nakazawaea, Nematospora, Neotyphodium, Neurospora, Ogataea, Oosporidium, Pachysolen, Penicillium, Phachytichospora, Phaffia, Pichia, Rhodosporidium, Rhodotorula, Saccharomyces, Saccharomycodes, Saccharomycopsis, Saitoella, Sakaguchia, Saturnospora, Schizoblastosporion, Schizosaccharomyces, Schwanniomyces, Sporidiobolus, Sporobolomyces, Sporopachydermia, Stephanoascus, Sterigmatomyces, Sterigmatosporidium, Symbiotaphrina, Sympodiomyces, Sympodiomycopsis, Torulaspora, Trichoderma, Trichosporiella, Trichosporon, Trigonopsis, Tsuchiyaea, Udeniomyces, Waltomyces, Wickerhamia, Wickerhamiella, Williopsis, Xanthophyllomyces, Yamadazyma, Yarrowia, Zygoascus, Zygosaccharomyces, Zygowilliopsis, and Zygozyma, among others. In some embodiments, the fungi is Candida albicans, Chrysosporium lucknowense, Fusarium graminearum, Fusarium venenatum, Hansenula polymorpha, Kluyveromyces lactis, Neurospora crassa, Pichia angusta, Pichia finlandica, Pichia kodamae, Pichia membranaefaciens, Pichia methanolica, Pichia opuntiae, Pichia pastoris, Pichia pijperi, Pichia quercuum, Pichia salictaria, Pichia thermotolerans, Pichia trehalophila, Pichia stipitis, Streptomyces ambofaciens, Streptomyces aureofaciens, Streptomyces aureus, Saccaromyces bayanus, Saccaromyces boulardi, Saccharomyces cerevisiae, Schizosaccharomyces pompe, Streptomyces fungicidicus, Streptomyces griseochromogenes, Streptomyces griseus, Streptomyces lividans, Streptomyces olivogriseus, Streptomyces rameus, Streptomyces tanashiensis, Streptomyces vinaceus, Trichoderma reesei and Xanthophyllomyces dendrorhous (formerly Phaffia rhodozyma), or a filamentous fungi, e.g. Trichoderma, Aspergillus sp., including Aspergillus nidulans, Aspergillus niger, Aspergillus oryzae, Aspergillus phoenicis, Aspergillus carbonarius, and the like.

The host cell can be an algae species and/or a photosynthetic, or non-photosynthetic, microorganism from Agmenellum, Amphora, Anabaena, Ankistrodesmus, Asterochloris, Asteromonas, Astephomene, Auxenochlorella, Basichlamys, Botryococcus, Botryokoryne, Boekelovia, Borodinella, Brachiomonas, Catena, Carteria, Chaetoceros, Chaetophora, Characiochloris, Characiosiphon, Chlainomonas, Chlamydomonas, Chlorella, Chlorochytrium, Chlorococcum, Chlorogonium, Chloromonas, Chrysosphaera, Closteriopsis, Cricosphaera, Cryptomonas, Cyclotella, Dictyochloropsis, Dunaliella, Ellipsoidon, Eremosphaera, Eudorina, Euglena, Fragilaria, Floydiella, Friedmania, Haematococcus, Hafniomonas, Heterochlorella, Gleocapsa, Gloeothamnion, Gonium, Halosarcinochlamys, Hymenomonas, Isochrysis, Koliella, Lepocinclis, Lobocharacium, Lobochlamys, Lobomonas, Lobosphaera, Lobosphaeropsis, Marvania, Monoraphidium, Myrmecia, Nannochloris, Nannochloropsis, Navicula, Nephrochloris, Nitschia, Nitzschia, Ochromonas, Oocystis, Oogamochlamys, Oscillatoria, Pabia, Pandorina, Parietochloris, Pascheria, Phacotus, Phagus, Phormidium, Platydorina, Platymonas, Pleodorina, Pleurochrysis, Polulichloris, Polytoma, Polytomella, Prasiola, Prasiolopsis, Prasiococcus, Prototheca, Pseudochlorella, Pseudocarteria, Pseudotrebouxia, Pteromonas, Pyrobotrys, Rosenvingiella, Scenedesmus, Schizotrichium, Spirogyra, Stephanosphaera, Tetrabaena, Tetraedron, Tetraselmis, Thraustochytrium, Trebouxia, Trochisciopsis, Ulkenia, Viridiella, Vitreochlamys, Volvox, Volvulina, Vulcanochloris, Watanabea, or Yamagishiella. The host cell can be Botryococcus braunii, Prototheca krugani, Prototheca moriformis, Prototheca portoricensis, Prototheca stagnora, Prototheca wickerhamii, Prototheca zopfii, or Schizotrichium sp. The host cell can be a fungi species from Aciculoconidium, Ambrosiozyma, Arthroascus, Arxiozyma, Ashbya, Aspergillus, Babjevia, Bensingtonia, Botryoascus, Botryozyma, Brettanomyces, Bullera, Bulleromyces, Candida, Chlamydomonas, Chrysosporium, Citeromyces, Clavispora, Cryptococcus, Cystofilobasidium, Debaryomyces, Dekkara, Dipodascopsis, Dipodascus, Eeniella, Endomycopsella, Eremascus, Eremothecium, Erythrobasidium, Fellomyces, Filobasidium, Fusarium, Galactomyces, Geotrichum, Guilliermondella, Hanseniaspora, Hansenula, Holtermannia, Hormoascus, Hyphopichia, Issatchenkia, Kloeckera, Kloeckeraspora, Kluyveromyces, Kondoa, Kuraishia, Kurtzmanomyces, Leucosporidium, Lipomyces, Lodderomyces, Malassezia, Metschnikowia, Mrakia, Myxozyma, Nadsonia, Nakazawaea, Nematospora, Neotyphodium, Neurospora, Ogataea, Oosporidium, Pachysolen, Penicillium, Phachytichospora, Phaffia, Pichia, Rhodosporidium, Rhodotorula, Saccharomyces, Saccharomycodes, Saccharomycopsis, Saitoella, Sakaguchia, Saturnospora, Schizoblastosporion, Schizosaccharomyces, Schwanniomyces, Sporidiobolus, Sporobolomyces, Sporopachydermia, Stephanoascus, Sterigmatomyces, Sterigmatosporidium, Symbiotaphrina, Sympodiomyces, Sympodiomycopsis, Torulaspora, Trichoderma, Trichosporiella, Trichosporon, Trigonopsis, Tsuchiyaea, Udeniomyces, Waltomyces, Wickerhamia, Wickerhamiella, Williopsis, Xanthophyllomyces, Yamadazyma, Yarrowia, Zygoascus, Zygosaccharomyces, Zygowilliopsis, and Zygozyma, among others. The fungi host cell can be Candida albicans, Chrysosporium lucknowense, Fusarium graminearum, Fusarium venenatum, Hansenula polymorpha, Kluyveromyces lactis, Neurospora crassa, Pichia angusta, Pichia finlandica, Pichia kodamae, Pichia membranaefaciens, Pichia methanolica, Pichia opuntiae, Pichia pastoris, Pichia pijperi, Pichia quercuum, Pichia salictaria, Pichia thermotolerans, Pichia trehalophila, Pichia stipitis, Streptomyces ambofaciens, Streptomyces aureofaciens, Streptomyces aureus, Saccaromyces bayanus, Saccaromyces boulardi, Saccharomyces cerevisiae, Schizosaccharomyces pompe, Streptomyces fungicidicus, Streptomyces griseochromogenes, Streptomyces griseus, Streptomyces lividans, Streptomyces olivogriseus, Streptomyces rameus, Streptomyces tanashiensis, Streptomyces vinaceus, Trichoderma reesei and Xanthophyllomyces dendrorhous (formerly Phaffia rhodozyma), or a filamentous fungi, e.g. Trichoderma, Aspergillus sp., including Aspergillus nidulans, Aspergillus niger, Aspergillus oryzae, Aspergillus phoenicis, Aspergillus carbonarius. The host cell can be a strain of the species Prototheca moriformis, Prototheca krugani, Prototheca stagnora or Prototheca zopfii and in other embodiment the cell has a 16S rRNA sequence with at least 70, 75, 80, 85, 90, 95 or 99% sequence identity (Ewing A, et al (2014). J. Phycol. 50:765-769).

Plant host cells include, for example, cells of monocotyledonous or dicotyledonous plants including, but not limited to, alfalfa, almonds, asparagus, avocado, banana, barley, bean, blackberry, brassicas, broccoli, cabbage, Cannabis, canola, carrot, cauliflower, celery, cherry, chicory, citrus, coffee, cotton, cucumber, Eucalyptus, hemp, lettuce, lentil, maize, mango, melon, oat, Papaya, pea, peanut, pineapple, plum, potato (including sweet potatoes), pumpkin, radish, rapeseed, raspberry, rice, rye, sorghum, soybean, spinach, strawberry, sugar beet, sugarcane, sunflower, tobacco, tomato, turnip, wheat, zucchini, and other fruiting vegetables (e.g. tomatoes, pepper, chili, eggplant, cucumber, squash etc.), other bulb vegetables (e.g., garlic, onion, leek etc.), other pome fruit (e.g. apples, pears etc.), other stone fruit (e.g., peach, nectarine, apricot, pears, plums etc.), Arabidopsis species, woody plants such as coniferous and deciduous trees, an ornamental plant, a perennial grass, a forage crop, flowers, other vegetables, other fruits, other agricultural crops, herbs, grass, or perennial plant parts (e.g., bulbs; tubers; roots; crowns; stems; stolons; tillers; shoots; cuttings, including un-rooted cuttings, rooted cuttings, and callus cuttings or callus-generated plantlets; apical meristems etc.) The term “plants” refers to all physical parts of a plant, including seeds, seedlings, saplings, roots, tubers, stems, stalks, foliage and fruits. Plant host cells can phytoremediate petroleum, including, for example, Agropyron cristatum, Astragalus adsurgens, biochar, Caragana korshinskii, Echinacea purpurea, Epipremnum aureum, Fawn (Festuca arundinacea Schreb), Festuca ovina, Fire Phoenix (a combined F. arundinacea), Gaillardia aristata, Imperata cylindrica, Leguminous plant Acacia seiberiana Tausch, Lolium perenne, mycorrhizae, Mucuna bracteate, Medicago sativa, Pteris vittata, and Purple Nutsedge.

### Introduction of Polynucleotides to Host Cells

Polynucleotides for expression of the recombinant defluorinating enzyme may be introduced into cells by various methods known in the art. Techniques include among others, electroporation, biolistic particle bombardment, liposome mediated transfection, calcium chloride transfection, microinjection, recombinant viral transfection, and protoplast fusion. The introduced nucleic acids may be integrated into chromosomal DNA or maintained as extrachromosomal replicating sequences. General transformation techniques are known in the art (see, e.g., Current Protocols in Molecular Biology, F. M. Ausubel et al. eds, Chapter 9 (1987); Sambrook et al., Molecular Cloning: A Laboratory Manual, 3rd Ed., Cold Spring Harbor Laboratory Press, N.Y. (2001); and Campbell et al., Curr Genet. 16:53-56, 1989; each publication incorporated herein by reference).

Polynucleotides for expression of the recombinant defluorinating enzyme may be introduced into host cells by transfection (e.g., Gorman, et al. Proc. Natl. Acad. Sci. 79.22 (1982): 6777-6781, which is incorporated by reference in its entirety for all purposes), transduction (e.g., Cepko and Pear (2001) Current Protocols in Molecular Biology unit 9.9; DOI: 10.1002/0471142727.mb0909s36, which is incorporated by reference in its entirety for all purposes), calcium phosphate transformation (e.g., Kingston, Chen and Okayama (2001) Current Protocols in Molecular Biology Appendix 1C; DOI: 10.1002/0471142301.nsa01cs01, which is incorporated by reference in its entirety for all purposes), calcium chloride and polyethylene glycol (PEG) to introduce recombinant DNA into microalgal cells (see Kim et al., (2002) Mar. Biotechnol. 4:63-73, which reports the use of this method to transform Chlorella ellipsoidea protoplasts, and which is incorporated by reference in its entirety for all purposes), cell-penetrating peptides (e.g., Copolovici, Langel, Eriste, and Langel (2014) ACS Nano 2014 8 (3), 1972-1994; DOI: 10.1021/nn4057269, which is incorporated by reference in its entirety for all purposes), electroporation (e.g Potter (2001) Current Protocols in Molecular Biology unit 10.15; DOI: 10.1002/0471142735.im1015s03 and Kim et al (2014) Genome 1012-19. doi: 10.1101/gr.171322.113, Kim et al. 2014 describe the Amaza Nucleofector, an optimized electroporation system, both of these references are incorporated by reference in their entirety for all purposes), microinjection (e.g., McNeil (2001) Current Protocols in Cell Biology unit 20.1; DOI: 10.1002/0471143030.cb2001s18, which is incorporated by reference in its entirety for all purposes), liposome or cell fusion (e.g., Hawley-Nelson and Ciccarone (2001) Current Protocols in Neuroscience Appendix IF; DOI: 10.1002/0471142301.nsa01fs10, which is incorporated by reference in its entirety for all purposes), mechanical manipulation (e.g. Sharon et al. (2013) PNAS 2013 110 (6); DOI: 10.1073/pnas. 1218705110, which is incorporated by reference in its entirety for all purposes), biolistic methods (see, for example, Sanford, Trends in Biotech. (1988) 6:299 302, U.S. Pat. No. 4,945,050, which is incorporated by reference in its entirety for all purposes), Lithium Acetate/PEG transformation (Gietz and Woods (2006) Methods Mol. Biol. 313, 107-120) and its modifications, which is incorporated by reference in its entirety for all purposes, or other well-known techniques for delivery of nucleic acids to host cells. Once introduced, the nucleic acids can be expressed episomally, or can be integrated into the genome of the host cell using well known techniques such as recombination (e.g., Lisby and Rothstein (2015) Cold Spring Harb Perspect Biol. March 2; 7 (3). pii: a016535. doi: 10.1101/cshperspect.a016535, which is incorporated by reference in its entirety for all purposes), non-homologous integration (e.g., Deyle and Russell (2009) Curr Opin Mol Ther. 2009 August; 11 (4): 442-7, which is incorporated by reference in its entirety for all purposes) or transposition (as described above for mobile genetic elements). The efficiency of homologous and non-homologous recombination can be facilitated by genome editing technologies that introduce targeted single or double-stranded breaks (DSB). Examples of DSB-generating technologies are CRISPR/Cas9, TALEN, Zinc-Finger Nuclease, or equivalent systems (e.g., Cong et al. Science 339.6121 (2013): 819-823, Li et al. Nucl. Acids Res (2011): gkr188, Gaj et al. Trends in Biotechnology 31.7 (2013): 397-405, all of which are incorporated by reference in their entirety for all purposes), transposons such as Sleeping Beauty (e.g., Singh et al (2014) Immunol Rev. 2014 January; 257 (1): 181-90. doi: 10.1111/imr.12137, which is incorporated by reference in its entirety for all purposes), targeted recombination using, for example, FLP recombinase (e.g., O'Gorman, Fox and Wahl Science (1991) 15: 251 (4999): 1351-1355, which is incorporated by reference in its entirety for all purposes), CRE-LOX (e.g., Sauer and Henderson PNAS (1988): 85; 5166-5170), or equivalent systems, or other techniques known in the art for integrating the nucleic acids of the invention into the eukaryotic cell genome.

Chemical means for introducing a polynucleotide into a host cell include colloidal dispersion systems, such as macromolecule complexes, nanocapsules, microspheres, beads, and lipid-based systems including oil-in-water emulsions, micelles, mixed micelles, and liposomes. An exemplary colloidal system for use as a delivery vehicle in vitro and in vivo is a liposome (e.g., an artificial membrane vesicle). Other methods of state-of-the-art targeted delivery of nucleic acids are available, such as delivery of polynucleotides with targeted nanoparticles or other suitable sub-micron sized delivery system.

Techniques for transforming a wide variety of higher plant species are well known and described in the technical and scientific literature. See, e.g., Weising (1988) Ann. Rev. Genet. 22:421-477; U.S. Pat. No. 5,750,870, which are both incorporated by reference in their entirety for all purposes.

### Transfer of Nucleic Acids

Transmission of genes between bacteria can occur through transformation, transduction, or conjugation. Conjugation efficiency is most commonly quantified by the ratio of the number of transconjugants (i.e., recipient cells that have received a plasmid from a donor cell) to the number of donors or recipients at the beginning of conjugation. This is the conjugation frequency, and is also known as the conjugation rate. The conjugation frequency is affected by various biotic and abiotic factors including, for example, such as growth phase, cell density, donor-to-recipient ratio, carbon and metal concentrations, temperature, pH, and mating time.

ssDNA transfer by conjugation is ubiquitous in the bacterial and archaebacterial world and relies on a dedicated cell envelope spanning DNA transfer machinery ancestral to T4SS (type IV secretion systems) which translocate virulence determining effector proteins into target cells. Approximately 10-20 proteins (fewer in Gram positive bacteria) constitute the building blocks of the T4SS dedicated to ssDNA and protein transfer. The T4S machinery and additional proteins required for DNA transfer and replication are encoded by conjugative plasmids or integrative conjugative elements.

Plasmids carrying genes that code for all the machinery needed to form a mating pair and transfer the plasmid to the recipient are called self-transmissible plasmids, whereas plasmids that require the help of transfer machinery encoded on other plasmids in the donor bacterium to achieve this are called mobilizable plasmids. Conjugative plasmids include or can be derived from, for example, F-plasmids, other Gram Negative conjugative plasmids, broad host range plasmids RP4 and R388, pKM101, pAMB1, pAT191, pAM714, pAM771, pCAL1, pCAL2, pCF10, Tn1545, Tn916, pYD1, ROR-1, pIP72, pOX38, RIP1a, R1, R1drd19, pCVM29188_146, TP123, R64, pHUSEC41-1, pES1, TP114, pIP6, RP1/RP4, pRK24, RK2, R388, R6K, R100, R6-5, ColB2-K77.

Conjugative plasmids belong to 23 different incompatibility groups: B, C, D, E, FI, FII, FIII, FIV, H, Ia, 12, Ic, Id, If, J, K, M, N, P, T, V, Wand X. Alternatively, conjugative plasmids can be grouped into compatibility groups using Inc/rep typing. In 2018, there were 28 Inc types in Enterobacteriaceae, 14 in Pseudomonas and approximately 18 in Staphylococcus. Still further, conjugative plasmids can be grouped using PCR based typing where different regions (e.g., rep genes, iterons, RNAI) are used. Conjugative plasmids within a group can stably coexist in the same host cell.

Conjugative plasmids grouped by Inc type show that several groups are promiscuous and have broad host ranges. IncA/C is a group conjugative, self-transferable plasmids with a size range of 40-230 kb. IncA/C conjugative plasmids have a broad host range which include members of Beta-, Gamma-, and Deltaproteobacteria classes. IncN (e.g., pCU1), IncP (e.g., RK2), and IncW group conjugative plasmids also have a broad host range including, for example, Beta-, Gamma-, Deltaproteobacteria, and Bacteroidetes classes. IncQ, IncU and PromA conjugative plasmids also have a broad host range including, for example, at least Alpha-, Beta-, and Gammaproteobacteria classes. In phylogeny, class is above order, which is above family, which is above genus, which is above specie. The conjugative plasmids from the broad host range Inc groups are compatible with many, many bacterial host cells. For example, IncP- and IncPromA-conjugative plasmids can transfer to a broad range of soil bacteria including recipients from eleven (11) different bacterial phyla.

Agrobacterium can be used to transfer genetic material from suitable vectors into recipient plant cells. Zhang et al, A highly efficient Agrobacterium-mediated method for transient gene expression and functional studies in multiple plant species, Plant Commun. 1:1000028 (2020) doi.org/10.1016/j.xpic.2020.1000028; Gelvin, Agrobacterium-mediated plant transformation: the biology behind the gene-jockeying tool, Microbiol. Mol. Biol. Rev. 67:16-37 (2003), each of which is incorporated by reference in its entirety for all purposes. The T-DNA region in Ti plasmids can be transferred from Agrobacterium into recipient, host plant cells. Agrobacterium can transfer DNA to a remarkably broad group of organisms including numerous dicot, monocot angiosperm species, gymnosperms, fungi, including yeasts, ascomycetes, and basidiomycetes.

Superspreader mutations, that dramatically enhanced the conjugation efficiency of conjugative plasmids belonging to diverse incompatibility groups. The first superspreader mutation was characterized in the F plasmid, which carries an IS3 insertion sequence into the finO gene. FinO inactivation destabilizes the FinP-traJ mRNA duplex, thus resulting in the upregulation of traJ and the constitutive expression of tra genes. This naturally occurring mutation accounts for the enhanced transfer efficiency of the F plasmid compared with the related IncF plasmids R100, R6-5, and R1, in which the FinOP regulatory system is still active. More recently, genetically induced superspreader mutations of several resistance plasmids have been isolated in laboratory settings. In the Incl plasmid pESBL, which is associated with extended-spectrum β-lactamase production in Enterobacteria, inactivation of the Hft locus triggered the overexpression of conjugative pili and 20-fold enhancement of the transfer efficiency. In the Citrobacter freundii IncM group plasmid pCTX-M3 that carries the blaCTX-M-3 gene, the deletion of two genes (orf35 and orf36) resulted in the enhanced expression of tra genes and increased plasmid transfer. Another example was reported in the Gram-positive broad host range (Inc18) plasmid pIP501, which is involved in the propagation of vancomycin resistance from Enterococci to methicillin-resistant strains of Staphylococcus aureus. In this case, the deletion of the traN gene encoding the small cytosolic protein TraN (unrelated to the F TraN protein) resulted in the upregulation of transfer factors and the enhancement of the transfer efficiency. Insertion of the Tn1999 transposon into the tir (transfer inhibition of RP4) gene of the IncL/M-type plasmid pOXA-48a, responsible for the dissemination of specific extended-spectrum β-lactamase genes in Enterobacteriaceae, increases the transfer efficiency by 50-100-fold without affecting traM expression levels.

Conjugation requires that a donor call meet a recipient cell, form a conjugative pilus, and attach to the surface of the recipient cell. The probability of mating-pair formation is influenced by the density of donors and recipients, their motility, and the structure of the environment (i.e., liquid versus solid, or structure of the filter). Once a mating pair has been successfully formed, a copy of the plasmid has to be transferred to the recipient, and the pilus should remain intact until this process is finished. Once inside the recipient, the plasmid should escape degradation by restriction endonucleases of the recipient which recognize restriction sites on the plasmid, and host factors should be able to ensure plasmid replication and equal distribution of the plasmid copies among the two daughter cells during cell division.

The conjugation efficiency can also be affected by plasmids that are already present in the recipient bacterium. They can stabilize mating pairs and increase the conjugation efficiency, or decrease mating-pair formation and make it more difficult for other related plasmids to enter the recipient. Plasmids in the recipient can inhibit stable maintenance of other plasmids if they use the same replication-control mechanism. Based on the different replication-control mechanisms, 28 different incompatibility (Inc) groups are recognized for plasmids in Enterobacteriaceae. (Rozwandowicz et al., J. Antimicrob. Chemother, 73:1121-37 (2018), which is incorporated by reference in its entirety for all purposes) The presence of genes coding for replication-control mechanisms correlates with the presence of genes needed for conjugation, and therefore may correlate with differences in conjugation efficiency.

Decreasing taxonomic relatedness between donor and recipient bacteria is associated with a lower conjugation frequency in liquid matings, but not in substrate matings. In a substrate mating, the donor and recipient cells are fixed in space such that conjugation is limited to neighboring cells. Under these conditions, mating-pair formation does not play an important role in limiting conjugation, because conjugation to related recipients will be efficient at first and will then saturate when all neighboring recipients have received the plasmid. Conjugation to less-related recipients might be less efficient, but because the bacteria are more fixed in space, conjugation will continue for a longer time, and cease when all neighboring recipients have received the plasmid. Competition for mating-pair formation can be less important in a substrate because the mating pairs are fixed in space. As a result, the difference in conjugation frequency to more-related versus less-related recipients will decrease over time, and at later time points relatedness does not to influence the conjugation frequency.

Substrates that can increase conjugation to less related recipient cells include, for example, biofilms, soil, the gut of an animal, and other environments were the host and recipient cells are fixed in space so that conjugation can occur between neighboring cells.

Transduction is a common tool used to stably introduce a foreign gene into a host cell's genome. Transduction vectors, methods of producing transducing particles, and methods for transducing host cells are known in the art. Broad host range, transducing phage include, for example, SN-T, STP4-a, vB_SPUM_SP116, SH6, SH7, SaFB14, KFS-SE1, fmb-p1, SS3e, ZCSE2, myPSH2311, ST32, vB_ValP_IME271, JHP, vB_PcaM_CBB.

Diverse soils including clay soil, forest soil, desert soil, or fertile mollisol have bacteria in the range of 10⁴ to 10⁹ cells per gram. Phage have been found in soil in the range of 0 to 10⁷ plaque forming unites per gram. In aquatic systems including freshwater lakes, streams, marine waters, and river mud bacterial counts were in the range of 10³ to 10⁹ bacteria per milliliter. Phage have been found in high concentrations in aquatic environments ranging from 10³ to 10⁸ plaque forming units per milliliter. Thus, transduction of genetic material is a common feature in soil and aquatic communities of bacteria.

In natural transformation, competent cells take up DNA and incorporate it into their genome. Naturally transformable bacteria develop competence and take up DNA under in situ conditions. And DNA has been shown to persist in the environment and to be available for uptake by competent cells. Many species of naturally competent bacteria have been identified in soil and aquatic sediments.

### Methods for Using the Defluorinating Enzymes

The recombinant defluorinating enzymes disclosed herein can be used to remove fluorine from fluoroalkyl and polyfluoroalkyl compounds. The disclosed defluorinating enzymes may remove fluorine via a glutathione-dependent mechanism involving nucleophilic attack on the β-carbon atom and formation of fluoride and S-(carboxymethyl) glutathione, with subsequent cleavage of the latter into amino acids and an S-(carboxymethyl) conjugate complex excreted in the urine (Mead et al., Metabolism and defluorination of fluoroacetate in the brush-tailed possum, Aust. J. Biol. Sci. 32:15-26 (1979); Tecle and Casida, Enzymatic defluorination and metabolism of fluoroacetate, fluoroacetamide, fluoroethanol, and (−)-erythro-fluoroacetate in rats and mice examined by 19F and 13C NMR, Chem. Res. Toxicol. 2:429-435 (1989), each of which is incorporated by reference in its entirety for all purposes).

Defluorination is mainly carried out by anionic proteins having glutathione transferase activity, though the anionic fraction contains nearly 10% of proteins without this activity but also capable of defluorination of FA. Moreover, cationic enzymes were shown to be responsible for about 20% of cytosolic defluorination of FA (Wang et al., Purification and identification of rat hepatic cytosolic enzymes responsible for defluorination of methoxyflurane and fluoroacetate, Drug Metab. Dispos. 14:392-398 (1986), which is incorporated by reference in its entirety for all purposes). The GHS-dependent enzyme defluorinating FA is not identical to GHS-dependent S-transferases; it is an FA-specific defluorinase with an acidic isoelectric point (pH=6.4) and a molecular weight of 41 kDa (27 kDa for the main subunit) (Soiefer and Kostyniak, The role of fluoroacetate-specific dehalogenase and glutathione transferase in the metabolism of 2,4-dinitrofluorobenzene, Toxicol. Lett. 22:217-222 (1984), which is incorporated by reference in its entirety for all purposes).

When used in bioremediation, the recombinant defluorinating enzymes disclosed herein can be engineered into a suitable host cell. A suitable host cell for aerobic bioremediation can include, for example, Delftia acidovorans, Bacillus subtilis, Pseudomonas putida, Moraxella, several Pseudomonad species, ACidimicrobium, Rhodococcus jostii, Arthrobacter, E. coli, and/or Bacillus megaterium. These engineered host cells can be used to directly bioremediate fluoroalkyl and/or polyfluoroalkyl compounds, and/or the engineered host cell can be used to transfer the nucleic acids encoding the defluorinating enzyme to indigenous organisms (e.g., soil bacteria or plants).

Two approaches to remediating fluoroalkyl compounds (e.g., polyfluoroalkyl compounds) using indigenous bacterial populations with engineered defluorinating enzymes and catabolic genes of interest are (1) through controlled mating (in vitro) and re-release or (2) direct application of engineered host cells with the defluorinating enzyme, and optionally other catabolic genes of interest for in situ transfer of nucleic acids encoding the defluorinating enzyme and optionally nucleic acids encoding other catabolic genes.

In another aspect, the defluorinating enzyme described herein can be used in a process or method for remediating PFAs. Generally, the method comprises contacting or incubating PFAs, with a defluorinating enzymes. The reaction can occur in vitro, for example, in cell free systems, or in vivo, for example where the process uses a host cell, such as a microbial organism, expressing a defluorinating enzyme.

In another aspect, the defluorinating enzymes described herein can be used in a process or method for remediating PCBs. Generally, the method comprises contacting or incubating PCBs, with a defluorinating enzymes in combination with laccases, peroxidases, and/or cytochrome P450 monooxygenase. The reaction can occur in vitro, for example, in cell free systems, or in vivo, for example where the process uses a host cell, such as a microbial organism, expressing a defluorinating enzyme.

In an aspect, the defluorinating enzymes described herein can be used to treat water to remove fluoroalkyl compounds. Suitable host cells for water treatment under aerobic conditions include, for example, Bacillus subtilis, Pseudomonas putida, Moraxella, several Pseudomonad species, ACidimicrobium, Rhodococcus jostii, Arthrobacter, Tetrasphaera, Trichococcus, Candidatus microthrix, Rhodoferax, Rhodobacter, and/or Hyphomicrobium.

In another aspect, the defluorinating enzymes described herein can be attached or associated with a substrate (e.g., a filter) for treating fluids (e.g., water). In this aspect the defluorinating enzyme may be attached to the substrate with a spacer or tether of desired length. Such tethers or spacers are well known in the art and can, for example, be 1-10 carbons in length (e.g., ethyl, propyl, butyl, etc.).

In an aspect, the defluorinating enzymes described herein can be used to treat biosolids to remove fluoroalkyl compounds. Suitable host cells for biosolid treatment under anaerobic conditions include, for example, Acetivibrio, Clostridium, Bacteroides, Ruminococcus, Thermotoga; Bifidobacterium (in the phylum Actinobacteria), Lactobacillus, Anaerolineaceae; Smithllela, Syntrophobacter, and Pelotomaculum; Syntrophus and Syntrophomonas; methanoculleus, Methanobacterium, Methanobrevibacter, Methanospirillum, and Methanothermobacter; Clostridium bornimense, Herbinix hemicellulosilytica, Herbinix luporum, Herbivorax saccincola, Proteiniphilum saccharofermentans, Petrimonas mucosa, Fermentimonas caenicola, and Proteiniborus indolifex.

In an aspect, the defluorinating enzymes described herein can be used to treat biosolids to remove fluoroalkyl compounds. Suitable host cells for biosolid treatment under aerobic conditions include, for example, Delftia acidovorans, Bacillus subtilis, Pseudomonas putida, Moraxella, several Pseudomonad species, ACidimicrobium, Rhodococcus jostii, Arthrobacter, E. coli, and Bacillus megaterium.

In an aspect, the defluorinating enzymes described herein can be used to treat landfill leachate to remove fluoroalkyl compounds. Suitable host cells for landfill leachate treatment include, for example, Delftia acidovorans, Bacillus subtilis, Pseudomonas putida, Moraxella, several Pseudomonad species, ACidimicrobium, Rhodococcus jostii, Arthrobacter, E. coli, and/or Bacillus megaterium. If the landfill leachate is treated under anaerobic conditions, a suitable host cell includes, for example, Geobacter.

Other host cells that can be engineered with nucleic acids encoding the defluorinating enzymes include, for example, Acidimicrobium, Arthrobacter, Bacillus megaterium, Bacillus subtilis, Candidatus microthrix, Delftia acidovorans, E. coli, Hyphomicrobium, Moraxella, Pseudomonas putida, several Pseudomonad species, Rhodococcus jostii, Rhodoferax, Rhodobacter, Tetrasphaera, and/or Trichococcus. Other host cells include, for example, Acetivibrio, Achromobacter, Alcaligenes, Anaerolineaceae, Bacteroides, Bacillus subtilis, Bacteroides, Bifidobacterium (in the phylum Actinobacteria), Clostridium, Clostridium bornimense, Dehalobacter, Dehalococcoides, Desulfobacteraceae, Fermentimonas caenicola, Geobacter, Herbinix hemicellulosilytica, Herbinix luporum, Herbivorax saccincola, Lactobacillus, Methanobacterium, Methanobrevibacter, Methanoculleus, Methanospirillum, Methanothermobacter, Pelotomaculum, Petrimonas mucosa, Proteiniborus indolifex, Proteiniphilum saccharofermentans, Rhodopseudomonas palustris, Ruminococcus, Smithllela, Staphylococcus aureus, Streptococcus, Syntrophobacter, Syntrophus and Syntrophomonas, and/or Thermotoga.

Anaerobic host cells that can also be engineered with nucleic acids encoding the defluorinating enzymes disclosed herein include, for example, Desulfobacteraceae, Geobacter, Clostridium, Dehalobacter, Dehalococcoides, Alcaligenes, Achromobacter, Bacillus subtilis (aerobic/anaerobic), Rhodopseudomonas palustris, Streptococcus, Staphylococcus aureus, Lactobacillus, and/or Bacteroides.

In carrying out the defluorinating enzyme mediated methods described herein, the engineered polypeptide may be added to the reaction mixture in the form of a purified enzyme, whole cells transformed with gene(s) encoding the enzyme, and/or as cell extracts and/or lysates of such cells. Host cells transformed with gene(s) encoding a defluorinating enzyme or cell extracts, lysates thereof, and isolated enzymes may be employed in a variety of different forms, including solid (e.g., lyophilized, spray-dried, and the like) or semisolid (e.g., a crude paste). The cell extracts or cell lysates may be partially purified by precipitation (ammonium sulfate, polyethyleneimine, heat treatment or the like, followed by a desalting procedure prior to lyophilization (e.g., ultrafiltration, dialysis, and the like). Any of the cell preparations may be stabilized by crosslinking using known crosslinking agents, such as, for example, glutaraldehyde or immobilization to a solid phase.

The gene(s) encoding the defluorinating enzyme can be transformed into host cell separately or together into the same host cell. For example, one set of host cells can be transformed with gene(s) encoding one defluorinating enzyme and another set can be transformed with gene(s) encoding another defluorinating enzyme. Both sets of transformed cells can be utilized together in the reaction mixture in the form of whole cells, or in the form of lysates or extracts derived therefrom. A host cell can be transformed with gene(s) encoding multiple different defluorinating enzymes. The engineered polypeptides can be expressed in the form of secreted polypeptides and the culture medium containing the secreted polypeptides can be used for the reaction.

Various ranges of suitable reaction conditions can be used in the methods, including but are not limited to, substrate loading, pH, temperature, buffer, solvent system, polypeptide loading, and reaction time. Further suitable reaction conditions for reacting substrate compound to product compound using a defluorinating enzyme can be readily optimized in view of the guidance provided herein and by routine experimentation that includes, but is not limited to, contacting the defluorinating enzyme and substrate compound under experimental reaction conditions of concentration, pH, temperature, and solvent conditions, and detecting the product compound. Substrate compound in the reaction mixtures can be varied, taking into consideration, for example, the desired amount of product compound, the effect of substrate concentration on enzyme activity, stability of enzyme under reaction conditions, and the percent conversion of substrate to product.

Suitable assays to detect products from the defluorinating enzyme can be performed using well known methods. Product synthesis can be analyzed by methods such as GC-MS (Gas Chromatography-Mass Spectroscopy) and LC-MS (Liquid Chromatography-Mass Spectroscopy) or other suitable analytical methods using routine procedures well known in the art.

Where whole cells can used in a method for remediating PFAs, PCBs, halogenated compounds, or other fluoroalkyl compounds, samples from cultures grown for each engineered strain to be tested can be examined for degradation of the target molecule as well as various intermediates in the degradation pathway.

The defluorinating enzymes, cells with nucleic acids encoding the same, and methods using the foregoing can be useful for remediating sites contaminated with polyfluoro- and perfluoroalkylcarboxylic acids (PFCA), such as PFOA, and including ionized forms thereof, and polyfluoro- and perfluoroalkylsulfonic acids (PFSA), such as PFOS, and including ionized forms thereof. In complex environmental contamination sites, certain contaminants are not sufficiently susceptible to in vitro chemical degradative process, and/or chemical absorption processes. Cells with conjugative vectors encoding the defluorinating enzymes disclosed herein can remediate fluoroalkyl compounds in these complex environments by transferring nucleic acids encoding the defluorinating enzymes to micoroorganims that are native to the complex environmental contamination site.

Remediation of waste water can be performed with a reactor having a plurality of remediation stages therein, said stages separated by a perforated separator, said reactor having a bottom separator; said reactor having a plurality of porous packing substrates located in said remediation stages and said substrates having one or more microorganisms (engineered with defluorinating enzymes) attached thereto; at least one perforated chimney pipe located within said reactor; said reactor having an open bottom area located below said bottom separator; and said reactor having no air or oxygen, or both, inlet pipe, said stage reactor having one or more supports; and said reactor capable of being located in a waste water aeration treatment tank containing aerators and waste water therein.

Another embodiment for the remediation of waste water can be a remediation tube reactor having one or more side wall perforated remediation tubes therein, at least one of said perforated remediation tubes, independently, having therein one or more different types of packing substrates, said packing substrates being porous and having micro-pores therein; said bio-remediation tube having a non-tube reactor area, wherein said non-tube reactor area has no packing substrates therein; said tube reactor having multiple types of different microorganisms therein that are attached to said packing substrates; said tube reactor having a bottom separator for maintaining said packing substrates in said reactor; said tube reactor having no chimney pipe; said tube reactor having an open bottom area located below said reactor bottom separator, said reactor having no air or oxygen, or both, inlet pipe, said reactor having one or more supports; and at least one or more of said tube reactors capable of being located in a waste water aeration treatment tank containing waste water therein.

Microorganisms that are utilized in the remediation of the above wastes generally work through several different mechanisms such as eradication, formation of complexes, splitting of molecules, formation of new compounds such as carbon dioxide, water, sulfur dioxide, nitrites, nitrates, and nitrogen and the like. As noted above, preferably numerous and different types of microorganisms are utilized in the reactor so that a highly diverse microbial population exists to effectively treat most, and even all of the various types of the waste components found in the aqueous waste composition. Desirably, microorganisms are utilized that are found in nature such as in the soil, trees, ponds, lakes, streams, rivers, grains, plants, mold, spores, fungi, and the like. Microorganisms are generally defined as being cellular and being able to replicate without a host cell. One desired source of microorganisms are the various bacteria that are known to remediate various waste compositions. The different types of bacteria are numerous and known to the art and to the literature and thus include bacteria to biodegrade carbonaceous compounds such as pseudomonas species such as Pseudomonas vesicularis, Pseudomonas putida and Aeromonas hydrophila, Brevibacterium acetylicum, bacteria to biodegrade nitrogen-containing compounds such as Nitrobacter species such as Nitrobacter winogradskyi and Nitrosomonas species such as Nitrosomonas europaea and bacteria to biodegrade sulfur-containing compounds such as Thiobacillus species such as Thiobacillus denitrificans and the like. Other microorganisms include various fungi such as those that naturally exist in mushrooms, yeasts, and molds. Generally, they lack chlorophyll, have a cell wall composed of polysaccarides, sometimes polypeptides, and chitin, and reproduce either sexually or asexually. Protozoa are simple microorganisms consisting of unicellular organisms that range in size from sub-microscopic to macroscopic. Types of protozoa include sarcomastigophora, labyrinthomorpha, apicomplexa, microspora, acetospora, myxozoa, and ciliophora. Preferably at least two or three, and even four or more different types of microorganism exist within the same remediation stage of the apparatus of the present invention inasmuch as the same has been found to destroy, eradicate, eliminate, react with, the various carbonaceous compounds, various nitrogen containing compounds, various sulfur containing compounds, various toxic compounds, and the like. Some or all of these microorganism can be engineered with nucleic acids encoding the recombinant defluorinating enzymes described herein so that the microorganism makes and utilizes the defluorinating enzyme(s).

These various microorganisms can be attached, contained, captured, bound, etc., by various substrates. The packing substrates can have various desirable attributes. For example, the packing substrate can have a high average surface area such as from at least about 100 square meters per cubic meter (M2/M3) or at least about 500 M2/M3 to about 1,000 M2/M3 and even 200,000 M2/M3 where M2 is the surface area and M3 is the volume. The packing substrates can have a surface area of about 500 M2/M3 or 800 M2/M3 to about 10,000 M2/M3. One or more of the remediation stages can contain two or three, or even four or more different types of packing substrates therein.

Multiple and generally numerous different types of porous substrates can be utilized within a single reactor. Substrates can include, for example, minerals, carbon substrates, ceramic, metal substrates, polymers or plastics, and the like. Examples of various minerals include clay, diatomaceous earth, fuller's earth, titanium dioxide, zirconium dioxide, chromium oxide, zinc oxide, magnesia, boria, boron nitride, pumice, lava, including crushed lava, ceiite, slag, and the like. Examples of carbon substrates include charcoal, coal, pyrolized wood or wood chips, activated carbon and the like. Ceramics can be silicates, alumina, muilite, and include brick, tile, terra cotta, porcelain, glasses of all types such as sodium glass and boron glass, porcelain enamels, refractories such as alumina, silicone carbide, boron carbide, and the like. Metal substrates can be iron, nickel, cobalt, zinc, aluminum, and the like.

Another attribute of the packing materials can be that the substrate be porous and have a large number of pores therein. The average size of the pores can be small but sufficiently large enough to house one or more microorganisms including a colony of various microorganisms. The average pore size can vary over a wide range such as from at least about 1 micron to about 150 microns, or up to about 250 microns, and even up to about 500 microns. The pore sizes can range from about 4, or about 20, or about 30, or about 50 microns to about 75 microns or about 100 microns. The pores can exist not only on the surface of the substrate, but also in the interior thereof and entirely therethrough such that the substrate often has an “open pore structure.”

The defluorinating enzymes, cells with nucleic acids encoding the same, and methods using the foregoing can be used with filter beds. A filter bed may be installed in a down-flow microbial remediation reactor, to filter solids from the process liquid flowing out as reactor effluent. This way, the mixed liquor, including the biomass, remains in the reactor for continued residence time rather than flowing out of the vessel. Thus, the remediation of the waste and contaminants in the mixed liquor continues, and only relatively clean, low BOD (biological oxygen demand) liquid flows out of the reactor. Proper filtration and control of reactor effluent are factors in maintaining the proper concentration of microbes and nutrients in the mixed liquor, which is crucial for effective remediation.

In many remediation reactors, the chosen filter bed is very coarse sand or sized like small pebbles, and so may be referred to hereafter as the “sand bed” or “sand filter.” The filter bed particulate can have a coarseness/size and shape that provide many voids between the particles for receiving and physically trapping solids from the reactor.

Various features and embodiments of the disclosure are illustrated in the following representative examples, which are intended to be illustrative, and not limiting. However, one skilled in the art will readily appreciate that the specific methods and results discussed are merely illustrative of the inventions as described more fully in the claims which follow thereafter. Unless otherwise indicated, the disclosure is not limited to specific procedures, materials, or the like, as such may vary. It is also to be understood that the terminology used herein is for the purpose of describing particular embodiments only and is not intended to be limiting.

### EXAMPLES

### Example 1: Novel Defluorinating Enzymes

Candidate enzymes were placed into pSF-OXB15, these vectors were engineered into E. coli, and soluble protein lysates with the candidate enzymes were made using the BugBuster extraction reagent, such as that sold by Sigma-Aldrich. These protein lysates were then tested for fluoride release when provided with fluoroacetate, or trifluoroacetate, or pentafluoroacetate, or pentafluoropropionic acid, or perfluorooctanoic acid. The results from these assays are shown below:

TABLE 1
Fluoride Release

| | | | Pentafluoro- | Perfluoro- |
|---|---|---|---|---|
| Enzyme | Fluoro-acetate | Trifluoro-acetate | propionic acid | octanoic acid |
| BDF1 | 100% (38 mg/L) | 2.32% (1.16 mg/L) | 1.52% (0.88 mg/L) | 2.61% (1.08 mg/L) |
| | in 0.54 days | in 6 days | in 6 days | in 6 days |
| BDF2 | 79.99% (30.39 mg/L) | ND | ND | 6.69% (2.77 mg/L) |
| | in 9 days | | | in 9 days |
| BDF3 | 22.26% (11.79 mg/L) | ND | ND | 5.38% (4.72 mg/L) |
| | in 22 days | | | in 22 days |
| BDF4 | 51.68% (19.64 mg/L) | ND | ND | 2.73% (2.26 mg/L) |
| | in 14 days | | | in 8 days) |
| BDF5 | 62.68% (23.82 mg/L) | ND | ND | 2.61% (2.16 mg/L) |
| | in 14 days | | | in 8 days) |
| BDF6 | 52.94% (20.12 mg/L) | ND | ND | 2.12% (1.76 mg/L) |
| | in 14 days | | | in 8 days) |
| BDF7 | 50.10% (19.04 mg/L) | ND | ND | 2.20% (1.82 mg/L) |
| | in 14 days | | | in 8 days) |
| BDF8 | 53.31% (20.26 mg/L) | ND | ND | 3.00% (2.48 mg/L) |
| | in 14 days | | | in 8 days) |
| BDF9 | 47.00% (17.86 mg/L) | ND | ND | 2.54% (2.1 mg/L) |
| | in 14 days | | | in 8 days) |
| BDF10 | 50.21% (19.08 mg/L) | ND | ND | 3.43% (2.84 mg/L) |
| | in 14 days | | | in 8 days) |
| BDF11 | 74.47% (28.3 mg/L) | ND | ND | 2.39% (1.98 mg/L) |
| | in 14 days | | | in 8 days) |
| BDF12 | 49.57% (18.84 mg/L) | ND | ND | 2.41% (2 mg/L) |
| | in 14 days | | | in 8 days) |
| BDF13 | 98.26% (37.34 mg/L) | 2.22% (1.656 mg/L) | 1.72% (1.556 mg/L) | 0.37% (1.54 mg/L) |
| | in 4 days) | in 4 days) | in 4 days) | in 4 days) |
| BDF14 | 26.57% (10.1 mg/L) | 2.73% (2.04 mg/L) | 2.23% (2.02 mg/L) | 0.40% (1.66 mg/L) |
| | in 4 days) | in 4 days) | in 4 days) | in 4 days) |
| BDF15 | 27.63% (10.5 mg/L) | 2.79% (2.08 mg/L) | 2.06% (1.866 mg/L) | 0.46% (1.92 mg/L) |
| | in 4 days) | in 4 days) | in 4 days) | in 4 days) |
| BDF16 | 59.00% (22.42 mg/L) | 2.27% (1.698 mg/L) | 1.71% (1.55 mg/L) | 0.36% (1.52 mg/L) |
| | in 4 days) | in 4 days) | in 4 days) | in 4 days) |
| BDF17 | 56.52% (21.48 mg/L) | 2.39% (1.786 mg/L) | 1.81% (1.638 mg/L) | 0.39% (1.62 mg/L) |
| | in 4 days) | in 4 days) | in 4 days) | in 4 days) |
| BDF18 | 19.94% (7.58 mg/L) | 2.34% (1.75 mg/L) | 1.77% (1.604 mg/L) | 0.39% (1.62 mg/L) |
| | in 4 days) | in 4 days) | in 4 days) | in 4 days) |
| BDF19 | 19.00% (7.22 mg/L) | 2.63% (1.962 mg/L) | 1.99% (1.802 mg/L) | 0.42% (1.76 mg/L) |
| | in 4 days) | in 4 days) | in 4 days) | in 4 days) |
| BDF20 | 82.57% (31.38 mg/L) | 2.55% (1.902 mg/L) | 1.20% (1.086 mg/L) | 0.40% (1.68 mg/L) |
| | in 4 days) | in 4 days) | in 4 days) | in 4 days) |
| BDF21 | 52.73% (20.04 mg/L) | 2.56% (1.912 mg/L) | 1.97% (1.788 mg/L) | 0.41% (1.72 mg/L) |
| | in 4 days) | in 4 days) | in 4 days) | in 4 days) |
| BDF22 | 16.47% (6.26 mg/L) | 2.47% (1.844 mg/L) | 1.93% (1.746 mg/L) | 0.38% (1.6 mg/L) |
| | in 4 days) | in 4 days) | in 4 days) | in 4 days) |

All of the defluorinating enzymes removed fluoride from fluoroacetate, and perfluorooctanoic acid. Eleven (11) of the defluorinating enzymes removed fluoride from trifluoroacetate and pentafluoropropionic acid.

### Example 2: Transfer of Defluorinating Enzymes

The defluorinating enzyme polypeptides are engineered into conjugative vectors, and then introduced into E. coli as described in Example 1. Conjugative strains of E. coli transfer the conjugative vector encoding the defluorinating enzyme into other bacterial host cells.

### Example 3: Water Treatment

In municipal wastewater treatment plants, gram-negative bacteria of the proteobacteria type are predominant (21-65%) of which Betaproteobacteria is the most abundant class, largely responsible for the elimination of organic elements and nutrients. The other branches are Bacteroidetes, Acidobacteria and Chloroflexi. The most numerous types of bacteria are Tetrasphaera, Trichococcus, Candidatus microthrix, Rhodoferax, Rhodobacter, Hyphomicrobium.

These indigenous can be engineered with nucleic acids encoding recombinant defluorinating enzymes by introducing to the wastewater suitable bacteria (e.g., a mixture of Bacillus and pseudomonas host cells) engineered with conjugation vectors encoding the defluorinating enzyme(s). When these host cells are introduced to the waste water the conjugation vectors with encoding the recombinant defluorinating enzyme(s) are transferred to the indigenous bacteria.

Alternatively, Rhodopseudomonas palustris can be engineered with a nucleic acid encoding a recombinant defluorinating enzyme (e.g., the nucleic acid can be a conjugative vector or a nonconjugative vector. The engineered Rhodopseudomonas palustris can then be introduced into the water to be treated.

### Example 4: Treatment of Biosolids

The anaerobic digestion process for biosolids can be conceptually divided into four phases: hydrolysis, acidogenesis, syntrophic acetogenesis, and methanogenesis. Each of these sequential phases can be carried out by a unique functional group of microorganisms. These groups of microorganisms can be engineered with nucleic acids encoding the defluorinating enzymes described herein. Alternatively, a host bacteria can be engineered with a conjugative plasmid encoding a recombinant defluorinating enzyme, and this bacteria can transfer by conjugation the conjugative plasmid to some or all of the groups of microorganisms.

In the hydrolysis phase, polymeric substrates, primarily polysaccharides (cellulose, hemicellulose, starch), lipids, and proteins, are hydrolyzed by the extracellular hydrolases (e.g., cellulase, xylanase, pectinase, amylase, lipase, and protease) secreted by hydrolytic bacteria, releasing monomers or oligomers, such as glucose and cellobiose from cellulose, glucose, and maltose from starch, xylose from hemicellulose, amino acids from proteins, and long-chain fatty acids (LCFA) and glycerol from lipids. The hydrolytic bacteria are phylogenetically diverse, but Firmicutes and Bacteroides are the two phyla containing most of the hydrolytic bacteria found in anaerobic degradation bioreactors. Hydrolytic bacteria, in general, can grow fast and are less sensitive to changes in environmental conditions, such as pH and temperature. Except for recalcitrant substrates, such as lignocellulose, the hydrolysis step is not rate-limiting in anaerobic degradation. All hydrolytic bacteria in anaerobic degradation bioreactors can utilize the hydrolysis products as growth substrates, primarily through fermentation, to produce short-chain fatty acids (SCFA).

The hydrolytic products are fermented to SCFA, with acetate, propionate, butyrate, valerate, and isobutyrate as the major SCFA, by acidogenic microorganisms (or acidogens, primarily bacteria) during acidogenesis. Carbon dioxide, hydrogen, ammonia, and sulfide are also produced during acidogenesis. Acetogens include both hydrolytic bacteria and fermentative bacteria that lack hydrolytic ability. Firmicutes, Bacteroidetes, Chloroflexi, Proteobacteria, and Atribacteria are the major phyla that contain many species of acidogens reported in anaerobic degradation bioreactors. Acidogenesis is generally rapid, and it can cause accumulation of SCFA and concomitant sharp pH drop when anaerobic degradation bioreactors are overloaded with readily digestible feedstocks, such as food wastes. Accumulation of SCFA can cause upset or even failure of the anaerobic degradation process.

Acetate, formate, H2, and CO2, resulted from acidogenesis, can be directly utilized by methanogens for biogas production, but other acidogenesis products, including propionate, butyrate, isobutyrate, valerate, and isovalerate, cannot be utilized by any of the known methanogens. They need to be further degraded and transformed into the methanogenesis substrates through syntrophic acetogenesis, during which the above hydrolytic and acidogenic products are further degraded/oxidized into acetate, H2, and CO2. Syntrophic oxidation of propionate is particularly important because nearly 30% of the electrons generated from complex substrates flow through propionate during anaerobic degradation. Medium-chain fatty acids (MCFA) and LCFA from lipid hydrolysis also need to be oxidized to acetate, H2, and CO2 through syntrophic acetogenesis. Unless the H2 partial pressure is kept very low (>10-4 atm), syntrophic acetogenesis is thermodynamically unfavorable. Hydrogenotrophic methanogens live in close proximity of syntrophic acetogens in anaerobic degradation bioreactors and consume the H2 released from the syntrophic acetogens. This syntrophic relationship is based on interspecies hydrogen transfer (IHT) from hydrogen-producing bacteria (syntrophic acetogens) to hydrogenotrophic methanogens. Syntrophic acetogenesis is a critical process in maintaining the stable and robust operation of anaerobic degradation bioreactors because some of the SCFA, particularly propionate, are potent inhibitors of methanogens even at neutral pH.

Methanogenesis is carried out by methanogens, a specialized group of archaea. They can be categorized into three groups based on the methanogenesis substrates and pathways, (i) acetotrophic (or acetoclastic) methanogens, which use acetate to produce methane (CH4) through the acetoclastic pathway; (ii) hydrogenotrophic methanogens, which use formate and H2 to reduce CO2 to CH4 via the hydrogenotrophic pathway; and (iii) methylotrophic methanogens, which produce CH4 from methyl compounds, such as methanol, methylamines, and methyl sulfides, through the methylotrophic methanogenesis pathway. Methanogens have also been divided into three classes (Anderson et al., 2009). Class I and II are hydrogenotrophic methanogens; they utilize formate, H2, and CO2 as their methanogenesis substrates and are important in the anaerobic degradation process owing to its ability to scavenge H2 and keep the partial hydrogen pressure low. Class III methanogens possess the ability to utilize other substrates, such as acetate, methanol, and other C1 compounds. In anaerobic degradation bioreactors, about two-thirds of the methane is produced from acetate, and about one-third produced from H2 and CO2, with minimal CH4 production from methanol, methylamines, and methyl sulfides. Compared to other bacteria in anaerobic degradation bioreactors, methanogens grow the slowest and are more sensitive to environmental disturbances, such as pH decline and accumulation of SCFA or ammonia.

All publications, patents, patent applications and other documents cited in this application are hereby incorporated by reference in their entireties for all purposes to the same extent as if each individual publication, patent, patent application or other document were individually indicated to be incorporated by reference for all purposes.

While various specific embodiments have been illustrated and described, it will be appreciated that various changes can be made without departing from the scope of the invention(s) of the disclosure.

What is claimed is:

1. A method for remediating a polyfluoroalkyl compound (PFA), comprising the steps of: applying a cell to a soil contaminated with the PFA, wherein the cell is a bacterial cell comprising a vector, wherein the vector comprises a polynucleotide encoding a recombinant defluorinating enzyme operably linked to a promoter, expressing the vector in the bacterial cell; and breaking down a component of the PFA in the bacterial cell.

2. The method of claim 1, wherein the recombinant defluorinating enzyme has an amino acid sequence that is one of SEQ ID NO: 2, 4, 6, 8, 10, 12, 14, 16, 18, 20, 22, 24, 26, 28, 30, 32, 34, 36, 38, 40, 42, or 44.

3. The method of claim 1, wherein the polynucleotide comprises a sequence of one of SEQ ID NO: 1, 3, 5, 7, 9, 11, 13, 15, 17, 19, 21, 23, 25, 27, 29, 31, 33, 35, 37, 39, 41, or 43.

4. The method of claim 1, wherein the bacterial cell is an aerobe.

5. The method of claim 1, wherein the bacterial cell is an anaerobe.

6. The method of claim 1, wherein the bacterial cell is facultative anaerobe.

7. The method of claim 1, wherein the bacterial cell is an Acidimicrobium, an Arthrobacter, a Bacillus megaterium, a Bacillus subtilis, a Candidatus microthrix, a Delftia acidovorans, an E. coli, a Hyphomicrobium, a Moraxella, a Pseudomonas putida, a Pseudomonad species, a Rhodococcus jostii, a Rhodoferax, a Rhodobacter, a Tetrasphaera, or a Trichococcus.

8. The method of claim 1, wherein the bacterial cell is a Desulfobacteraceae, a Geobacter, a Clostridium, a Dehalobacter, a Dehalococcoides, an Alcaligenes, an Achromobacter, a Bacillus subtilis, a Rhodopseudomonas palustris, a Streptococcus, a Staphylococcus aureus, a Lactobacillus, or a Bacteroides.

9. A method for remediating a fluoroalkyl compound, comprising the steps of: applying a donor cell to a soil contaminated with the fluoroalkyl compound, wherein the donor cell is a bacterial cell comprising a conjugation system and a vector, wherein the vector comprises a polynucleotide encoding a recombinant defluorinating enzyme operably linked to a first promoter, wherein the vector can be transferred by conjugation; forming a conjugation pilus between the donor cell and a recipient cell, wherein the recipient cell is a bacteria; transferring the vector from the donor cell to the recipient bacteria; expressing the vector in the recipient bacteria; and breaking down the fluoroalkyl compound in the recipient bacteria with the vector.

10. The method of claim 9, wherein the donor cell is an enteric bacteria.

11. The method of claim 10, wherein the enteric bacteria is an Escherichia coli.

12. The method of claim 9, wherein the recipient bacteria a petroleum degrading bacteria.

13. The method of claim 12, wherein the petroleum degrading bacteria is selected from the group consisting of a Bacillus, an Achromobacter, an Acinetobacter, an Aeromonas, an Agmenellum, an Alcanivorax, an Alcaligenes, an Alkanindiges, an Alteromonas, an Arthrobacter, a Burkholderia, a Cycloclasticus, a Dietzia, an Enterobacter, a Gordonia sp., a Kocuria, a Marinobacter, a Mycobacterium, an Ochrobactrum, an Oleispira, a Pandoraea, a Pseudomonas, a Rhodococcus, a Staphylococcus, a Stenotrophomonas, a Streptobacillus, a Streptococcus, a Thallassolituus, and a Xanthomonas sp.

14. The method of claim 9, wherein the recombinant defluorinating enzyme has an amino acid sequence that is one of SEQ ID NO: 2, 4, 6, 8, 10, 12, 14, 16, 18, 20, 22, 24, 26, 28, 30, 32, 34, 36, 38, 40, 42, or 44.

15. The method of claim 9, wherein the polynucleotide comprises a sequence of one of SEQ ID NO: 1, 3, 5, 7, 9, 11, 13, 15, 17, 19, 21, 23, 25, 27, 29, 31, 33, 35, 37, 39, 41, or 43.

16. The method of claim 12, wherein the promoter is operable in a petroleum degrading bacteria.

17. The method of claim 9, wherein the promoter is operable in an aerobic bacteria.

18. The method of claim 9, wherein the promoter is operable in an anaerobic bacteria.

19. The method of claim 9, wherein the promoter is operable in a facultative anaerobic bacteria.

20. The method of claim 9, wherein the conjugation system is selected from the group consisting of an IncA/C group plasmid, an IncN group plasmid, an IncP group plasmid, an IncW group plasmid, an IncQ group plasmid, an IncU group plasmid, and an IncPromA group plasmid.
